(19) United States
(12) Patent Application Publication
(10) Pub. No.: US 2025/0239582 A1
(43) Pub. Date: Jul. 24, 2025

(54) SYSTEMS AND METHODS FOR PREPARING SEMI-SOLID ELECTRODES

(71) Applicant: 24M Technologies, Inc., Cambridge, MA (US)

(72) Inventors: Raymond ZAGARS, Pensacola, FL (US); Glenn JORDAN, Harvard, MA (US); Mitchell GILBERT, Madison, AL (US); Naoki OTA, Lexington, MA (US); Junzheng CHEN, Concord, MA (US); Keiichi TANAKA, Utsunomiya-Shi (JP); Liufeng XIONG, Lexington, MA (US); Aaron David ANESGART, Jamaica Plain, MA (US); Parth S. PATEL, Boston, MA (US)

(21) Appl. No.: 19/029,226

(22) Filed: Jan. 17, 2025

Related U.S. Application Data
(60) Provisional application No. 63/622,751, filed on Jan. 19, 2024.

(51) Int. Cl. H01M 4/04; C09J 7/35; H01M 4/139; H01M 10/0585; H01M 10/0587; H01M 10/42; H01M 50/46

(52) U.S. Cl. CPC H01M 4/0404; C09J 7/35; H01M 4/0435; H01M 4/139; H01M 10/0585; H01M 10/0587; H01M 10/4235; H01M 50/46; C09J 2203/33; C09J 2301/304

(57) ABSTRACT

Embodiments described herein relate generally to systems and methods for continuously and/or semi-continuously manufacturing semi-solid electrodes and batteries including semi-solid electrodes. The methods include disposing a portion of a current collector material into a gap between a first arc-shaped member and a second arc-shaped member, disposed along an outside edge of a drum, and moving the first arc-shaped member with respect to the second arc-shaped member to at least partially close the gap, causing the current collector material to frictionally engage with a portion of both arc-shaped members. The method further includes dispensing a semi-solid electrode material onto a surface of the first arc-shaped member and the second arc-shaped member. Subsequently, the second arc-shaped member is moved with respect to the first one, re-establishing the gap and resulting in the formation of two discrete portions of electrode material on the surface of the current collector material.

### CROSS-REFERENCE TO RELATED APPLICATIONS

This application claims priority to and the benefit of U.S. Provisional Patent Application No. 63/622,751, filed Jan. 19, 2024 and titled “Systems and Methods for Preparing Semi-Solid Electrodes,” the disclosure of which is hereby incorporated by reference herein in its entirety.

### TECHNICAL FIELD

Embodiments described herein relate generally to systems and methods for continuously and/or semi-continuously manufacturing semi-solid electrodes and batteries incorporating semi-solid electrodes in a controlled manner.

### BACKGROUND

In the production of electrode materials, a typical manufacturing process involves applying a slurry containing an active material, conductive additive, and binding agent dissolved or dispersed in a solvent onto a conductive substrate (i.e., current collector). The coated slurry is then dried to remove the solvent and calendered to achieve the desired thickness. Various steps, such as material mixing, casting, calendering, drying, slitting, and working, are commonly used depending on the battery architecture being manufactured. However, ensuring a uniform and consistent coating thickness across the entire current collector surface presents challenges. Existing manufacturing methods have encountered issues with machining variability and deflection caused by the force of the dispensed slurry, leading to uneven coating thickness in the electrodes. Such variations can negatively affect the performance and capacity of the batteries.

To address this, many manufacturing processes control the casting speed to achieve consistent slurry dispensing and coating onto the current collector. Yet, reducing the casting speed impacts production throughput and may not meet market demands. Therefore, achieving precision components and minimizing mechanical deflection during slurry casting are important to ensure the quality and consistency of the coating thickness in the electrodes.

In addition, the dimensions of the semi-solid electrodes can change under pressure in situations that can include cell testing or during incorporation into a battery stack. When adjacent unit cells (including an anode, a separator, and a cathode) are not perfectly aligned in a battery cell or adjacent battery cells are not perfectly aligned in a battery pack, the electrodes (anode or cathode) can be nonuniformly deformed under pressure. The electrode dimensional instability can cause cell performance degradation or even safety concerns. For example, cathodes are often smaller than anodes and the cathode area is covered by anode with a separator between them. If cathode area is not covered by anode area after deformation, lithium plating can occur, which causes safety concerns. Therefore, improving the mechanical strength and dimensional stability of semi-solid electrodes is important for manufacturing high performance cells with good safety.

### SUMMARY

Embodiments described herein relate generally to systems and methods for continuously and/or semi-continuously manufacturing semi-solid electrodes in a controlled manner. In some embodiments, a method can include receiving a current collector material on a surface of a first arc-shaped member and a surface of a second arc-shaped member disposed along an outside edge of a drum, the first arc-shaped member and the second arc-shaped member having a gap therebetween. The method can further include conveying the current collector material along the surface of the first arc-shaped member and the surface of the second arc-shaped member such that a portion of the current collector material is disposed into the gap between the first arc-shaped member and the second arc-shaped member. The method can further include moving the first arc-shaped member with respect to the second arc-shaped member to at least partially close the gap between the first arc-shaped member and the second arc-shaped member such that the current collector material is frictionally engaged with a portion of the first arc-shaped member and a portion of the second arc-shaped member (i.e., tucked between a portion of the first arc-shaped member and a portion of the second arc-shaped member). The method can further include dispensing a semi-solid electrode material onto portions of the current collector material that are disposed on the surface of the first arc-shaped member and the second arc-shaped member and moving the second arc-shaped member with respect to the first arc-shaped member to re-form the gap between the first arc-shaped member and the second arc-shaped member, such that a first discrete portion of the semi-solid electrode material and a second discrete portion of the semi-solid electrode material are formed on the surface of the current collector material. In some embodiments, the current collector material is received from an alignment drum onto the surface of a first arc-shaped member and the surface of a second arc-shaped member. In some embodiments, the alignment drum is mechanically coupled to the drum, such that the alignment drum is driven synchronously with the drum.

In some embodiments, the current collector material can be placed on a carrier film or carrier material. In some embodiments, the current collector material can be placed in discrete sections on the carrier film. The method may further include cutting the current collector material between the discrete portions of semi-solid electrode (i.e., between the first discrete portion of electrode material and the second discrete portion of electrode material) formed on the surface of the current collector material to form a finished electrode. In some embodiments, the method can include cutting the carrier film.

In some embodiments, systems described herein may include a plurality of arc-shaped pallets that forms a drum; a dispenser being attached to an outside surface of at least one of the arc-shaped pallets; at least one concave roller gear being in touch with an outside surface of at least two of the arc-shaped pallets; an alignment drum mechanically coupled to the drum; and a dynamic clamping force regulator system including a plurality of pinion gears. In some embodiments, at least a portion of the plurality of pinion gears can be in contact with a first portion of an outside edge of the drum; and a damping system including at least one pinion gear. In some embodiments, the at least one pinion gear is in contact with a second portion of an outside edge of the drum, and the first portion of an outside edge of the drum and the second portion of an outside edge of the drum are adjacent to each other and separated by a distance of less than a surface arc length of one arc-shaped member. In some embodiments, the drum is rotated around a shaft. The system may further include a vacuum inside the drum. In some embodiments, the plurality of arc-shaped pallets have a surface including holes. In some embodiments, the system further includes a gantry (e.g., a gantry with a turret) including a plurality of receivers. The plurality of receivers may be filled with a semi-solid electrode material.

In some embodiments, a method can include formation of a substrate with multilayer films laminated onto a current collector. The multilayer films, after cutting to the desired dimensions, can pass through a coating apparatus, where slurry is coated onto the substrate. The coated slurry is then partially dried to the desired electrode loading. The top layer of the multilayer films is then removed via a roll-to-roll process and the electrodes are calendered to a desired thickness. After calendering, the separator is applied to the coated substrate by a roll-to-roll process. After applying the separator, the coated surface and the separator can be cut to the desired dimension according to cell design. Optionally a protection film can be applied on the top of separator by a rolling process. The formed multilayered structure can then be wound to form a semi-solid electrode with a rolled form.

In some embodiments, anode current collector can include copper. In some embodiments, the cathode current collector can include aluminum. In some embodiments, other materials can be used for the current collectors that are used for lithium-ion batteries. The multilayer films can be laminated on current collector by passing lamination films and current collector through heated rolls or other methods, in which a single layer film is laminated on one side of current collector and multilayer films are laminated on the other side of the collector. The multilayer films can be cut by laser beam or other methods so that areas of current collector are exposed for slurry coating.

In some embodiments, the coating system includes a coating apparatus that can be a slot die coater, comma coater or any other coating systems used for roll-to-roll LIB electrode fabrication. The slurry is prepared by mixing cathode and/or anode active materials, conductive additives, organic solvents, and other components. The other components can include electrolyte and/or binder. The partial slurry can be dried via forced air and/or other methods used LIB electrode production. The drying temperature can be room temperature or a higher temperature less than 100° C. The drying temperature depends on slurry composition, coating line speed and final loading weight.

In some embodiments, the post coating system can include a top film remover to remove the top layer film from the coated substrate. The top film remover can include rolls that peel off the top film and wind the film after removal. The post coating system can further include a roll calender to reduce the thickness of coating by passing the rolls of the calender. The post coating system can further include a separator applier that places separator on the coated substrate. The separator applier can include rolls that convey the separator and attach the separator on the coated substrate. The separator can be fixed on substrate by heating between the separator and the multilayer films. The coated substrate is then cut to the discrete electrodes with desired size. Optionally, a protection film is applied to the substrate after the separator is applied. Instead of cutting electrodes, the coated substrate with protection layer can be wound to form a roll of coated substrate that can be used for further cell assembly.

In some embodiments, the roll-to-roll process described above can be applied to both anode and cathode electrodes.

In some embodiments, the roll-to-roll process described above can be applied to coat single sided electrode or double sided electrodes with slight modification of the multilayer substrate and electrode fabrication process.

In some embodiments, a method includes: receiving a current collector material from an alignment drum on a surface of a first arc-shaped member and a surface of a second arc-shaped member disposed along an outside edge of a drum mechanically coupled to the alignment drum, the first arc-shaped member and the second arc-shaped member having a gap therebetween, the alignment drum being driven synchronously with the drum; conveying the current collector material along the surface of the first arc-shaped member and the surface of the second arc-shaped member such that a portion of the current collector material is disposed into the gap between the first arc-shaped member and the second arc-shaped member; moving the first arc-shaped member with respect to the second arc-shaped member to at least partially close the gap between the first arc-shaped member and the second arc-shaped member such that the current collector material is frictionally engaged with a portion of the first arc-shaped member and a portion of the second arc-shaped member; dispensing a semi-solid electrode material onto portions of the current collector material that are disposed on the surface of the first arc-shaped member and the second arc-shaped member; and moving the second arc-shaped member with respect to the first arc-shaped member to re-form the gap between the first arc-shaped member and the second arc-shaped member, such that a first discrete portion of the semi-solid electrode material and a second discrete portion of the semi-solid electrode material are formed on the current collector material.

In some embodiments, a system includes: a plurality of arc-shaped pallets that forms a drum, the drum being rotated around a shaft; a dispenser being attached to an outside surface of at least one of the arc-shaped pallets; at least one concave roller gear being in touch with an outside surface of at least two of the arc-shaped pallets; an alignment drum mechanically coupled to the drum; a dynamic clamping force regulator system including a plurality of pinion gears, at least a portion of the plurality of pinion gears being in contact with a first portion of an outside edge of the drum; and a damping system including at least one pinion gear, the at least one pinion gear being in contact with a second portion of an outside edge of the drum, the first portion of the outside edge of the drum and the second portion of the outside edge of the drum being next to each other with a distance of less than a surface arc length of one arc-shaped member.

In some embodiments, a method of forming an electrode includes: disposing a current collector on a first surface of a film material; disposing an endframe material on the film material around an outside edge of the current collector; disposing a section of tape on the endframe material; casting a semi-solid electrode material onto the current collector; and removing the section of tape from the endframe material, such that a portion of the semi-solid electrode material is removed, thereby forming the electrode.

In some embodiments, a method includes: mixing an active material, a conductive material, a binder, and a first electrolyte solvent to produce an electrode material, the electrolyte solvent free of an electrolyte salt; dispensing the electrode material onto a current collector material; adding an electrolyte salt into the electrode material via inkjet printing to form an electrode, the electrolyte salt dissolved in a second electrolyte solvent; and stacking a plurality of electrodes on top of each other to form an electrochemical cell stack while separating adjacent current collector materials from each other with a separator material.

In some embodiments, a system includes: a first head pulley and a second head pulley opposite the first head pulley, the first head pulley and the second head pulley operatively coupled to each other; a first tail pulley and a second tail pulley opposite the first tail pulley, the first tail pulley and the second tail pulley operatively coupled to each other; a first conveyor belt including: a first belt platform including a plurality of openings configured to allow passage of air therethrough, a first belt ribbon operably coupled to the first head pulley and the first tail pulley and attached to the first belt platform along a first outside edge of the first belt platform, and a second belt ribbon operably coupled to the second head pulley and the second tail pulley and attached to the first belt platform along a second outside edge of the first belt platform, the second outside edge of the first belt platform opposite the first outside edge of the first belt platform, a third head pulley and a fourth head pulley opposite the third head pulley, the third head pulley and the fourth head pulley operatively coupled to each other, the third head pulley and the fourth head pulley configured to operate independently of the first head pulley and the second head pulley; and a third tail pulley and a fourth tail pulley opposite the third tail pulley, the third tail pulley and the fourth tail pulley operatively coupled to each other, the third tail pulley and the fourth tail pulley configured to operate independently of the first tail pulley and the second tail pulley; a second conveyor belt including: a second belt platform including a plurality of openings configured to allow passage of air therethrough, a third belt ribbon operably coupled to the third head pulley and the third tail pulley and attached to the second belt platform along a first outside edge of the second belt platform, and a fourth belt ribbon operably coupled to the fourth head pulley and the fourth tail pulley and attached to the second belt platform along a second outside edge of the second belt platform; and a vacuum chamber positioned between the first head pulley and the first tail pulley and configured to draw air through the plurality of openings in the first belt platform and the second belt platform.

In some embodiments, a system includes: a drum, constructed from a first assembly and a second assembly, each of the first assembly and the second assembly including: a plurality of disks spaced apart by a distance along an axial direction, each of the plurality of disks having an outer surface and an inner surface; an arc-shaped pallet disposed on the plurality of disks and extending over a portion of the outer surface of the plurality of disks; and a center axle disposed and configured to engage the inner surfaces of the plurality of disks of the first assembly and the inner surfaces of the plurality of disks of the second assembly; the first assembly and the second assembly being configured to be coupled together such that the plurality of disks of the first assembly are positioned in the spaces between the plurality of disks of the second assembly to form the drum.

In some embodiments, a method includes: laminating a plurality of films onto a current collector material; cutting the laminated plurality of films to form a multilayer endframe, the multilayer endframe including a middle film and a removable film; coating an electrode slurry onto the current collector material and the multilayer endframe; at least partially drying the electrode slurry to form an electrode material; removing the removable film; calendering the electrode material to a desired thickness; and applying a separator to the electrode material via a roll-to-roll process to form an electrode.

In some aspects, an electrochemical cell can include a first electrode, a second electrode, an electrolyte, a separator disposed between the first electrode and the second electrode, a first film coupled to the first electrode, and a second film coupled to the second electrode. The second film is coupled to the first film along a sealing region, and the sealing region at least partially encircles the first electrode along a perimeter thereof. The sealing region includes an adhesive. The electrochemical cell further includes an electrode tab extending from a tab region of the first electrode and a tab film coupled to the tab region of the first electrode. The adhesive and the tab film can be substantially non-wettable with respect to the electrolyte.

In some embodiments, the electrode tab can be a first electrode tab and the tab region can be a first tab region, the electrochemical cell further including a second electrode tab extending from a second tab region of the second electrode. In some embodiments, the first electrode includes a first electrode material and a first current collector and the first electrode tab extends from the first current collector. In some embodiments, the second electrode includes a second electrode material and a second current collector, the second electrode tab extending from the second current collector. In some embodiments, the tab film is a first tab film and the electrochemical cell further includes a second tab film coupled to the second tab region.

### BRIEF DESCRIPTION OF THE DRAWINGS

FIG. 1 is a schematic flow chart of a method of semi-continuous or continuous manufacturing of a semi-solid electrode, according to an embodiment.

FIG. 2 is a block diagram of a system for manufacturing a semi-solid electrode, according to an embodiment.

FIGS. 3A-3D are illustrations of a system for manufacturing a semi-solid electrode, and various components thereof, according to an embodiment.

FIG. 4 is an illustration of a drum for casting of semi-solid electrode material, according to an embodiment.

FIG. 5 is an illustration of an electrochemical cell, according to an embodiment.

FIG. 6 is an illustration of an electrochemical cell, according to an embodiment.

FIGS. 7A-7C are illustrations of a production process for an electrode, according to an embodiment.

FIG. 8 is an illustration of a collection of components of an electrochemical cell, and their interaction with a tape covering, according to an embodiment.

FIG. 9 is an illustration of a collection of components of an electrochemical cell, and their interaction with a tape covering, according to an embodiment.

FIG. 10 is a schematic flow chart of a method of manufacturing of an electrochemical cell stack, according to an embodiment.

FIG. 11 is a block diagram of a system for conveying an electrochemical cell strip, according to an embodiment.

FIG. 12 is a block diagram of a system for conveying an electrochemical cell strip, according to an embodiment.

FIGS. 13A-13F are illustrations of a system for conveying an electrochemical cell strip, and various components thereof, according to an embodiment.

FIG. 14 is a schematic flow chart of a method of conveying an electrochemical cell strip, according to an embodiment.

FIG. 15 is a block diagram of a system for manufacturing an electrode, according to an embodiment.

FIGS. 16A-16C are illustrations of a system for manufacturing an electrode, and various components thereof, according to an embodiment.

FIGS. 17A-17B are illustrations of a roll-to-roll system for manufacturing semi-solid electrodes with a multilayer endframe substrate, according to an embodiment.

FIG. 18 is an illustration of endframe substrate for roll-to-roll coating, according to an embodiment.

FIG. 19A is an optical microscope image of a semi-solid electrode showing edge quality without adhesive in middle film. FIG. 19B is an optical microscope image of a semi-solid electrode showing edge quality with adhesive on a middle film facing the current collector.

FIG. 20A is an optical microscope image of a coating edge with insertion of the location of line scans. FIG. 20B shows a height line scan profile across edge.

FIGS. 21A-21E are step-by-step illustrations of roll-to-roll coating with endframe substrate simulated by a doctor blade hand coating process, according to an embodiment.

FIGS. 22A-22B are illustrations of a winding endframe electrode on a 3-inch core without and with coated slurry.

FIGS. 23A-23C are illustrations of double side coating of an endframe electrode. FIG. 23A shows an endframe substrate structure; FIG. 23B shows coating on one side; FIG. 23C shows coating on both sides.

FIGS. 24A-24B are graphical representations of slurry evaporation rate vs. exposure time. FIG. 24A shows the effect of covering electrodes with a cover film. FIG. 24B shows the effect of solvent composition: DMC/EC with different ratios and with electrolyte (0.9 M LiPF6 in EC/PC/DMC/EMC)

FIGS. 25A-25B are illustrations of slurry viscosity and photos of slurries. In FIG. 25A: A1—Lower surface area cathode with EC/DMC, 56% solid, A2—higher surface area cathode with electrolyte, 54% solid, and A3—higher surface area cathode with EC/DMC, 57% solid. In FIG. 25B: Photos of slurries, B1: without lithium salt; B2: with lithium salt.

FIG. 26 is an illustration of electrode thickness change after densification, measured vs. calculated.

FIGS. 27A-B are illustrations of coated endframe electrodes before the cell is built and after cell is built and pressurized.

FIGS. 28A-B are illustrations of cell testing results with endframe electrodes in LFP/Graphite cells. FIG. 28A shows a voltage profile of a 1^{st} cycle. FIG. 28B shows C/3 cycling. E1 and F1 are two types of electrolytes.

FIG. 29 is a block diagram of an electrochemical cell with tabs and tab films, according to an embodiment.

FIG. 30 is a visual depiction of contact angle, as described herein.

FIG. 31 is a block diagram of an electrochemical cell with tabs and tab films, according to an embodiment.

FIGS. 32A-32B are illustrations of an electrochemical cell with tabs and tab films, according to an embodiment.

FIGS. 33A-33B are illustrations of an electrochemical cell with tabs and tab films, according to an embodiment.

FIGS. 34A-34B are illustrations of an electrochemical cell with tabs and tab films, according to an embodiment.

FIGS. 35A-35C are illustrations of an electrochemical cell with tabs and tab films, and its incorporation into an electrochemical cell stack according to an embodiment.

### DETAILED DESCRIPTION

Embodiments described herein relate generally to systems and methods for continuously and/or semi-continuously manufacturing semi-solid electrodes and batteries incorporating semi-solid electrodes. Embodiments described herein relate generally to methods for manufacturing semi-solid electrodes including dispensing a semi-solid electrode material onto a current collector that is conveyed along a drum. Examples of a semi-solid electrode material and methods of manufacture are described in U.S. Pat. No. 11,462,722, entitled “Apparatuses and Processes for Forming a Semi-solid Electrode having High Active Solids Loading and Electrochemical Cells including the Same”, the entire disclosure of which is hereby incorporated by reference.

Conventional electrodes and conventional electrochemical cells are typically prepared by coating a discrete portion of a current collector material (e.g., a metal foil substrate) with a thin (e.g., about 10 μm to about 200 μm) wet slurry that is subsequently dried and calendered to a desired thickness. The slurry components typically include active materials, conductive additives, a binding agent, and a solvent (e.g., commonly N-Methylpyrrolidone (NMP)). When the solvent is evaporated (e.g., in a drying oven covering a conveying line), the binder agent that is present in the slurry converts to a “glue” that holds all of the solid particles together in a matrix bound to the substrate. The manufacture of battery electrodes can commonly include material mixing, casting, calendering, drying, slitting, and working (bending, rolling, etc.) according to the battery architecture being built.

Roll casting is a high-throughput manufacturing technique used in the production of lithium-ion battery electrodes that enables large-scale production of electrode materials. It offers several advantages over batch processing methods, such as improved consistency, reduced material waste, and the ability to manufacture electrodes in continuous rolls, facilitating automated assembly of battery cells. It includes continuously dispensing a slurry onto a current collector as it passes through a conveyance system including a plurality of pallets. In some embodiments, a gap between sections of current collector material can be tucked between adjacent pallets such that a slurry is only dispensed onto discrete sections of current collector material. A current collector is tucked and gripped between pallets before going through casting (e.g., dispensing a slurry) and is untucked after casting. This tucking and untucking allow for continuous casting of slurries. Examples of such roll casting techniques can be found in U.S. Pat. No. 11,652,203, entitled “Continuous and Semi-continuous methods of Semi-Solid Electrode and Battery Manufacturing” and in U.S. Patent Publication No. 2022/0115710, entitled “Methods of Continuous and Semi-continuous Production of Electrochemical cells” the entire disclosures of which are hereby incorporated by reference.

Nevertheless, achieving uniform and consistent coating thickness across the entire surface of the current collector poses difficulties. Current manufacturing techniques have faced challenges related to variations in machining, as well as deflection caused by the force of the dispensed slurry, leading to uneven coating thickness in the electrodes. Particularly, when the weight of active material in the slurry is increased, the deflection caused by the force of the dispensed slurry becomes more noticeable, resulting in uneven slurry distribution on the current collector's surface. These inconsistencies can have adverse effects on battery performance and capacity. To tackle these issues, various manufacturing processes regulate the casting force to ensure consistent slurry dispensing and coating on the current collector. However, reducing the casting force has implications for production throughput and may not meet market demands. Inconsistencies in casting force/pressure can cause inconsistencies and non-uniformities in coating thickness. Therefore, achieving accuracy in components and minimizing mechanical deflection during slurry casting are crucial to ensure the electrode coating's quality and uniformity.

To overcome these challenges, embodiments of systems and methods described herein for continuously and/or semi-continuously manufacturing semi-solid electrodes, may provide one or more benefits including, for example: (1) minimizing machining variability by reducing mechanical deflection caused by the force of the dispensed slurry; (2) enabling controlled and synchronized production of electrodes, thereby ensuring consistency among the manufactured electrodes; (3) enabling fast production rates up to 70 meters per minute; (4) and/or being adaptable to different electrode materials and form factors. Moreover, systems and methods described herein also relate to adhesives and/or tapes for sealing electrochemical cells, which have low wettability or reactivity with electrolytes, thus providing various advantages including improving flexibility of roll-to-roll manufacturing processes, enhancing hermetic sealing of electrochemical cells, thus reducing possibility of moisture ingress increasing safety and reliability of electrochemical cells.

In some embodiments, the methods and systems of the present disclosure can include a continuous and automated process, wherein the active electrode material (i.e., the semi-solid electrode material) is dispensed onto a current collector material present on the surface of arc-shaped pallets traveling around the circumference of a drum. The motion of the arc-shaped pallets is precisely and synchronously controlled with unique synchronous cam mechanisms to allow for tucking and untucking of a current collector material while the roll casting drum rotates around a robust shaft. Such synchronous cam mechanisms facilitate the smooth and even deposition of the active material onto the current collector, ensuring a consistent thickness and distribution across the electrode. This continuous and rapid deposition process is particularly advantageous in large-scale battery production, where high throughput and cost optimization are essential. In some embodiments, the pallets can be driven via the action of a roller gear. In some embodiments, the pallets can be driven via a spur gear system, which controls the pinching force of adjacent pallets when they clamp the current collector material between them.

In some embodiments, the methods and systems provided herein can also include a roll-to-roll process, wherein a substrate with multilayered structure passes through a coating apparatus, where an electrode slurry is coated on the substrate. In some embodiments, the coating apparatus can include coatings for conventional roll-to-roll electrode manufacturing. The coated slurry is then partially dried to a desired loading of the electrode. The top layer of the multilayered films can then be removed via a rolling process and the electrodes are calendered to desired thickness. After calendering, a separator can be applied to the coated substrate via a roll-to-roll process and is then fixed on substrate via sealing the separator and the film on a substrate. The coated substrate can then be cut to the desired dimension (i.e., according to a cell design). Optionally a protection film can be applied on the top of separator via a rolling process. The formed multilayered structure is then wound to form a roll of a coated semi-solid electrode. This roll-to-roll process can utilize conventional roll-to-toll coating systems with slight modification and has the advantages of precision and high-speed manufacturing.

Further, systems described herein offer a more precise casting surface and significantly reduce deflection during the process. Consequently, higher machine speeds of up to 70 meters per minute become feasible, enabling efficient and accurate production of multi-gigawatt-hour (GWHr) battery manufacturing. One of the significant advantages of using the methods and systems described herein for electrode production is the potential for enhanced electrode performance. The controlled and uniform distribution of active materials on the current collector can lead to improved electrochemical properties, such as higher energy density, enhanced cycling stability, and increased overall battery efficiency. Moreover, the continuous nature of the process reduces downtime and minimizes the need for manual intervention, thus streamlining the production workflow and reducing manufacturing costs.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein. Additionally, electrolyte in the slurry can facilitate large format electrode (i.e., electrodes with large length/thickness and/or width/thickness proportions) production. Electrolyte added late in the production process can cause difficulty in distributing over a large area.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in U.S. Patent Publication No. 2022/0238923 (“the '923 publication”), filed Jan. 21, 2022 and titled “Production of Semi-Solid Electrodes Via Addition of Electrolyte to Mixture of Active Material, Conductive Material, and Electrolyte Solvent,” and U.S. patent application Ser. No. 18/212,414 (“the '414 application”), filed Jun. 21, 2023 and titled “Electrochemical Cells with High-Viscosity Semi-solid Electrodes, and Methods of Making the Same,” the entire disclosures of which are hereby incorporated by reference.

All definitions, as defined and used herein, should be understood to control over dictionary definitions, definitions in documents incorporated by reference, and/or ordinary meanings of the defined terms.

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set”, and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, the term “z-direction” generally means the third direction where longitudinal and transverse are the first and second directions. In other words, the z-direction refers to the depth or thickness of a feature as opposed to length and width.

As used herein, the term “semi-solid” refers to a material that is a mixture of liquid and solid phases, for example, such as particle suspension, colloidal suspension, emulsion, gel, or micelle.

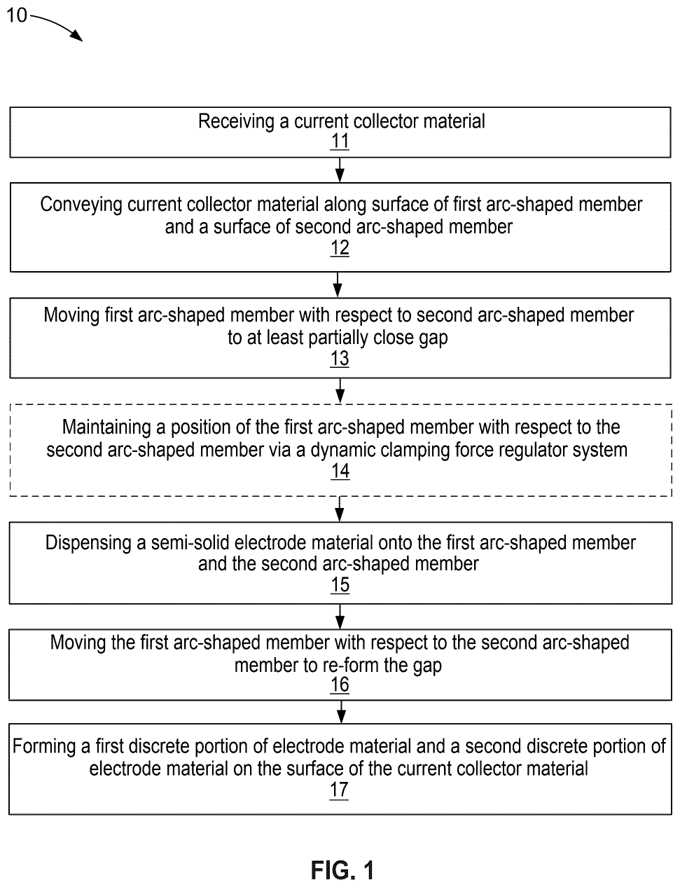

FIG. 1 is a schematic diagram of a method 10 of semi-continuous or continuous manufacturing of a semi-solid electrode, according to an embodiment. As shown, the method 10 includes receiving a current collector material at step 11, conveying the current collector material along a surface of a first arc-shaped member and a surface of a second arc-shaped member at step 12, and moving the first arc-shaped member with respect to the second arc-shaped member to at least partially close a gap between the first arc-shaped member and the second arc-shaped member at step 13. The method 10 optionally includes maintaining a position of the first arc-shaped member with respect to the second arc-shaped member via a dynamic clamping force regulator system at step 14. The method 10 further includes dispensing a semi-solid electrode material onto the first arc-shaped member and the second arc-shaped member at step 15, moving the first arc-shaped member with respect to the second arc-shaped member to re-form the gap at step 16, and forming a first discrete portion of electrode material and a second discrete portion of electrode material on the surface of the current collector material at step 17.

In some embodiments, the method 10 includes continuously and/or semi-continuously dispensing a semi-solid electrode slurry onto a current collector (e.g., a metal foil) as it passes through a conveyance system (i.e., a drum). In some embodiments, the conveyance system can be configured to continuously or semi-continuously convey the current collector past a fixed dispensing mechanism.

The method 10 includes receiving a current collector material on a surface of a first arc-shaped member and a surface of a second arc-shaped member at step 11 while the first arc-shaped member and the second arc-shaped member have a gap between them. In some embodiments, the gap is between about 10 μm to about 10 cm, about 10 μm to about 5 cm, about 10 μm to about 1 cm, about 10 μm to about 5 mm, about 10 μm to about 1 mm, about 10 μm to about 0.5 mm, about 10 μm to about 0.1 mm, about 10 μm to about 50 μm, about 50 μm to about 10 cm, about 50 μm to about 5 cm, about 50 μm to about 1 cm, about 50 μm to about 5 mm, about 50 μm to about 1 mm, about 50 μm to about 0.5 mm, about 50 μm to about 0.1, inclusive. In some embodiments, the gap is at least about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 50 mm, about 100 mm, about 250 mm, about 500 mm, about 750 mm, about 100 cm.

In some embodiments, the first arc-shaped member (i.e., arc-shaped pallet) and the second arc-shaped member are disposed along an outside edge of a drum. In some embodiments, the first and/or second arc shaped member can include a drum. In some embodiments, the drum can include a stationary (i.e., non-rotating) drum with pallets rotating around the outside of the drum. The first arc-shaped member and the second arc-shaped member can be adjacent to each other. In some embodiments, the current collector material can be received from an alignment drum onto the drum. In such embodiments, an alignment drum is mechanically coupled to the drum, and the alignment drum is driven synchronously with the drum. In some embodiments, the first arc-shaped member and the second arc-shaped member can be spring-loaded in an open position. In some embodiments, the gap between adjacent arc-shaped members (i.e., pallets) disposed on the outside edge of a drum can be initially open as the current collector is received from a reel feeder (e.g., an alignment drum) onto the drum. The current collector material is electronically conductive and can be electrochemically inactive under the operation conditions of the cell. In some embodiments, current collector materials can include copper, aluminum, and/or titanium for the negative current collector and aluminum for the positive current collector. In some embodiments, aluminum is used as the current collector for positive electrode. In some embodiments, copper is used as the current collector material for the negative electrode. In some embodiments, aluminum is used as the current collector material for the negative electrode.

In some embodiments, the gap between the first arc-shaped member and the second arc-shaped member can be at least about 50 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the gap between the first arc-shaped member and the second arc-shaped member can be no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, or no more than about 100 μm. Combinations of the above-referenced gap lengths are also possible (e.g., at least about 50 μm and no more than about 5 cm or at least about 1 mm and no more than about 1 cm), inclusive of all values and ranges therebetween. In some embodiments, the gap between the first arc-shaped member and the second arc-shaped member can be about 50 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm, about 3.5 cm, about 4 cm, about 4.5 cm, or about 5 cm.

In some embodiments, the current collector material can be thin and highly deformable. The handling of the current collector material can be controlled so as not to wrinkle, fold, tear, bend, dent, or otherwise mishandle the current collector during conveyance. In some embodiments, in order to help protect the current collector material from such damage, the current collector material can be received onto a film (i.e., a pouch material) before the semi-solid electrode slurry is disposed onto the current collector material (e.g., prior to step 15).

In some embodiments, disposing the current collector material onto a film before the semi-solid electrode slurry is disposed onto the current collector material may also help in transporting the current collector material past the dispensing mechanism. A significant challenge in casting the semi-solid electrode slurry onto the current collector material is preventing the current collector material from slipping on a casting pallet surface, such as the surface of the arc-shaped member of drum 110. It is generally desirable that the casting pallet have a high degree of surface flatness, which can, for example, be achieved through precision grinding. However, this grinding process, while ensuring a flat surface on the pallet or drum 110, tends to create a slippery surface. Therefore, applying a high-friction coating to the film surface presents an alternative method for generating friction between the current collector material and the casting pallet or drum 110, effectively addressing this issue. Accordingly, in some embodiments, the current collector material is disposed on a surface of a film material. In some embodiments, the film material has a first surface and a second surface opposite to the first surface. In some embodiments, the current collector material is disposed on a first surface of a film material. In some embodiments, the film material includes a coating disposed on a second surface of the film material opposite the first surface, the second surface being in contact with a surface of the first arc-shaped member and a surface of the second arc-shaped member. In some embodiments, the second surface of the film material has a coefficient of friction against the surfaces of the first arc-shaped member and the second arc-shaped member that is at least about 5% greater than a coefficient of friction of an uncoated second surface of the film material against the surfaces of the first arc-shaped member and the second arc-shaped member.

As used herein, a “coefficient of friction” refers to a ratio between the force necessary to move one surface horizontally over another and the pressure between the two surfaces. In some embodiments, the second surface of the film material has a coefficient of friction against the surfaces of the first arc-shaped member and/or the second arc-shaped member that is at least about 1%, at least about 3%, at least about 5%, at least about 7%, at least about 10%, at least about 13%, at least about 15%, at least about 17%, at least about 20%, at least about 23%, at least about 25%, at least about 27%, at least about 30%, at least about 33%, at least about 35%, at least about 37%, at least about 40%, at least about 43%, at least about 45%, at least about 47%, at least about 50%, at least about 53%, at least about 55%, at least about 57%, or at least about 60% greater than a coefficient of friction of an uncoated second surface of the film material against the surfaces of the first arc-shaped member and the second arc-shaped member.

In some embodiments, the coating and/or the second surface of the film material can include a multilayer film (i.e., having two or more layers). In some embodiments, the coating and/or the second surface of the film material can include a polymer, a metal, a ceramic, a silicon or combination thereof. In some embodiments, the coating and/or the second surface of the film material can include a pressure-sensitive adhesive film. In such embodiments, the coating and/or the second surface of the film material can become adhesive due to increase in pressure under a casting nozzle (e.g., the dispenser 130) during dispensing the semi-solid electrode material onto the surface of the first arc-shaped member and the second arc-shaped member.

In some embodiments, the coating and/or the second surface of the film material can include a heat activated adhesive film. In such embodiments, the coating and/or the second surface of the film material can become adhesive due to increase in temperature prior to dispensing a semi-solid electrode material onto a surface of the first arc-shaped member and the second arc-shaped member.

In some embodiments, the coating and/or the second surface of the film material can may be a woven or extruded plastic film, yarn, or any other fibrous material, known in the art. Examples of materials suitable for forming the coating and/or the second surface of the film material can include polyolefins, such as polyethylene, including high density polyethylene, low density polyethylene, linear low density polyethylene, and linear ultra-low density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadiene-styrene copolymers, and ethylene/propylene copolymers; acrylic polymers and copolymers; and combinations thereof. Mixtures or blends of any plastic and elastomeric materials such as polypropylene/polyethylene, polyurethane/polyolefin, polyurethane/polycarbonate, polyurethane/polyester, can also be used.

In some embodiments, the coating and/or the second surface of the film material can be in the form of single or multi-layer films, non-woven films, porous films, foam-like films, and combinations thereof. Material substrates can also be prepared from filled materials, such as, for example, filled films, e.g., calcium carbonate filled polyolefins.

The coating can be disposed on the second surface of the film material by any known method of film forming, such as, for example, extrusion, co-extrusion, solvent casting, spray coating, foaming, non-woven technology, and the like.

The coating can have any thickness so long as it possesses sufficient integrity to be processable and handleable. In some embodiments, the coating can have a thickness of at least about 500 nm, at least about 1 μm, at least about 5 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, or at least about 250 μm. In some embodiments, the coating can have a thickness of no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 75 μm, no more than about 50 μm, no more than about 25 μm, or no more than about 10 μm. Combinations of the above-reference ranges for foil thicknesses are also possible (e.g., at least about 500 nm and no more than about 10 μm or at least about 1 μm and no more than about 25 μm), inclusive of all values and ranges therebetween. In some embodiments, the coating can have a thickness of about 500 nm, about 1 μm, about 1.5 μm, about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, or about 10 μm.

In some embodiments, the coating includes a polymer film having a coefficient of friction against a counter material that is at least about 1%, at least about 3%, at least about 5%, at least about 7%, at least about 10%, at least about 13%, at least about 15%, at least about 17%, at least about 20%, at least about 23%, at least about 25%, at least about 27%, at least about 30%, at least about 33%, at least about 35%, at least about 37%, at least about 40%, at least about 43%, at least about 45%, at least about 47%, at least about 50%, at least about 53%, at least about 55%, at least about 57%, or at least about 60% greater than a coefficient of friction of the film material against the counter material.

In some embodiments, the current collector material can include a strip of conductive material that is not yet apportioned into discrete current collectors. The current collector material has a length defining a longitudinal axis, and a thickness that is defined as a dimension perpendicular to the longitudinal axis. The current collector material is configured to be transported though the conveyance system (i.e., the direction of travel) along its longitudinal axis. In some embodiments, the thickness of the current collector material can be substantially similar to the desired thickness or height of the current collector to be used in the finished semi-solid electrode. In some embodiments, the thickness of the current collector can be greater than about 100%, greater than about 105%, greater than about 110%, greater than about 120%, greater than about 130%, greater than about 140%, greater than about 150%, greater than about 175%, greater than about 200%, greater than about 300%, greater than about 400%, or greater than about 500% of the desired thickness of the current collector to be used in the finished semi-solid electrode.

In some embodiments, the current collector material has a thickness of between about 0.01 μm and about 100 μm, between about 100 nm and about 100 μm, between about 1 μm and about 95 μm, between about 1 μm and about 90 μm, between about 1 μm and about 85 μm, or between about 1 μm and about 80 μm, inclusive of all values and ranges therebetween. In some embodiments, the current collector material has a thickness of less than about 500 μm, less than about 400 μm, less than about 300 μm, less than about 200 μm, less than about 100 μm, less than about 90 μm, less than about 80 μm, less than about 70 μm, less than about 60 μm, less than about 50 μm, less than about 45 μm, less than about 40 μm, less than about 35 μm, less than about 30 μm, less than about 25 μm, less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, less than about 10 μm, less than about 9 μm, less than about 8 μm, less than about 7 μm, less than about 6 μm, less than about 5 μm, less than about 5 μm, less than about 4 μm, less than about 3 μm, less than about 2 μm, less than about 1 μm, less than about 900 nm, less than about 750 nm, less than about 500 nm, or less than about 100 nm, inclusive of all values and ranges therebetween.

In some embodiments, the method 10 further includes the use of a mechanical tucking tool during, or after step 11. The mechanical tucking tool may enable disposing a portion of the current collector material within the gap between the first arc-shaped member and the second arc-shaped member. Any suitable mechanical tool including, but not limited to an extending rod, an air knife, a tucking wire, or a flying tucking device can be used as the mechanical tucking tool. In some embodiments, the current collector material can be advanced along a carrier film. In some embodiments, a vacuum supplied from below the current collector material (and/or the carrier film) can be used to draw the current collector material (and/or the carrier film between adjacent pallets). In some embodiments, the mechanical tucking tool is configured to tuck the portion of the current collector material between the adjacent arc-shaped members as the current collector material moves past the tucking tool. In some embodiments, a computer vision system can be configured to monitor the tucking step and control precisely the tucking device, the movement of the arc-shaped members, and the timing of the tucking and untucking. In some embodiments, the computer vision system can be a closed loop computer vision system including a video camera, a processor, a memory, a power supply, and a computer-readable media configured to provide processing feedback to an automated manufacturing system.

In some embodiments, receiving the current collector at step 11 can be slowed, paused, or stopped in order to facilitate the disposition of the portion of the continuous current collector between the two arc-shaped members. In some embodiments, receiving the current collector 11 can be nonstop. In some embodiments, the current collector is received from an alignment drum that is mechanically coupled to the drum. In such embodiments, the alignment drum is configured to move at substantially the same speed as the drum. In some embodiments, the alignment drum can move synchronously with the drum. In some embodiments, the alignment drum ensures the uniform distribution of the current collector material onto the drum when the current collector material is received. For example, the alignment drum aids the current collector material not to be wrinkled, folded, torn, bent, dented, or otherwise mishandled during conveyance at step 12.

After receiving the current collector material onto the drum at step 11, the current collector material is conveyed along the surface of the first arc-shaped member and the surface of a second arc-shaped member at step 12, such that a portion of the current collector material is disposed into the gap between the first and second arc-shaped members. That is, a portion of the current collector material is disposed (e.g., interposed or tucked) between two open adjacent arc-shaped members. In some embodiments, the current collector material can be conveyed by the pallet and held in place on the pallet surface via frictional force. In some embodiments, the holding of the current collector material in place can be enabled by pallet surface friction and a normal vacuum force.

In some embodiments, the position of the current collector material that is conveyed along an outside edge of a drum is maintained via a vacuum inside the drum. In such embodiments, the arc-shaped members that forms the drum include holes on their surfaces to allow air flow such that the current collector material disposed on the surface of arc-shaped members can be pulled through the holes under vacuum. In some embodiments, the vacuum can pull and tuck portions of current collector material disposed onto the arc-shaped members into the drum to facilitate the portions of the current collector material tucked inside the gap between two adjacent arc-shaped members. Inducing tucking from within the drum can aid in preventing contamination of the electrode material dispensed on the current collector material. More specifically, a mechanical tucking tool described above, if not timed just right, can contact electrode material disposed on the current collector material. This electrode material can become deposited on the tucking tool. This deposited electrode material can contaminate later electrode materials that pass over the drum. Including a vacuum in the drum can prevent a piece of material from contacting and contaminating other materials. In addition, as the drum can move at high speeds (e.g., about 30 rpm, about 40 rpm, about 50 rpm, about 60 rpm, about 70 rpm, about 80 rpm, about 90 rpm, or about 100 rpm, inclusive of all values and ranges therebetween), it can be difficult for a mechanical tool to precisely target and penetrate the spaces between the arc-shaped members deeply enough such that the current collector are fully tucked between the arc-shaped members.

Step 13 includes moving the first arc-shaped member with respect to the second arc-shaped member to at least partially close the gap between the first arc-shaped member and the second arc-shaped member such that the current collector material is frictionally engaged with a portion of the first arc-shaped member and a portion of the second arc-shaped member. In other words, by adjusting the arc-shaped members from the open position to the closed position, the current collector can be pinched such that a portion of the current collector material is pinched between adjacent arc-shaped pallets. The method 10 optionally includes controlling the movement of the first arc-shaped member with respect to the second arc-shaped member by a rotating concave roller gear that is in contact with an outside surface of both the first arc-shaped member and the second arc-shaped member (i.e., the adjacent arc-shaped members).

In some embodiments, the movement of the first arc-shaped member with respect to the second arc-shaped member is controlled by the rotating concave roller gear in a time-staggered fashion. That is, the rotating concave roller gear can cause the gap between the first arc-shaped member and the second arc-shaped member to shrink during a pre-determined amount of time period. More specifically, the gap between two adjacent arc-shaped members can be slowly closed prior to dispensation of a semi-solid electrode material when the two adjacent arc-shaped members come into contact with the rotating concave roller gear during the travel of the drum. This time-staggered approach can allow for controlled closing of the gap between the first arc-shaped member and the second arc-shaped member such that the current collector material can be safely tucked in between the pallets prior to dispensation of the semi-solid electrode material.

After the gap is at least partially closed and the current collector material is tucked in between the arc-shaped members, optional step 14 includes maintaining a position of the first arc-shaped member with respect to the second arc-shaped member via a dynamic clamping force regulator system. In some embodiments, the current collector material can be tucked between the arc-shaped members while the gap is being closed (i.e., while the first arc-shaped member merges with the second arc-shaped member). In some embodiments, the dynamic clamping force regulator system can also ensure that the pallets squeeze together with the same force regardless of casting force. In some embodiments, the position of the first arc-shaped member with respect to the second arc-shaped member is maintained via a dynamic clamping force regulator system. Step 14 can allow for a longer period of time (i.e., for the current collector material and/or the carrier film to be tucked between adjacent pallets) for the electrode material to be dispensed onto a tucked current collector material than if the pallets are simply tucked for a brief period of time (e.g., the length of time the drum needs to travel a distance of the width of one arc-shaped member). In some embodiments, adjacent arc-shaped members can be coupled together for at least about 10%, at least about 15%, at least about 20%, at least about 25%, at least about 30%, at least about 35%, at least about 40%, at least about 45%, or at least about 50% of a full rotation around the center of the drum. In some embodiments, one or more pinion gears can be used to execute the time-staggered tucking of the current collector material. This step allows keeping the distance between two adjacent arc-shaped members in a closed or substantially closed position while a semi-solid electrode material is dispensed onto the moving members (i.e., pallets). In some embodiments, the dynamic clamping force regulator system includes a plurality of pinion gears after the gap is at least partially closed. In such embodiments, at least a portion of the plurality of pinion gears are in contact with a first portion of an outside edge of the first arc-shaped member and the second arc-shaped member. In some embodiments, the differential motion between the roller gear and a gear mechanism provides a clamping force to the tucked current collector material (and/or carrier film) to ensure that the current collector material and/or the carrier film remains tucked.

Once the current collector material is frictionally engaged between the adjacent arc-shaped members, a semi-solid electrode material is dispensed onto a surface of the first arc-shaped member and the second arc-shaped member at step 15. Since the dynamic clamping force regulator system described herein allows keeping the distance between two adjacent arc-shaped members in a closed or substantially closed position while a semi-solid electrode material is dispensed, deflection generated by dispensing the semi-solid electrode material (e.g., semi-solid slurry) can be minimized. This technique ensures that the high shear force reaction force that exists while driving the pallet and/or current collector along the casting nozzle does not damage the carrier film. Dispensing the semi-solid electrode material at step 15 can generate a significant amount of force upon the drum (on the surface of the arc-shaped members). The force generated by dispensing the semi-solid electrode material is proportional to the loading of the semi-solid electrode material (i.e., higher viscosity semi-solid slurry loading generates more force upon the drum). In some embodiments, the force acting upon the conveyance system can be greater than about 2,000 lbf (8,896 N), greater than about 2,500 lbf (11,120 N), greater than about 3,000 lbf (13,345 N), or greater than about 3,500 lbf (15,569 N). This force can cause mechanical deflections in the drum, regardless of how thoroughly the system is designed to limit deflections. These deflections can influence the casting gaps between the dispenser and the current collector, which impacts the thickness of the electrode. In some embodiments, the deflection can reach 100 μm over the course of only 10 mm of movement of the current collector through the drum. In some embodiments, an adjustable dispenser can move in such a way to counteract these deflections. In other words, the adjustable dispenser can move up and down (i.e., along the z-axis) to compensate for the deflection caused by force of the dispensed slurry. In some embodiments, the dispenser can move up and down (i.e., in the z-direction) along the entire thickness of the electrode.

In some embodiments, a semi-solid electrode material is dispensed onto the first arc-shaped member and the second arc-shaped member approximately horizontal (i.e., in a direction parallel to the ground) and in a direction tangential to the movement of the current collector material that is frictionally engaged with a portion of the first arc-shaped member and a portion of the second arc-shaped member. In some embodiments, the semi-solid electrode material can be dispensed at an angle relative to the ground (e.g., about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees, inclusive of all values and ranges therebetween).

In some embodiments, the semi-solid electrode material is provided by mixing the active material, the conductive material, and an electrolyte together. In some embodiments, the semi-solid electrode material is provided via a dispenser (e.g., a casting nozzle coupled to a receiver (e.g., a container that are filled with the semi-solid electrode material). In some embodiments, the semi-solid electrode material is provided 100 by mixing the active material, the conductive material, and the electrolyte without a binder. In some embodiments, the semi-solid electrode material can be binderless or substantially binderless. In some embodiments, the mixing can be via a continuous process. In some embodiments, the mixing can be in a continuous mixer. In some embodiments, the mixing can be in a twin-screw extruder. Further examples of mixing methods and compositions are described in U.S. Pat. No. 9,484,569, entitled “Electrochemical Slurry Compositions and Methods for Preparing the Same,” the entire disclosure of which is hereby incorporated by reference in its entirety.

After dispensing a semi-solid electrode material from a dispenser such as a nozzle, the second arc-shaped member is moved with respect to the first arc-shaped member to re-form the gap between the first arc-shaped member and the second arc-shaped member at step 16. In some embodiments, the gap between the first arc-shaped member and the second arc-shaped member is re-generated after dispensation of the semi-solid electrode material via a damping system. In some embodiments, the arc-shaped members can be spring-loaded into an open configuration. The damping system can control the opening motion such that it happens smoothly. This step allows controlling the speed of re-formation of the gap between the adjacent arc-shaped members. The damping system includes at least one pinion gear, and the at least one pinion gear is in contact with a second portion of an outside edge of the first arc-shaped member and the second arc-shaped member. In some embodiments, the reformation of the gap is controlled by a damping system including at least one pinion gear that is in contact with the adjacent arc-shaped members whose gap will be re-formed. That is, the gap between the adjacent arc-shaped members is slowly re-generated while the adjacent arc-shaped members move past the damping system while the drum is rotating.

Step 17 includes forming a first discrete portion of electrode material and a second discrete portion of electrode material on the surface of the current collector material. In some embodiments, the formation of the first discrete portion of electrode material and the second discrete formation of electrode material can occur at least partially simultaneously. Because no semi-solid electrode material is dispensed onto the segment of the current collector material nestled between the neighboring arc-shaped members (i.e., the portion that is tucked between the neighboring arc-shaped members), a gap's re-creation between two adjacent arc-shaped members leads to the emergence of distinct first and second electrode material portions on the current collector material's surface.

In some embodiments, the current collector material can be cut into individualized current collectors (e.g., via laser cutting). In some embodiments, each individualized current collector with the discrete portion of semi-solid electrode slurry disposed thereupon can be considered the finished electrode. In some embodiments, the finished electrode can be disposed onto an electrically insulating material (e.g., laminate pouch material) such that the current collector directly abuts the insulating material. In some embodiments, an adhesive can be used to retain the finished electrode on the insulating material. In some embodiments, as described above, the current collector can be pre-disposed to the insulating material (e.g., pouch material) such that individualization of the current collector material also includes cutting the insulating material to form the finished electrode.

In some embodiments, the finished electrode can include an electrode tab electrically connected to the current collector and configured to transport electrons into or out of the electrode. In some embodiments, the electrode tab can extend beyond the current collector and/or the insulating material. In some embodiments, the electrode tab can be electrically coupled to the current collector before the semi-solid electrode slurry is disposed onto the current collector. In some embodiments, the electrode can include integrated electrical tabbing, which can obviate inclusion of, for example, (i) a discrete tab component (e.g., an electrical lead), (ii) connecting dedicated tabs to current collectors, and/or (iii) a dedicated tab sealing operation. Instead, in some embodiments, an electrical tab or lead can be provided as an extension of the current collector integral to the current collector. In some embodiments, the tab or lead can be defined by removal of material from a larger area of current collector material, thereby defining the current collector and the tab or lead.

In some embodiments, the method 10 can include wetting the semi-solid electrode with a solvent. Solvent (i.e., electrolyte solvent) can evaporate during any part of the method 10. This can reduce the movement of electroactive species through the semi-solid electrode and subsequent electrochemical cell. Thus, replacement of this solvent can aid in reducing such occurrences. In some embodiments, the wetting can include spraying. In some embodiments, the wetting can include spraying a solvent. In some embodiments, the wetting can include spraying an electrolyte. In some embodiments, the wetting can include spraying a solvent and spraying an electrolyte. In some embodiments, the wetting can include spraying a solvent onto the semi-solid electrode. In some embodiments the wetting can include spraying an electrolyte onto the semi-solid electrode. In some embodiments, the wetting can include spraying both a solvent and an electrolyte onto the semi-solid electrode. In some embodiments, the solvent can be ink jet printed for high precision application. Ink jet printing can limit or completely eliminate overspray. In some embodiments, a separator can be disposed onto the semi-solid electrode and the spraying can be onto the separator. In some embodiments, the wetting can include spraying a solvent onto the separator. In some embodiments the wetting can include spraying an electrolyte onto the separator. In some embodiments, the wetting can include spraying both a solvent and an electrolyte onto the separator.

In some embodiments, the method 10 can include spraying hard carbon. In some embodiments, the hard carbon can be ink jet printed onto the semi-solid electrode material. In some embodiments, the method 10 can include spraying a hard carbon suspension. In some embodiments, the method 10 can include applying a hard carbon suspension onto the semi-solid electrode. In some embodiments, the method 10 can include spraying a hard carbon suspension onto the semi-solid electrode. In some embodiments, the method 10 can include applying a hard carbon suspension onto the separator. In some embodiments, the method 10 can include spraying a hard carbon suspension onto the separator. Examples of electrodes, separators, and electrochemical cells that incorporate hard carbon are described in International Patent Publication No. 2023/0118961, entitled “Electrochemical Cells and electrodes with Carbon-containing Coatings and Methods of Making the Same,” the entire disclosure of which is hereby incorporated by reference in its entirety.

In some embodiments, solvent can be sprayed onto the separator. In some embodiments, spraying the separator with solvent can make the solvent adhere to the semi-solid electrode more easily. In some embodiments, solvent can be ink jet printed onto the separator. In some embodiments, the spraying can be onto the semi-solid electrode. In some embodiments, the solvent can include an electrolyte salt. In some embodiments, the solvent can be without the electrolyte salt. In some embodiments, the solvent can be added (e.g., via spraying) to a conventional electrode (i.e., a solid electrode) with an electrolyte salt. Wetting a large format conventional electrode can be difficult. Wetting the large area of the conventional electrode with an electrolyte and/or solvent before assembly can be beneficial in conventional electrochemical cell manufacture (e.g., conventional Li ion electrochemical cell manufacturing).

In some embodiments, the semi-solid electrode can optionally be conveyed through a tunnel, for example, an environmentally controlled tunnel or passage. The tunnel can aid in preventing evaporation of the solvent. In other words, the tunnel can reduce the venting effect of the semi-solid electrode being exposed to the surrounding environment. Any portion of the drum can include a tunnel overhead. In other words, the tunnel can be deployed during any part of the method 10 (e.g., before the wetting).

In some embodiments, the semi-solid electrode can optionally be adjoined to an additional electrode (i.e., an adjoining electrode) interposed by a separator to form an electrochemical cell. In some embodiments, the adjoining electrode can come from a drum from the semi-solid electrode. In some embodiments, the adjoining electrode can be placed on top of the semi-solid electrode from above. In some embodiments, the adjoining electrode can be a conventional electrode.

In some embodiments, the electrochemical cell can optionally be sealed in a pouch. In some embodiments, the sealing of the pouch can be via impulse heating. Sealing methods of pouches often use a sealing device with constant heat applied to the sealing device. In the presence of such heat, pouch materials can warp and wrinkle. Additionally, electrolyte from the semi-solid electrode can evaporate in such heat. With the use of impulse heating, the application of heat is very quick, such that the surrounding environment does not significantly increase in temperature. In addition, the sealing can be via a single sealing apparatus. In other words, a single apparatus can seal all around the perimeter of the pouch in one motion, rather than sealing just one side at a time via multiple passes or multiple sealing devices.

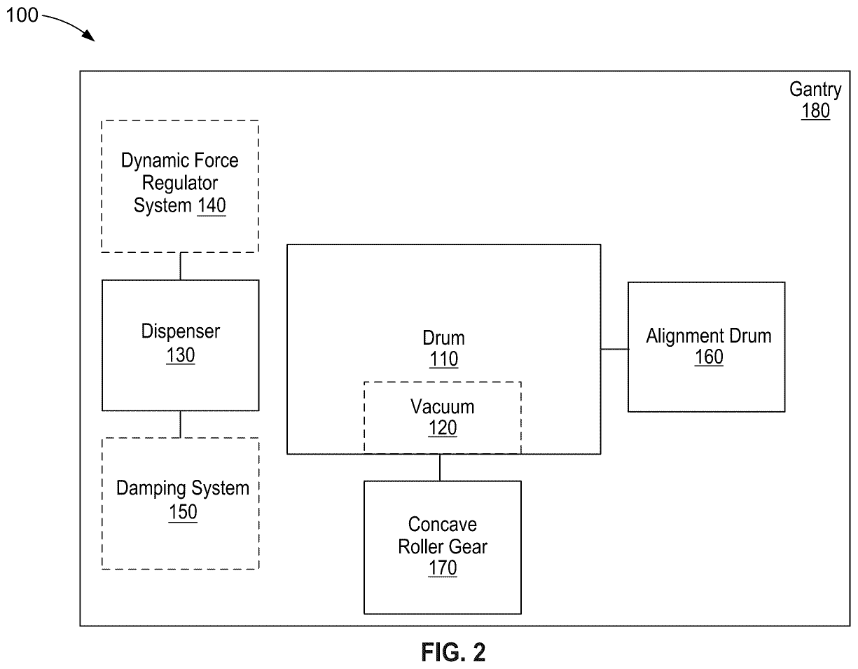

FIG. 2 is a block diagram of a system 100 for manufacturing a semi-solid electrode, according to an embodiment. The system 100 includes a drum 110 including a plurality of arc-shaped members (i.e., pallets) and an optional vacuum 120 disposed therein, a dispenser 130, an optional dynamic clamping force regulator system 140 and an optional damping system 150 configured to regulate the dispenser 130, an alignment drum 160, and at least one concave roller gear 170. In some embodiments, each of the components of the system 100 can be disposed on a gantry 180 (e.g., a gantry with a turret).

The gantry 180 includes a mechanical framework or structure (e.g., a platform) that holds and supports the elements of system 100 (e.g., the drum 110, the alignment drum 160). That is, the elements of system 100 working together can be placed and positioned onto the gantry 180. The gantry 180 may be made of any suitable material consisting of, but not limited to, steel, aluminum, stainless steel, composite materials (e.g., fiber reinforced polymers), high strength alloys (e.g., steel alloys having a tensile exceeding 1,000 MPa, titanium alloys, nickel alloys, aluminum alloys).

In some embodiments, the gantry 180 enables movement and/or positioning of the elements of system 100 that are placed on the gantry 180. For example, in some embodiments, the gantry 180 can move along a single linear axis such that the system elements placed onto the gantry 180 move together with the gantry 180. In some embodiments, the gantry 180 can move in multiple directions (e.g., combining linear and vertical movement). In some embodiments, the gantry 180 enables positioning of the elements of system 100 from one location on the gantry 180 to another location on the gantry 180. For example, the gantry 180 can be designed such that a position of the drum 110 on the gantry 180 can be changed from a first position to a second position (e.g., a different position on an x-y plane). The gantry 180 described herein may further include a rotating platform (e.g., a turret). A gantry 180 with a turret may combine the capabilities of both the rotating platform and a base platform to achieve enhanced versatility and efficiency in tasks that require movement, positioning, and rotation.

The drum 110 is formed of a plurality of arc-shaped members (i.e., pallets). In some embodiments, the plurality of arc-shaped pallets includes 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 arc-shaped pallets. In some embodiments, the number of arc-shaped pallets that form the drum is between about 8 and about 200, between about 8 and about 150, between about 8 and about 100, between about 8 and about 90, between about 8 and about 80, between about 8 and about 70, between about 8 and about 60, between about 8 and about 50, between about 8 and about 45, between about 8 and about 40, and between about 8 and about 20, inclusive of all values and ranges therebetween.

In some embodiments, the drum 110 has a radius of at least about 20 cm, at least about 25 cm, at least about 30 cm, at least about 35 cm, at least about 40 cm, at least about 45 cm, at least about 50 cm, at least about 55 cm, at least about 60 cm, at least about 65 cm, at least about 70 cm, at least about 75 cm, at least about 80 cm, at least about 85 cm, at least about 90 cm, at least about 95 cm, at least about 100 cm, at least about 105 cm, at least about 110 cm, at least about 115 cm, at least about 120 cm, at least about 125 cm, at least about 130 cm, at least about 135 cm, at least about 140 cm, at least about 150 cm, at least about 155 cm, at least about 160 cm, at least about 165 cm, at least about 170 cm, at least about 175 cm, at least about 180 cm, at least about 185 cm, at least about 190 cm, at least about 195 cm, at least about 200 cm, at least about 220 cm, at least about 240 cm, at least about 260 cm, at least about 280 cm, at least about 300 cm, at least about 350 cm, at least about 400 cm, or at least about 450 cm. In some embodiments, the drum 110 has a radius between about 20 cm to about 500 cm, about 20 cm to about 450 cm, about 20 cm to about 400 cm, about 20 cm to about 350 cm, about 20 cm to about 300 cm, about 20 cm to about 250 cm, about 20 cm to about 200 cm, about 20 cm to about 150 cm, about 20 cm to about 140 cm, about 20 cm to about 130 cm, about 20 cm to about 120 cm, about 20 cm to about 110 cm, about 20 cm to about 100 cm, about 20 cm to about 90 cm, about 20 cm to about 80 cm, about 20 cm to about 60 cm, inclusive of all values and ranges therebetween. In some embodiments, the drum 110 has a radius of no more than about 500 cm, no more than about 450 cm, no more than about 400 cm, no more than about 350 cm, no more than about 300 cm, no more than about 280 cm, no more than about 260 cm, no more than about 240 cm, no more than about 220 cm, no more than about 200 cm, no more than about 195 cm, no more than about 190 cm, no more than about 185 cm, no more than about 180 cm, no more than about 175 cm, no more than about 170 cm, no more than about 165 cm, no more than about 160 cm, no more than about 155 cm, no more than about 150 cm, no more than about 145 cm, no more than about 140 cm, no more than about 135 cm, no more than about 130 cm, no more than about 125 cm, no more than about 120 cm, no more than about 115 cm, no more than about 110 cm, no more than about 105 cm, no more than about 100 cm, no more than about 95 cm, no more than about 90 cm, no more than about 85 cm, no more than about 80 cm, no more than about 75 cm, no more than about 70 cm, no more than about 65 cm, no more than about 60 cm, no more than about 55 cm, no more than about 50 cm, no more than about 45 cm, no more than about 40 cm, no more than about 35 cm, no more than about 30 cm, or no more than about 25 cm. Combinations of the above-referenced radius values are also possible (e.g., at least about 20 cm and no more than about 500 cm or at least about 40 cm and no more than about 200 cm), inclusive of all values and ranges therebetween. In some embodiments, the drum 110 has a radius of about 20 cm, about 25 cm, about 30 cm, about 35 cm, about 40 cm, about 45 cm, about 50 cm, about 55 cm, about 60 cm, about 65 cm, about 70 cm, about 75 cm, about 80 cm, about 85 cm, about 90 cm, about 95 cm, about 100 cm, about 105 cm, about 110 cm, about 115 cm, about 120 cm, about 125 cm, about 130 cm, about 135 cm, about 140 cm, about 150 cm, about 155 cm, about 160 cm, about 165 cm, about 170 cm, about 175 cm, about 180 cm, about 185 cm, about 190 cm, about 195 cm, about 200 cm, about 220 cm, about 240 cm, about 260 cm, about 280 cm, about 300 cm, about 350 cm, about 400 cm, about 450 cm, or about 500 cm.

In some embodiments, the drum 110 is rotated around a shaft. In some embodiments, the shaft is directly coupled to a motor or another power source (e.g., an electric motor), enabling direct transfer of rotational motion. For instance, an electric motor can be attached to the shaft to provide continuous or controlled rotation. In some embodiments, the shaft is rotated via a gear mechanism. For example, by connecting gears to the shaft and applying force to one gear, the shaft can be rotated.

The drum 110 can move at various speeds (e.g., about 5 rpm, about 10 rpm, about 15 rpm, about 20 rpm, about 25 rpm, about 30 rpm, about 40 rpm, about 50 rpm, about 60 rpm, about 70 rpm, about 80 rpm, about 90 rpm, or about 100 rpm, inclusive of all values and ranges therebetween).

In some embodiments, the arc-shaped members have a surface including one or more holes. The holes on the surface can allow air flow such that the current collector material disposed on the surface of arc-shaped members can be pulled through the holes under vacuum when vacuum is placed within the drum 110. In some embodiments, the holes have a diameter of about 0.1 mm, about 0.5 mm, about 1 mm, about 2 mm, about 3 mm about 4 mm, about 5 mm, about 1 cm, about 2 cm, about 3 cm, about 4 cm, or about 5 cm, inclusive of all values and ranges therebetween.

In some embodiments, the arc-shaped member has a surface arc length of at least about 10 cm, at least about 15 cm, at least about 20 cm, at least about 25 cm, at least about 30 cm, at least about 35 cm, at least about 40 cm, at least about 45 cm, at least about 50 cm, at least about 55 cm, at least about 60 cm, at least about 65 cm, at least about 70 cm, at least about 75 cm, at least about 80 cm, at least about 85 cm, at least about 90 cm, at least about 95 cm, at least about 100 cm, at least about 150 cm, or at least about 200 cm. In some embodiments, the arc-shaped member cam have a surface arc length of no more than about 250 cm, no more than about 200 cm, no more than about 150 cm, no more than about 100 cm, no more than about 95 cm, no more than about 90 cm, no more than about 85 cm, no more than about 80 cm, no more than about 75 cm, no more than about 70 cm, no more than about 65 cm, no more than about 60 cm, no more than about 55 cm, no more than about 50 cm, no more than about 45 cm, no more than about 40 cm, no more than about 35 cm, no more than about 30 cm, no more than about 25 cm, no more than about 20 cm, or no more than about 15 cm. Combinations of the above-referenced surface arc lengths are also possible (e.g., at least about 10 cm and no more than about 250 cm or at least about 40 cm and no more than about 100 cm). In some embodiments, the arc-shaped member has a surface arc length of about 10 cm, about 15 cm, about 20 cm, about 25 cm, about 30 cm, about 35 cm, about 40 cm, about 45 cm, about 50 cm, about 55 cm, about 60 cm, about 65 cm, about 70 cm, about 75 cm, about 80 cm, about 85 cm, about 90 cm, about 95 cm, about 100 cm, about 150 cm, about 200 cm, or about 250 cm.

As shown in FIG. 2, the system 100 includes a dispenser 130 (e.g., a nozzle). The dispenser casts an electrode material (e.g., a semi-solid electrode material) on the current collector material. In some embodiments, the dispenser 130 receives the electrode material from a receiver (e.g., a container, a cartridge) that is filled with the electrode material. In some embodiments, the receiver is placed onto the gantry 180.

In some embodiments, the dispenser 130 can cast the electrode material horizontally (i.e., in a direction parallel to the ground). In such embodiments, the dispenser 130 can cast the electrode material on a side of the drum 110. In some embodiments, the dispenser 130 can cast the electrode material in a direction perpendicular to the ground. In some embodiments, the dispenser 130 can cast at an angle of about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, about 125 degrees, about 130 degrees, about 135 degrees, about 140 degrees, about 145 degrees, about 150 degrees, about 155 degrees, about 160 degrees, about 165 degrees, about 170 degrees, about 175 degrees, about 180 degrees, about 185 degrees, about 190 degrees, about 195 degrees, about 200 degrees, about 205 degrees, about 210 degrees, about 215 degrees, about 220 degrees, about 225 degrees, about 230 degrees, about 235 degrees, about 240 degrees, about 245 degrees, about 250 degrees, about 255 degrees, about 260 degrees, about 265 degrees, about 270 degrees, about 275 degrees, about 280 degrees, about 285 degrees, about 290 degrees, about 295 degrees, about 300 degrees, about 305 degrees, about 310 degrees, about 315 degrees, about 320 degrees, about 325 degrees, about 330 degrees, about 335 degrees, about 340 degrees, about 345 degrees, about 350 degrees, or about 355 degrees relative to the vertical plane at the top of the drum 110, inclusive of all values and ranges therebetween.

In some embodiments, the dispenser 130 can move to control casting gaps between the dispenser 130 and the drum 110 to a precision of less than about 10 m, less than about 9 m, less than about 8 m, less than about 7 m, less than about 6 m, less than about 5 m less than about 4 m, less than about 3 m, less than about 2 m, or less than about 1 am. In some embodiments, the gap between the dispenser 130 and the drum 110 can be adjusted (e.g., via a computer algorithm controlling movement of the dispenser 130) at distance intervals traveled by the drum 110. For example, the dispenser 130 can be adjusted once for every 10 mm the drum 110 travels. These quick adjustments can aid in creating uniformity in the thickness of resulting electrodes. In some embodiments, the position of the dispenser 130 relative to the drum 110 can be adjusted once for about every 1 mm, about every 2 mm, about every 3 mm, about every 4 mm, about every 5 mm, about every 6 mm, about every 7 mm, about every 8 mm, about every 9 mm, about every 10 mm, about every 11 mm, about every 12 mm, about every 13 mm, about every 14 mm, about every 15 mm, about every 16 mm, about every 17 mm, about every 18 mm, about every 19 mm, about every 20 mm, about every 25 mm, about every 25 mm, about every 30 mm, about every 35 mm, about every 40 mm, about every 45 mm, or about every 50 mm the drum 110 travels, inclusive of all values and ranges therebetween.

The system 100 includes at least one concave roller gear 170 being in touch with an outside surface of at least two of the arc-shaped pallets (i.e., the adjacent arc-shaped members). In some embodiments, the system 100 includes two concave roller gears 170 and each of the concave roller gears is in touch with an outside surface of at least about 2, at least about 3, at least about 4, at least about 5, at least about 6, at least about 7, at least about 8, at least about 9, at least about 10, at least about 11, at least about 12, at least about 13, at least about 14, at least about 15, at least about 16, at least about 17, at least about 18, at least about 19, at least about 20, at least about 25, or at least about 30 of the adjacent arc-shaped pallets.

In some embodiments, the concave roller gear 170 rotates in a direction parallel to the direction of drum 110. In some embodiments, the rotation of the concave roller gear 170 is governed by the rotation of the drum 110. That is, when the drum 110 stops rotating, the concave roller gear 170 comes to stop as well. In other words, in some embodiments, the concave roller gear 170 and the drum 110 are mechanically coupled to each other (e.g., in touch).

In some embodiments, the concave roller gear 170 controls the closing of arc-shaped members (i.e., pallets) prior to dispensing the electrode material. This creates a precisely controlled time-staggered pallet closing which allows time for tucking the current collector material between the closing pallets. That is, the rotating concave roller gear 170 can cause the gap between the first arc-shaped member and the second arc-shaped member to shrink during a pre-determined amount of time period. More specifically, the gap between two adjacent arc-shaped members can be slowly closed prior to dispensation of a semi-solid electrode material when the two adjacent arc-shaped members come into contact with the rotating concave roller gear during the travel of the drum. This time-staggered approach can allow for controlled closing of the gap between the first arc-shaped member and the second arc-shaped member such that the current collector material can be safely tucked in between the pallets prior to dispensation of the semi-solid electrode material.

In some embodiments, the concave roller gear 170 is positioned between the alignment drum 160 and the dispenser 130 in the anticlockwise direction. In some embodiments, the concave roller gear 170 includes two concave roller gears 170. In some embodiments, the two concave roller gears 170 are separated between each other with a gap (i.e., a portion of the pallets' surface).

The concave roller gear 170 can be any suitable concave gear selected from the group of, but not limited to, cycloidal gears, crown gears, spherical gears, globoidal gears, or worm gears. In some embodiments, the concave roller gear 170 is selected from globoidal gears.

In some embodiments, the concave roller gear 170 has one or more groove (e.g., teeth) on its surface. In some embodiments, the concave roller gear 170 has two, three, four, five, six, seven, eight, nine, ten, eleven, twelve, thirteen, fourteen, fifteen, sixteen, seventeen, eighteen, nineteen, or twenty grooves, inclusive of all values and ranges therebetween. In some embodiments, the one or more grooves can be positioned on the surface of the concave roller gear 170 such that the one or more grooves create a spiral distribution. In some embodiments, a distance between two adjacent grooves is less than a surface arc length of one arc-shaped pallet.

In some embodiments, the concave roller gear 170 has a variable pitch (i.e., the theoretical circle that the gear's teeth engage with) that changes along its length. In other words, in some embodiments, the concave roller gear 170 has a diameter of the pitch circle that varies along its length. This diameter may affect the gear's rotational speed. In some embodiments, the concave roller gear 170 is a variable pitch globoidal concave roller gear.

In some embodiments, the concave roller gear 170 has a variable diameter that is in a range of about 10 cm to about 200 cm, about 10 cm to about 180 cm, about 10 cm to about 160 cm, about 10 cm to about 140 cm, about 10 cm to about 120 cm, about 10 cm to about 100 cm, about 10 cm to about 80 cm, about 10 cm to about 60 cm, about 10 cm to about 40 cm, about 10 cm to about 30 cm, about 10 cm to about 20 cm, about 20 cm to about 200 cm, about 20 cm to about 180 cm, about 20 cm to about 160 cm, inclusive of all values and ranges therebetween. In some embodiments, the concave roller gear 170 has a variable diameter that is in a range of about 60 cm to about 180 cm.

The concave roller gear 170 can be made from a variety of materials, each chosen based on factors such as the application's requirements, load-bearing capacity, wear resistance, and operating conditions. For example, the concave roller gear 170 can be made from a group of materials consisting of, but not limited to, aluminum, steel, bronze, brass, ceramics, polymers and plastics (e.g., nylon, Delrin (acetal), of PEEK), or any suitable combination thereof.

Referring to FIG. 2, the system 100 optionally further includes a dynamic clamping force regulator system 140. In some embodiments, the dynamic clamping force regulator system 140 includes a plurality of pinion gears (e.g., at least 1, 2, 3, 4, 5, 6, 7, 8, 9 or 10). In some embodiments, the dynamic clamping force regulator system 140 includes 3 pinion gears. In some embodiments, the dynamic clamping force regulator system 140 includes 5 pinion gears. In some embodiments, the dynamic clamping force regulator system 140 includes 7 pinion gears. In some embodiments, at least a portion of the plurality of pinion gears are in contact with a first portion of an outside edge of the drum. For example, in some embodiments, the dynamic clamping force regulator system 140 includes three pinion gears, and two of pinion gears are in contact with a first portion of an outside edge of the drum. In some embodiments, the pinion gears can be spur or helical type. In some embodiments, the pinion gear have a pitch diameter less than a surface arc length of one arc-shaped pallet. In some embodiments, the pinion gears have a pitch diameter less than a surface arc length of two arc-shaped pallets. In some embodiments, the pinion gears have a pitch diameter between a surface arc length of one arc-shaped pallet and a surface arc length of one arc-shaped pallets, inclusive of all values and ranges therebetween.

In some embodiments, the dynamic clamping force regulator system 140 is positioned between the dispenser 130 and the alignment drum 160 in the clockwise direction.

In some embodiments, each of the pinion gears that are in contact with an outside edge of the drum 110 is positioned such that each pinion gear can control at least two arc-shaped members that are passing through the dispenser 130.

In some embodiments, the dynamic clamping force regulator system 140 controls the closed arch pallets once they are in the casting zone (e.g., once the pallets arrives at the dispenser 130). The closed pallets are controlled by a dynamic pouch clamping control system 140 including a plurality of pinion gears driving the pallets as they traverse though the casting zone. In some embodiments, the plurality of pinion gears are controlled by a servo that can maintain a precise gap between adjacent arc-shaped pallets independent of the casting shear force.

In some embodiments, the gap between the pallets is adjustable via a setting on a machine control panel. In some embodiments, the system 100 can be calibrated without a material to control the pallets to a measurable (load cell) closing force. These settings are associated with specific pallets. This calibration factors out any mechanical variations in the system. When in operation, these settings are used to control the specific pallets to the desired gap through the casting zone.

Referring again to FIG. 2, the system 100 further includes a damping system 150 including at least one pinion gear. In some embodiments, the damping system 150 is positioned between the alignment drum 160 and the dynamic clamping force regulator system 140 in the clockwise direction. In some embodiments, the at least one pinion gear is in contact with a portion of an outside edge of the drum 110 such that the at least one pinion gear is adjacent to the dynamic clamping force regulator system 140 and separated by a distance of less than a surface arc length of one arc-shaped member.

The optional damping system 150 controls the opening speed of the two adjacent arc-shaped members of the drum 110. The pallets can be held open via springs. The damping system can control and smooth the opening and/or closing of the pallets. When a portion of an outside edge of two adjacent closed arc-shaped members come into contact with the at least one pinion gear, the gap between the two adjacent closed arc-shaped members starts to be re-generated after the two adjacent closed arc-shaped members pass the casting zone (i.e., after passing the dispenser 130). This step allows controlling the speed of re-formation of the gap between the adjacent arc-shaped members.

The system 100 also includes an alignment drum 160. In some embodiments, the alignment drum 160 is positioned between the damping system 150 and the concave roller gear 170 in the clockwise direction. In some embodiments, the alignment drum 160 is positioned between the dispenser 130 and the concave roller gear 170 in the clockwise direction.

The alignment drum 160 feeds the drum 110 with the current collector material. That is, the current collector material is received from the alignment 160 drum onto the surface of a first arc-shaped member and the surface of a second arc-shaped member.

In some embodiments, the alignment drum 160 is mechanically coupled to the drum, such that the alignment drum 160 is driven synchronously with the drum 110. In such embodiments, the alignment drum is configured to move at substantially the same speed as the drum.

In some embodiments, the alignment drum 160 can have a diameter of at least about 1 cm, at least about 5 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, the alignment drum 160 can have a diameter of no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, or no more than about 5 cm. Combinations of the above-referenced diameters of the alignment drum 160 are also possible (e.g., at least about 1 cm and no more than about 1 m or at least about 10 cm and no more than about 50 cm), inclusive of all values and ranges therebetween. In some embodiments, the alignment drum 160 can have a diameter of about 1 cm, about 5 cm, about 10 cm, about 20 cm, about 30 cm, about 40 cm, about 50 cm, about 60 cm, about 70 cm, about 80 cm, about 90 cm, or about 1 m.

In some embodiments, the alignment drum ensures the uniform distribution of the current collector material onto the drum 110 when the current collector material is received. For example, the alignment drum 160 aids the current collector material not to be wrinkled, folded, torn, bent, dented, or otherwise mishandled when it is received by the drum 110. In order to achieve reproducible and uniform electrodes, the current collector material needs to be received on the drum 110 precisely. Accordingly, in some embodiments, the relative position of the alignment drum 160 with respect to drum 110 can be changed during feeding of the current collector material onto the drum 110. For example, the alignment drum 160 may have an inner portion which holds the current collector material, and the inner portion can be moved relative to the driven outer sections of the alignment drum 110. As the current collector material lands on the center portion of the alignment drum 110, the inner portion of the alignment drum 160 can be moved in a closed loop fashion to bring the inner portion into the proper position relative to the driven outer sections of the drum 110.

In some embodiments, the current collector material is in the form of a foil. In some embodiments, the current collector is disposed on a pouch material. In some embodiments, the current collector material can have a thickness of at least about 500 nm, at least about 1 μm, at least about 1.5 μm, at least about 2 μm, at least about 2.5 μm, at least about 3 μm, at least about 3.5 μm, at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, or at least about 9.5 μm. In some embodiments, the foil can have a thickness of no more than about 10 μm, no more than about 9.5 μm, no more than about 9 μm, no more than about 8.5 μm, no more than about 8 μm, no more than about 7.5 μm, no more than about 7 μm, no more than about 6.5 μm, no more than about 6 μm, no more than about 5.5 μm, no more than about 5 μm, no more than about 4.5 μm, no more than about 4 μm, no more than about 3.5 μm, no more than about 3 μm, no more than about 2.5 μm, no more than about 2 μm, no more than about 1.5 μm, or no more than about 1 μm. Combinations of the above-reference ranges for foil thicknesses are also possible (e.g., at least about 500 nm and no more than about 10 μm or at least about 1 μm and no more than about 5 μm), inclusive of all values and ranges therebetween. In some embodiments, the foil can have a thickness of about 500 nm, about 1 μm, about 1.5 μm, about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, or about 10 μm.

As shown in FIG. 2, the system 100 also optionally includes an at least one vacuum 120. In some embodiments, the drum 110 can include a vacuum 120 therein, such that the vacuum 120 can pull, and tuck portions of the current collector material disposed on the arc-shaped members into the drum 110. In such embodiments, the arc-shaped members include holes on their surfaces to allow air flow. The vacuum tucking can pull portions of the current collector material thereon inward to facilitate tucking of the current collector. Inducing tucking from within the drum 110 can aid in preventing contamination of the electrode material dispensed on the current collector material. More specifically, a tucking arm or a tucking finger, if not timed just right, can contact electrode material disposed on the current collector material. This electrode material can become deposited on the tucking arm or the tucking finger. This deposited electrode material can contaminate later electrode materials that pass over the drum 110. Including a vacuum in the drum 110 can prevent a piece of material from contacting and contaminating other materials. Additionally, the vacuum inside the drum 110 can aid in tucking the current collector material deeper than a tucking arm or a tucking finger. In some embodiments, the drum 110 can move at high speeds (e.g., about 40 rpm, about 50 rpm, about 60 rpm, about 70 rpm, about 80 rpm, about 90 rpm, or about 100 rpm, inclusive of all values and ranges therebetween). These high speeds can make it difficult for a tucking arm or a tucking finger to precisely target and penetrate the spaces between the arc-shaped pallets deeply enough such that the current collector are fully tucked between the pallets.

In some embodiments, the vacuum 120 can apply a downward force on the arc-shaped pallets, such that the arc-shaped pallets experience a pressure of at least about 1 MPa, at least about 2 MPa, at least about 3 MPa, at least about 4 MPa, at least about 5 MPa, at least about 6 MPa, at least about 7 MPa, at least about 8 MPa, or at least about 9 MPa. In some embodiments, the vacuum 120 can apply a downward force on the arc-shaped pallets, such that the arc-shaped pallets experience a pressure of no more than about 10 MPa, no more than about 9 MPA, no more than about 8 MPA, no more than about 7 MPA, no more than about 6 MPA, no more than about 5 MPA, no more than about 4 MPA, no more than about 3 MPA, or no more than about 2 MPA. Combinations of the above-referenced pressures experienced by the arc-shaped pallets due to the downward force of the vacuum 120 are also possible (e.g., at least about 1 MPa and no more than about 10 MPa or at least about 3 MPa and no more than about 7 MPa), inclusive of all values and ranges therebetween. In some embodiments, the vacuum 120 can apply a downward force on the arc-shaped pallets, such that the arc-shaped pallets experience a pressure of about 1 MPa, about 2 MPa, about 3 MPa, about 4 MPa, about 5 MPa, about 6 MPa, about 7 MPa, about 8 MPa, about 9 MPa, or about 10 MPa.

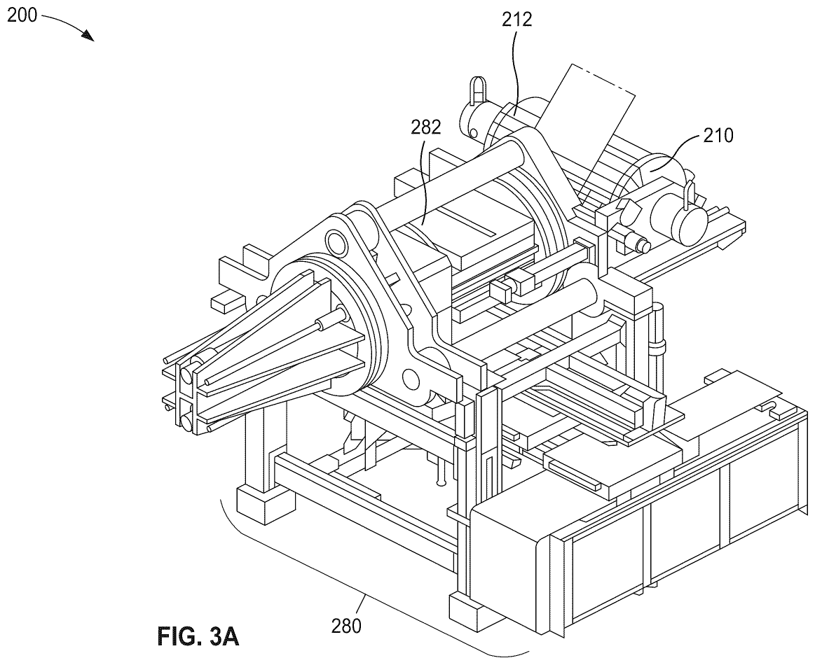

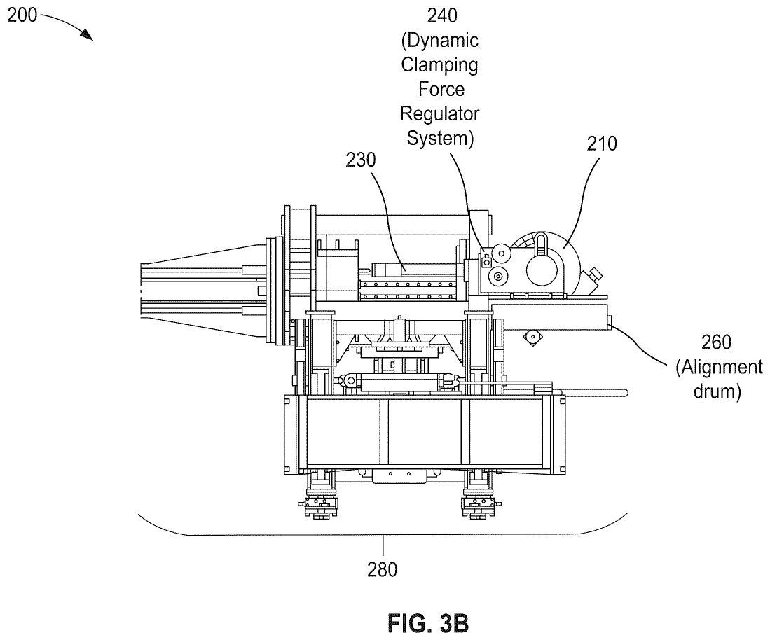

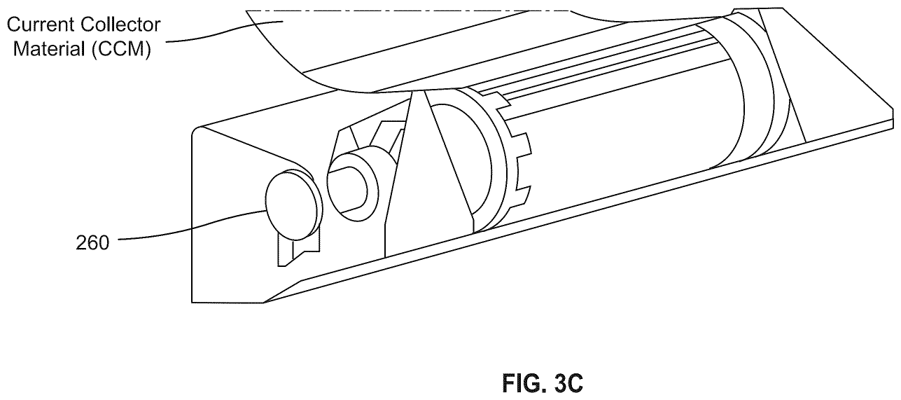

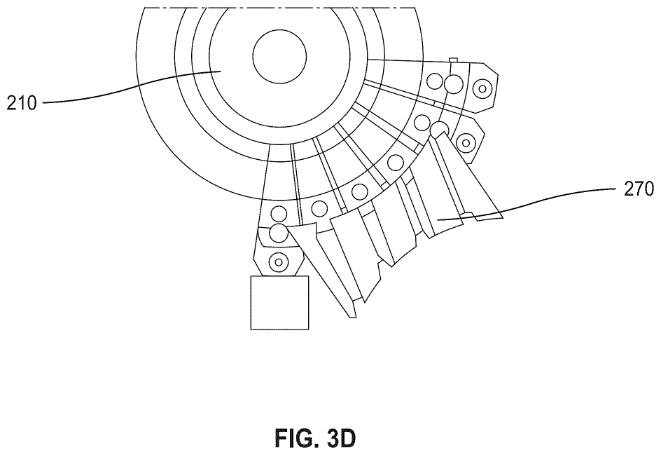

FIGS. 3A-3D are illustrations of the system 200 for manufacturing a semi-solid electrode, and various components thereof, according to an embodiment. As shown, the system 200 includes a drum 210, a dispenser 230, a dynamic force regulator system 240, an alignment drum 260, a concave roller gear 270, and a gantry 280. In some embodiments, the drum 210, the dispenser 230, the dynamic force regulator system 240, the alignment drum 260, the concave roller gear 270, and the gantry 280 can be the same or substantially similar to the drum 110, the dispenser 130, the dynamic force regulator system 140, the alignment drum 160, the concave roller gear 170, and the gantry 180, as described above with reference to FIG. 1. FIG. 3A shows a perspective view of the system 200. FIG. 3B shows a side profile view of the system 200. FIG. 3C shows a detailed view of the alignment drum 260. FIG. 3D shows a detailed view of the drum 210 and the concave roller gear 270.

The drum 210 includes a plurality of arc-shaped members 212 (i.e., pallets). In some embodiments, the arc-shaped members 212 have a surface arc length of at least about 20 cm, about 25 cm, about 30 cm, about 35 cm, about 40 cm, about 45 cm, about 50 cm, about 55 cm, about 60 cm, about 65 cm, about 70 cm, about 75 cm, about 80 cm, about 85 cm, about 90 cm, about 95 cm, about 100 cm, about 105 cm, about 110 cm, about 115 cm, about 120 cm, about 125 cm, about 130 cm, about 135 cm, about 140 cm, about 150 cm, about 155 cm, about 160 cm, about 165 cm, about 170 cm, about 175 cm, about 180 cm, about 185 cm, about 190 cm, about 195 cm, or about 200 cm. In some embodiments, the surface arc length of the pallets 212 is between about 20 cm to about 200 cm, about 20 cm to about 150 cm, about 20 cm to about 140 cm, about 20 cm to about 130 cm, about 20 cm to about 120 cm, about 20 cm to about 110 cm, about 20 cm to about 100 cm, about 20 cm to about 90 cm, about 20 cm to about 80 cm, about 20 cm to about 60 cm, inclusive. In some embodiments, the surface arc length of the pallets 212 is between about 30 cm to about 50 cm. In some embodiments, the surface arc length of the pallets 212 is between about 35 cm to about 50 cm.

The arc-shaped members 212 can be made of any suitable material that is strong enough to minimize deflection generated by dispensing the semi-solid electrode material. For example, the arc-shaped members 212 can be made of at least one of a metal (e.g., steel, aluminum), an alloy, a plastic, a wood (e.g., a hardwood), a composite (e.g., wood and plastic).

In some embodiments, the system 200 further includes a plurality of receivers 282. The plurality of receivers 282 may be filled with a semi-solid electrode material. In some embodiments, the dispenser (e.g., the dispenser 130) receives the electrode material from a receiver 282 (e.g., a container, a cartridge) that is filled with the electrode material. In some embodiments, the receiver is placed onto the gantry 280. In some embodiments, the gantry 280 includes 1, 2, 3, 4, 5, 6, 7, 8, 9 or 10 receivers. In some embodiments, the gantry 280 includes 5 receivers. In some embodiments, the dispenser (e.g., the dispenser 130) receives the electrode material from the receiver 282 that is placed on top of the other receivers. Once the electrode material within the receiver placed on top of the other receivers is finished, the finished receiver can be changed (manually or automatically) with the receiver completely or partially filled with the electrode material positioned at the bottom of the plurality of receivers 282. This process can increase the speed of the manufacturing.

In FIG. 3A, the receivers 282 are depicted as having a substantially rectangular shape, but this is for illustrative purposes only and the receivers 282 may have any other three-dimensional (3D) shape, for example, substantially cuboid, cylindrical, rectangular prism, pentagonal prism, hexagonal prism, trapezoidal prism, octagonal prism, any other suitable shape, or a combination thereof. The receiver described herein may have a volume between about 50 mL and about 100 mL, about 50 mL and about 200 mL, about 50 mL and about 300 mL, about 50 mL and about 400 mL, about 50 mL and about 500 mL, about 50 mL and about 600 mL, about 50 mL and about 700 mL, about 50 mL and about 800 mL, about 50 mL and about 900 mL, about 50 mL and about 1 L, about 50 mL and about 1.5 L, about 50 mL and about 2 L, about 50 mL and about 3 L, about 50 mL and about 4 L, about 50 mL and about 5 L, about 50 mL and about 6 L, about 50 mL and about 7 L, about 50 mL and about 8 L, about 50 mL and about 9 L, about 50 mL and about 10 L, about 50 mL and about 20 L, and about 50 mL and about 30 L. In some embodiments, the receiver can have a volume of at least about 50 mL, at least about 100 mL, at least about 200 mL, at least about 300 mL, at least about 400 mL, at least about 500 mL, at least about 600 mL, at least about 700 mL, at least about 800 mL, at least about 900 mL, at least about 1 L, at least about 2 L, at least about 3 L, at least about 4 L, at least about 5 L, at least about 6 L, at least about 7 L, at least about 8 L, at least about 9 L, at least about 10 L, or at least about 20 L. In some embodiments, the receiver can have a volume of no more than about 30 L, no more than about 20 L, no more than about 10 L, no more than about 9 L, no more than about 8 L, no more than about 7 L, no more than about 6 L, no more than about 5 L, no more than about 4 L, no more than about 3 L, no more than about 2 L, no more than about 1 L, no more than about 900 mL, no more than about 800 mL, no more than about 700 mL, no more than about 600 mL, no more than about 500 mL, no more than about 400 mL, no more than about 300 mL, no more than about 200 mL, or no more than about 100 mL. Combinations of the above-referenced volumes are also possible (e.g., at least about 50 mL and no more than about 30 L or at least about 300 mL and no more than about 5 L), inclusive of all values and ranges therebetween. In some embodiments, the receiver can have a volume of about 50 mL, about 100 mL, about 200 mL, about 300 mL, about 400 mL, about 500 mL, about 600 mL, about 700 mL, about 800 mL, about 900 mL, about 1 L, about 2 L, about 3 L, about 4 L, about 5 L, about 6 L, about 7 L, about 8 L, about 9 L, about 10 L, about 20 L, or about 30 L.

FIG. 3B is a side view of system 200 including the dynamic clamping force regulator system 240, the drum 210 and the alignment drum 260 placed onto the gantry 280. FIG. 3C shows a magnified view of the alignment drum 260 that feeds the drum 210 with a current collector material (CCM). The current collector material (CCM) may be substantially similar to the current collector material described above. In some embodiments, the alignment drum 260 and the drum 210 are mechanically coupled to each other to rotate synchronously, ensuring that they maintain the same rotational speed and stay in alignment. The alignment drum 260 and the drum 210 can be connected to each other in several ways. In some embodiments, the alignment drum 260 can rotate around a first shaft. In some embodiments, the drum 210 can rotate around a second shaft. In some embodiments, the first shaft and the second shaft can be connected with each other through a coupling (e.g., flexible couplings, such as jaw couplings or Oldham couplings, or a rigid coupling). In some embodiments, synchronous motors can be used to drive the drum 210 and alignment drum 260. The synchronous motors run at a fixed speed determined by the supply frequency and can ensure synchronous rotation. In some cases, a direct mechanical linkage, such as a rigid rod or lever, can be used to couple the drum 210 and alignment drum 260 and ensure synchronous rotation. In some embodiments, gears (e.g., meshing gears, spur gears, helical gears, or bevel gears) can provide a precise and rigid connection between the drum 210 and the alignment drum 260. Gears offer efficient torque transfer and can provide accurate synchronization. In some embodiments, timing belts or chains with matching tooth profiles can be used to connect the drum 210 and the alignment drum 260. This method is commonly used when the drums are at a distance from each other. The teeth on the belts or chains ensure synchronized rotation and can handle some misalignment. In some embodiments, one or more chain and sprocket system can synchronize the rotation of the drum 210 and the alignment drum 260. The chain wraps around sprockets on both drums, ensuring they rotate at the same speed. When selecting a method to mechanically couple the drum 210 and the alignment drum 260, factors such as the desired precision, load capacity, flexibility, misalignment tolerance, and maintenance requirements are considered.

FIG. 3D shows an enlarged view of the concave roller gear 270 that is in contact with an outside surface of five adjacent arc-shaped members of the drum 210. Although the concave roller gear 270 is depicted as in contact with five adjacent arc-shaped members, this is for illustrative purposes only and the concave roller gear 270 can be in contact with an outside surface of two, three, four, six, seven, eight, nine, or ten adjacent arc-shaped members of the drum 210.

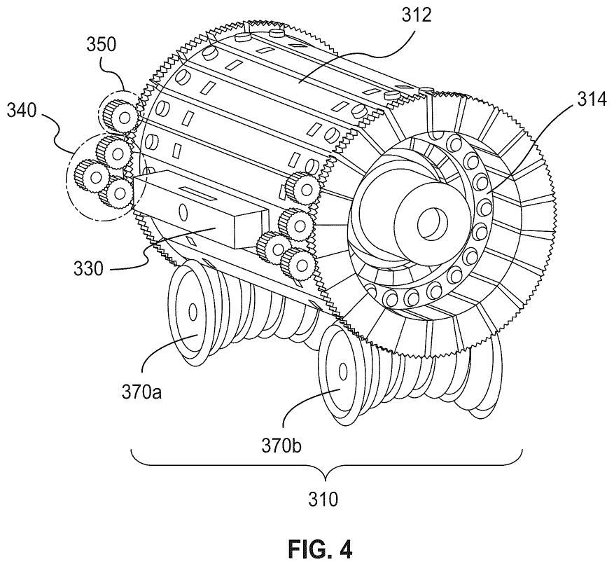

FIG. 4 is an illustration of a drum 310 for casting of semi-solid electrode material, according to an embodiment. The drum 310 includes a plurality of arc-shaped members (i.e., pallets) 312, a dispenser 330, two concave roller gears 370a and 370b, a dynamic clamping force regulator system 340, a damping system 350 and pitch control links 314. In some embodiments, the drum 310 may lack at least one of the alignment drum 360, the dynamic clamping force regulator system 340, the damping system 350 and the concave gears 370a and 370b. In some embodiments, the system 100 further includes a vacuum (not shown) inside the drum 310. The elements of drum 310 may be substantially similar to the elements described above.

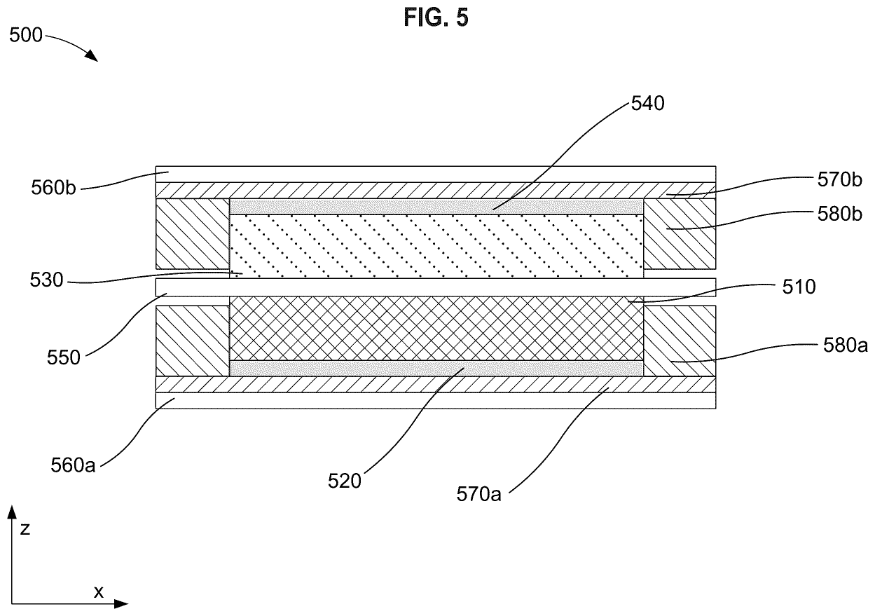

FIG. 5 is an illustration of an electrochemical cell 500, according to an embodiment. As shown, the electrochemical cell 500 includes an anode material 510 disposed on an anode current collector 520, a cathode material 530 disposed on a cathode current collector 540, with a separator 550 disposed between the anode material 510 and the cathode material 530. A film 560a and a film 560b are disposed around the outside of the electrochemical cell 500. Collectively, the film 560a and the film 560b form a pouch. An adhesive layer 570a is disposed between the anode current collector 520 and the film 560a. An adhesive layer 570b is disposed between the cathode current collector 540 and the film 560b. An endframe 580a is disposed on the adhesive 570a and around an outside edge of the anode material 510. An endframe 580b is disposed on the adhesive 570b around an outside edge of the cathode material 530. Axes are shown for structural clarity.

The endframe 580a can have a thickness substantially the same or almost as much as a thickness of the anode material 510. The endframe 580b can have a thickness substantially the same or almost as much as a thickness of the cathode material 530. A tall endframe (i.e., the endframe 580a and/or the endframe 580b, collectively referred to as endframes 580) can reduce edge deformation of the anode material 510 and/or the cathode material 530, particularly when the anode material 510 and/or the cathode material 530 includes a semi-solid electrode material. Additionally, thicker/taller endframes 580 can create more uniform pressure distribution throughout the anode material 510 and/or the cathode material 530.

In some embodiments, the thickness of the endframe 580a can be less than the thickness of the anode material 510 by less than about 100 μm, less than about 90 μm, less than about 80 μm, less than about 70 μm, less than about 60 μm, less than about 50 μm, less than about 40 μm, less than about 30 μm, less than about 20 μm, less than about 10 μm, less than about 9 μm, less than about 8 μm, less than about 7 μm, less than about 6 μm, less than about 5 μm, less than about 4 μm, less than about 3 μm, less than about 2 μm, or less than about 1 μm. In some embodiments, the thickness of the endframe 580a can be the same or substantially similar to the thickness of the anode material 510. In some embodiments, the thickness of the endframe 580b can be less than the thickness of the cathode material 530 by less than about 100 μm, less than about 90 μm, less than about 80 μm, less than about 70 μm, less than about 60 μm, less than about 50 μm, less than about 40 μm, less than about 30 μm, less than about 20 μm, less than about 10 μm, less than about 9 μm, less than about 8 μm, less than about 7 μm, less than about 6 μm, less than about 5 μm, less than about 4 μm, less than about 3 μm, less than about 2 μm, or less than about 1 μm. In some embodiments, the thickness of the endframe 580b can be the same or substantially similar to the thickness of the cathode material 530.

In some embodiments, the endframes 580 can have a width (i.e., a dimension in the x-direction) of at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the endframes 580 can have a width of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced widths are also possible (e.g., at least about 100 μm and no more than about 1 cm or at least about 1 mm and no more than about 5 mm), inclusive of all values and ranges therebetween. In some embodiments, the endframes 580 can have a width of about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

As shown, the endframes 580 are bonded to the films 560a, 560b via the adhesive 570a, 570b. In some embodiments, the endframe 580a can be bonded directly to the anode current collector 520. In some embodiments, the endframe 580b can be bonded directly to the cathode current collector 540. In some embodiments, the film 560a and/or the film 560b can include polyethylene terephthalate (PET), or any other suitable polymer.

In some embodiments, the film 560a and/or the film 560b may include a coating disposed on a second surface of the film 560a, 560b to the first surface, the second surface being in contact with a surface of a first casting pallet (e.g., a first arc-shaped member) and a surface of a second casting pallet (e.g., a second arc-shaped member) disposed along an outside edge of a drum. In some embodiments, the first casting pallet and the second casting pallet have a gap therebetween.

In some embodiments, the second surface of the film 560a, 560b can have a coefficient of friction against the surfaces of the first and second casting pallet that is at least about 1%, at least about 3%, at least about 5%, at least about 7%, at least about 10%, at least about 13%, at least about 15%, at least about 17%, at least about 20%, at least about 23%, at least about 25%, at least about 27%, at least about 30%, at least about 33%, at least about 35%, at least about 37%, at least about 40%, at least about 43%, at least about 45%, at least about 47%, at least about 50%, at least about 53%, at least about 55%, at least about 57%, or at least about 60% greater than a coefficient of friction of an uncoated second surface of the film 560a, 560b against the surfaces of the first and second arc-shaped members.

In some embodiments, the coating may include a heat and/or pressure activated adhesive film. In some embodiments, the coating may include a heat and/or pressure responsive polymer.

In some embodiments, the coating includes a polymer film having a coefficient of friction against a counter material that is at least about 1%, at least about 3%, at least about 5%, at least about 7%, at least about 10%, at least about 13%, at least about 15%, at least about 17%, at least about 20%, at least about 23%, at least about 25%, at least about 27%, at least about 30%, at least about 33%, at least about 35%, at least about 37%, at least about 40%, at least about 43%, at least about 45%, at least about 47%, at least about 50%, at least about 53%, at least about 55%, at least about 57%, or at least about 60% greater than a coefficient of friction of the film material against the counter material. In some embodiments, the counter material may be a surface of a casting pallet (e.g., an arc-shaped member of a casting drum).

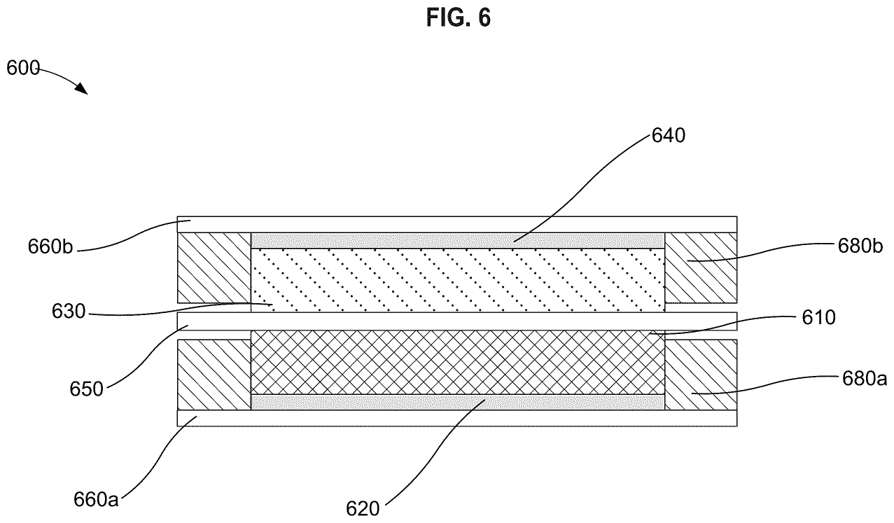

FIG. 6 is an illustration of an electrochemical cell 600, according to an embodiment. As shown, the electrochemical cell 600 includes an anode material 610 disposed on an anode current collector 620, a cathode material 630 disposed on a cathode current collector 640, with a separator 650 disposed between the anode material 610 and the cathode material 630. A film 660a and a film 660b are disposed around the outside of the electrochemical cell 600. Collectively, the film 660a and the film 660b form a pouch. An endframe 680a is disposed on the film 660a and around an outside edge of the anode material 610. An endframe 680b is disposed on the film 660b around an outside edge of the cathode material 630. In some embodiments, the anode material 610, the anode current collector 620, the cathode material 630, the cathode current collector 640, the separator 650, the film 660a, the film 660b, the endframes 680a, 680b (collectively referred to as endframes 680) can be the same or substantially similar to the anode material 510, the anode current collector 520, the cathode material 530, the cathode current collector 540, the separator 550, the film 560a, the film 560b, and the endframes 580, as described above with reference to FIG. 5. Thus, certain aspects of the anode material 610, the anode current collector 620, the cathode material 630, the cathode current collector 640, the separator 650, the film 660a, the film 660b, and the endframes 680 680b are not described in greater detail herein.

As shown, the electrochemical cell 600 does not include an adhesive layer between the endframe 680a and the film 660a or between the endframe 680b and the film 660b. In other words, the endframes 680 are directly coupled to the films 660a, 660b (collectively referred to as films 660). In some embodiments, the endframes 680 can be directly coupled to the films 660 via a thin layer of adhesive. In some embodiments, the endframes 680 can be laminated to the films 660. Additionally, the anode current collector 620 and the cathode current collector 640 are each coupled directly to the films 660. In some embodiments, the anode current collector 620 and/or the cathode current collector 640 can be coupled to the films 660 via electrochemical deposition, vapor deposition, sputtering, or any combination thereof.

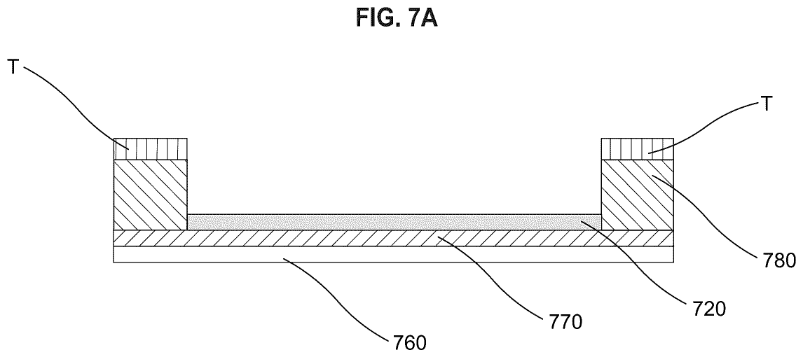

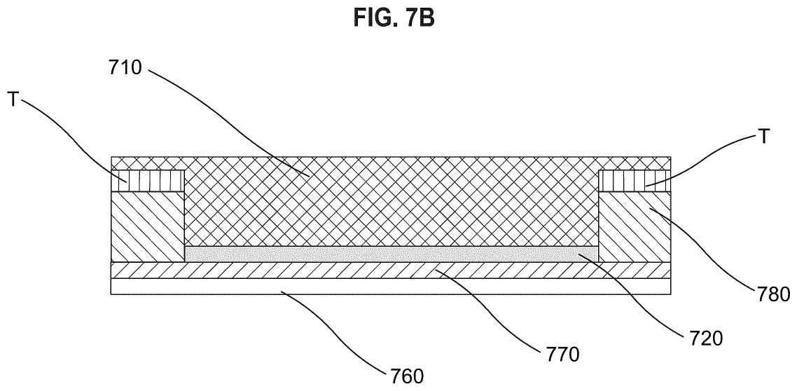

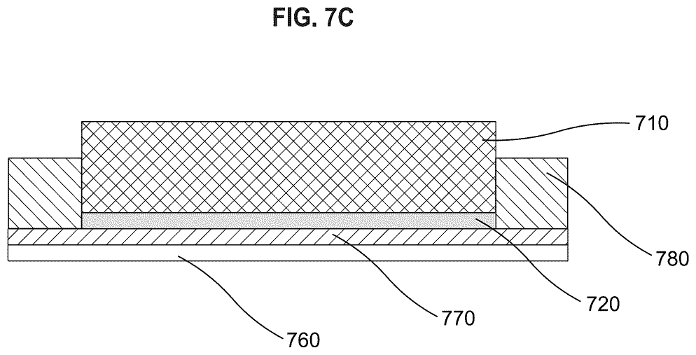

FIGS. 7A-7C are illustrations of a production process for an electrode, according to an embodiment. As shown in FIG. 7A, an adhesive layer 770 is coupled to a film 760. An anode current collector 720 is coupled to the adhesive layer 770. An endframe 780 is coupled to the adhesive layer 770 around the outside edge of the anode current collector 720. Layers of tape T are disposed on the endframe 780. As shown in FIG. 7B, a semi-solid anode material 710 has been dispensed onto the anode current collector 720 (e.g., via a casting nozzle, as described above). As shown, the tape T protects the endframe 780 from having semi-solid electrode material disposed thereon. In FIG. 7C, the tape T has been removed, and the endframe 780 remains without semi-solid electrode material on its top side. In some embodiments, the tape T can be removed via ultraviolet (UV) radiation. In some embodiments, the UV radiation can aid in curing the adhesive layer 770. In some embodiments, the tape T can be removed by manual peeling. In some embodiments, the anode material 710, the anode current collector 720, the film 760, the adhesive layer 770, and the endframe 780 can be the same or substantially similar to the anode material 510, the anode current collector 520, the film 560, the adhesive layer 570, and the endframe 580, as described above with reference to FIG. 5. FIGS. 7A-7C show a production process for a semi-solid anode. The same or a substantially similar process can be exercised in the production of a semi-solid cathode.

In some embodiments, the semi-solid anode material 710 can be wetted via a solvent. In some embodiments, the wetting can be via spraying. In some embodiments, the solvent can be used to wet the electrode material. In some embodiments, the solvent can be applied to the separator. In some embodiments, the solvent can include ethylene carbonate (EC), propylene carbonate (PC), dimethyl carbonate (DMC), or any combination thereof. In some embodiments, the solvent can include an electrolyte salt (i.e., the solvent can be an electrolyte). In some embodiments, the electrolyte salt can have a concentration in the solvent of at least about 1 M, at least about 1.5 M, at least about 2 M, at least about 2.5 M, at least about 3 M, at least about 3.5 M, at least about 4 M, at least about 4.5 M, or at least about 5 M. The addition of a solvent to the semi-solid anode material 710 can reduce the viscosity of the semi-solid anode material, such that the semi-solid anode material can be more easily processed in the endframe 780.

In some embodiments, the tape T can be composed of PET. In some embodiments, the tape T can include a polyimide film with a silicon adhesive. In some embodiments, the tape T can include multiple tape layers. In some embodiments, the tape T can have a thickness of at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, at least about 19 μm, at least about 20 μm, at least about 30 μm, at least about 40 μm, at least about 50 μm, at least about 60 μm, at least about 70 μm, at least about 80 μm, or at least about 90 μm. In some embodiments, the tape T can have a thickness of no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9 μm, no more than about 8 μm, no more than about 7 μm, no more than about 6 μm, no more than about 5 μm, no more than about 4 μm, no more than about 3 μm, or no more than about 2 μm. Combinations of the above-referenced thicknesses are also possible (e.g., at least about 1 μm and no more than about 100 μm or at least about 10 μm and no more than about 50 μm), inclusive of all values and ranges therebetween. In some embodiments, the tape T can have a thickness of about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 30 μm, about 40 μm, about 50 μm, about 60 μm, about 70 μm, about 80 μm, about 90 μm, or about 100 μm.

In some embodiments, the semi-solid anode 710 can be pressed. In some embodiments, the endframe 780 can have a thickness less than a thickness of the semi-solid anode 710 after the semi-solid anode 710 has been pressed. In some embodiments, a semi-solid cathode material can be used in place of the semi-solid anode material 710.

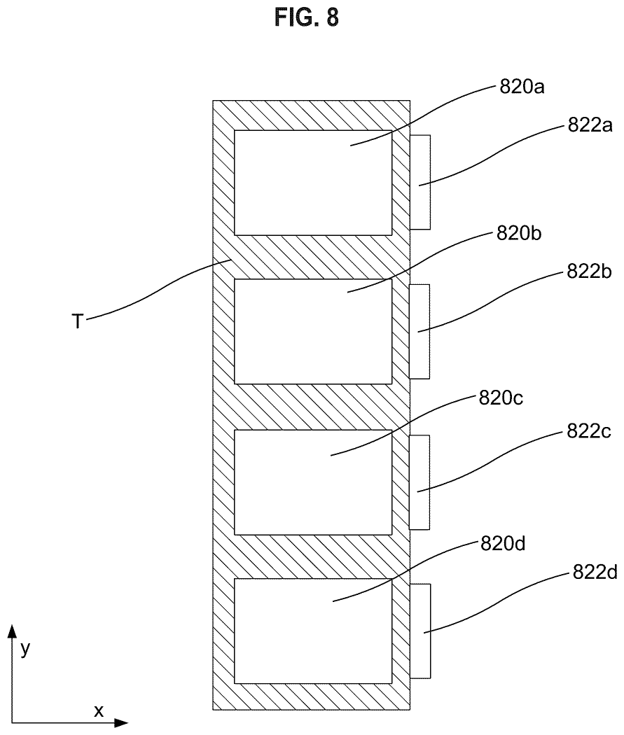

FIG. 8 is an illustration of a collection of components of an electrochemical cell, and their interaction with a tape covering, according to an embodiment. FIG. 8 is an overhead view of a row of anode current collectors 820a, 820b, 820c, 820d (collectively referred to as anode current collectors 820) distributed and covered with endframe material (not shown). The endframe material is covered with tape T. Axes are shown for structural clarity. Anode tabs 822a, 822b, 822c, 822d (collectively referred to as anode tabs 822) extend from the anode current collectors 820.

As shown, the tape T covers the endframe material in a “picture-frame” arrangement. In other words, the tape T has a rectangular shape with void sections that do not cover the anode current collectors 820. The semi-solid anode material can then be casted onto the anode current collectors 820 (i.e., in the negative z-direction). The tape T can then be removed, along with excess semi-solid anode material. FIG. 8 includes anode current collectors 820 for casting of anode material. In some embodiments, cathode current collectors can be organized and processed in the same or a substantially similar manner.

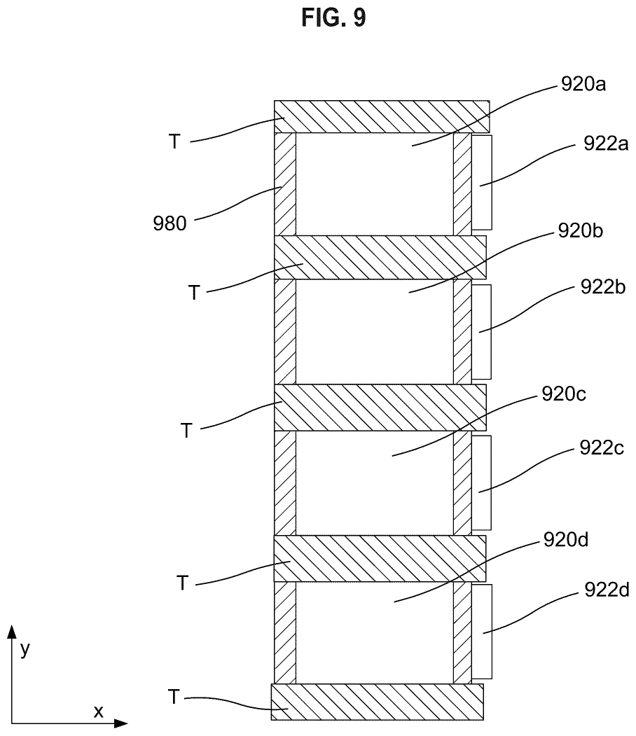

FIG. 9 is an illustration of a collection of components of an electrochemical cell, and their interaction with a tape covering, according to an embodiment. FIG. 9 is an overhead view of a row of anode current collectors 920a, 920b, 920c, 920d (collectively referred to as anode current collectors 920) distributed and covered with endframe material 980. The endframe material is covered with sections of tape T. Axes are shown for structural clarity. Anode tabs 922a, 922b, 922c, 922d (collectively referred to as anode tabs 922) extend from the anode current collectors 920.

As shown, the sections of tape T cover the endframe material 980 in discrete lines of tape T. The sections of tape T cover the endframe material 980 between the regions where the semi-solid anode material is to be casted. This requires less material and is easier to implement than the picture frame assembly (i.e., FIG. 8), but may be less effective at preventing semi-solid electrode material from contacting the endframe material 980. FIG. 9 includes anode current collectors 920 for casting of anode material. In some embodiments, cathode current collectors can be organized and processed in the same or a substantially similar manner.

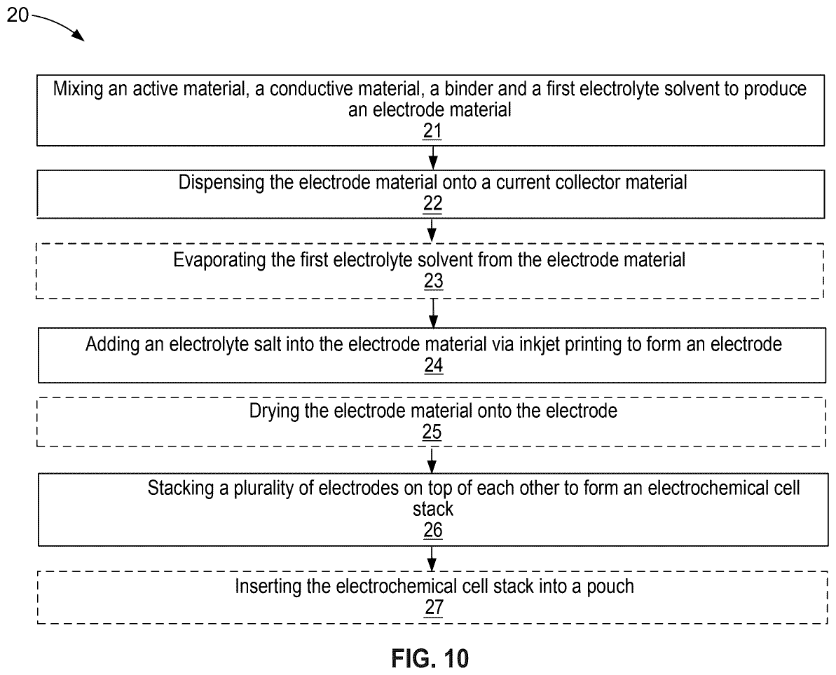

FIG. 10 shows a schematic flow chart of a method 20 of manufacturing of an electrochemical cell stack, according to an embodiment. The method 20 can be used for fabrication of large format electrochemical cells (e.g., conventional Li-ion cells) with low length-to-width aspect ratios. In some embodiments, the large format cells (i.e., large capacity cells) can be incorporated into an electrochemical cell stack. In some embodiments, the electrochemical cell stack includes a number of alternating layers of separator, then cathode (or anode) electrode, then separator, then anode (or cathode) electrode. This stacking arrangement can be repeated multiple times (e.g., 50 times) to reach the desired cell capacity and/or voltage according to the cell design and specification. Such large format cells can be used to build large, high energy density electrochemical cell modules. Large format low aspect ratio modules can have a relatively high energy density and are effective for heat dissipation.

The method 20 includes mixing an active material, a conductive material, a binder and a first electrolyte solvent to produce an electrode material, at step 21, the electrolyte solvent is being free of an electrolyte salt. The method 20 further includes dispensing the electrode material onto a current collector at step 22 and adding an electrolyte salt into the electrode material via inkjet printing to form an electrode at step 24. In some embodiments, the electrolyte salt is dissolved in a second electrolyte solvent. The method 20 also includes stacking a plurality of electrodes on top of each other to form an electrochemical cell stack at step 26 while separating adjacent current collectors from each other with a separator material. The method 20 optionally includes evaporating the first electrolyte solvent from the electrode material at step 23 prior to adding the electrolyte salt. The method 20 optionally includes drying the electrode material onto the current collector after adding the electrolyte salt at step 25. The method 20 may further include inserting the electrochemical cell stack into a pouch at step 27.

At step 21, the method 20 includes mixing an active material, a conductive material, a binder and a first electrolyte solvent to produce an electrode material. In some embodiments, the active material and the conductive material are substantially similar to the active material and the conductive material described herein with respect to FIG. 1.

In some embodiments, the active material can include silicon, tin, silicon alloys, tin alloys, aluminum, titanium oxide, lithium metal, carbon, lithium-intercalated carbon, lithium nitrides, lithium alloys and lithium alloy forming compounds of silicon, bismuth, boron, gallium, indium, zinc, tin, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon oxide, silicon carbide.

In some embodiments, the conductive material can include graphite, activated carbon, conductive carbon particles (e.g., KETJENBLACK™ carbon), hard carbon, soft carbon, carbon nanotubes, carbon nanofibers, Nickel-Metal Hydride (NiMH), Nickel Cadmium (NiCd), lithium cobalt oxide, lithium iron phosphate (LFP), or any combination thereof.

In some embodiments, the first electrolyte solvent is free or substantially free of an electrolyte salt. The first electrolyte solvent can be chosen from any suitable solvent (e.g., having ability to dissolve the active material, the conductive material and the binder) that has been used for manufacturing of a conventional Li-ion cells. In some embodiments, the first electrolyte solvent includes N-methyl pyrrolidone (NMP). In some embodiments, the first electrolyte solvent includes cyclic carbonates (ethylene carbonate (EC), propylene carbonate, butylene carbonate, fluoroethylene carbonate), linear carbonates (dimethyl carbonate (DMC), diethyl carbonate (DEC), ethylmethyl carbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1,2-diethoxyethane, ethoxymethoxyethane), cyclic ethers (tetrahydrofuran, 2-methyltetrahydrofuran), and mixtures thereof.

The binder may be used to structurally hold the active material and the conductive material together. In some embodiments, the binder may include polyvinylidene fluoride (PVdF), polyethylene oxide (PEO), an ethylene propylene diene monomer (EPDM) rubber, carboxymethyl cellulose (CMC), styrene-butadiene rubber (SBR), styrene-butadiene rubber carboxymethyl cellulose (SBR-CMC), polyacrylic acid (PAA), cross-linked polyacrylic acid-polyethylenimine, polyimide, or any other suitable binder. Other suitable binders may include polyvinyl alcohol (PVA), sodium alginate, or other water-soluble binders. In some embodiments, the binder may include one or more polymers.

At step 22, the method 20 includes dispensing the electrode material onto a current collector material. In some embodiments, the current collector material is same or substantially similar to the current collector materials described with respect to FIG. 1. In some embodiments, the current collector material can be an anode current collector material. In some embodiments, the current collector material can be a cathode current collector material.

In some embodiments, the dispensing can be via a dispensation mechanism. In some embodiments, the dispensing can be from a cartridge. In some embodiments, the dispensing can be through a nozzle. In some embodiments, the dispensing can be through formers that form the semi-solid material into a desired shape and control the edges of the semi-solid material.

The method 20 optionally includes step 23, in which at least a portion of the first electrolyte solvent is removed from the electrode material prior to adding the electrolyte salt. In some embodiments, the removal of at least a portion of the first electrolyte solvent can include partially or completely evaporating the first electrolyte solvent from the electrode material. In other words, the electrode material can undergo a densification process. In some embodiments, removal of the first electrolyte solvent can be via an absorbent material. In some embodiments, removal of the first electrolyte solvent can be via a heat treatment. In some embodiments, an electrolyte can be mixed directly with the slurry without adding electrolyte separately.

At step 24, the method 20 includes adding an electrolyte salt into the electrode material via inkjet printing to form an electrode. Inkjet printing the electrolyte solvent including an electrolyte salt(s) on the electrode (e.g., an anode and/or cathode) prior to forming the electrochemical cell stack can ensure proper distribution of the electrolyte through a large electrode surface area.

Conventional electrodes and conventional electrochemical cells are typically prepared by coating a discrete portion of metal foil substrate with a thin (e.g., about 10 m to about 200 m, inclusive) wet slurry that is subsequently dried and calendered to a desired thickness. The electrodes are then cut, packaged with other components, infiltrated with electrolyte and the entire package is then sealed. One of the challenges in this conventional method is the application of the electrolyte. Since it is introduced late in the manufacturing process, evenly distributing it across a large format area can be difficult. Ink jet printing can limit or completely eliminate overspray and enables substantially homogenous distribution of electrolyte through the large electrode surface.

In some embodiments, the electrode can include an anode. In some embodiments, the electrode can include a cathode.

In some embodiments, the electrolyte salt includes a lithium salt. In some embodiments, the electrolyte salt may include LiClO₄, LiAlCl₄, LiI, LiBr, LiSCN, LiBF₄, LiB(C₆H₅)₄, LiAsF₆, LiCF₃SO₃, LiN(FSO₂)₂ (LIFSI), LiN(CF₃SO₂)₂ (LITFSI), LiPF₆, LiB(C₂O₄)₂ (LiBOB), LiBF₂(C₂O₄) (LiODFB), LiPF₃(C₂F₅)₃ (LiFAP), LiPF₄(CF₃)₂, LiPF₄(C₂O₄) (LiFOP), LiNO₃, LiPF₃(CF₃)₃, LiSO₃CF₃, and mixtures thereof. In some embodiments, the electrolyte salt is dissolved in a second electrolyte solvent. In some embodiments, the second electrolyte solvent have a composition substantially similar to a composition of the first electrolyte solvent described above with respect to FIG. 1. In some embodiments, the second electrolyte solvent can have a composition different than the composition of the first electrolyte solvent.

At step 25, the method 20 optionally includes drying the electrode material on the electrode. In some embodiments, the drying at step 25 may lead to evaporation of at least portion of the first electrolyte solvent and/or second the electrolyte solvent. In some embodiments, drying the electrode may include a heat treatment for a pre-determined amount of time. In some embodiments, the drying can be in an oven. In some embodiments, the drying can include conveying they electrode material through a furnace.

At step 26, the method 10 includes stacking a plurality of electrodes on top of each other to form an electrochemical cell stack. In some embodiments, step 26 also includes separating adjacent current collectors from each other with a separator material while tacking a plurality of electrodes on top of each other. In some embodiments, each of the electrochemical cells within the cell stack can include an anode material disposed on an anode current collector, a cathode material disposed on a cathode current collector, and a separator disposed between the anode material and the cathode material.

In some embodiments, the separator may be a porous material (e.g., micro porous material). In some embodiments, the separator may include polyethylene or polypropylene-type separator or plasticized polymer.

In some embodiments, the electrochemical cell stack can include multiple electrochemical cells arranged in a stack. In some embodiments, the electrochemical cell stack can include at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 150, at least about 200, at least about 250, at least about 300, at least about 350, at least about 400, at least about 450 electrochemical cells. In some embodiments, the electrochemical cell stack can include no more than about 500, no more than about 450, no more than about 400, no more than about 350, no more than about 300, no more than about 250, no more than about 200, no more than about 150, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 electrochemical cells. Combinations of the above-referenced numbers of electrochemical cells are also possible (e.g., at least about 1 electrochemical cell and no more than about 500 electrochemical cells or at least about 5 electrochemical cells and no more than about 50 electrochemical cells), inclusive of all values and ranges therebetween. In some embodiments, the electrochemical cell stack can include about 1, about 2, about 3, about 4, about 5, about 6, about 7, about 8, about 9, about 10, about 20, about 30, about 40, about 50, about 60, about 70, about 80, about 90, about 100, about 150, about 200, about 250, about 300, about 350, about 400, about 450, or about 500 electrochemical cells. In some embodiments, the electrochemical cell stack can be sectioned into subgroups of electrochemical cells with thermal spacers between each subgroup. In some embodiments, each subgroup shares the same set of restraining hardware.

The electrochemical cell stack has a length L, a width W, and a thickness T. The thickness T of the electrochemical cell stack is the vertical dimension along which the electrochemical cells are stacked. The length L is the longer of the two dimensions describing the breadth of the electrochemical cells in the electrochemical cell stack and the width W is the shorter of the two dimensions describing the breadth of the electrochemical cells in the electrochemical cell stack.

In some embodiments, the length L of the electrochemical cell stack can be at least about 5 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 1.5 m, at least about 2 m, at least about 2.5 m, at least about 3 m, at least about 3.5 m, at least about 4 m, or at least about 4.5 m. In some embodiments, the length L of the electrochemical cell stack can be no more than about 5 m, no more than about 4.5 m, no more than about 4 m, no more than about 3.5 m, no more than about 3 m, no more than about 2.5 m, no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, or no more than about 1 cm. Combinations of the above-referenced lengths are also possible (e.g., at least about 5 mm and no more than about 5 m or at least about 5 cm and no more than about 40 cm), inclusive of all values and ranges therebetween. In some embodiments, the length L of the electrochemical cell stack can be about 5 mm, about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 1.5 m, about 2 m, about 2.5 m, about 3 m, about 3.5 m, about 4 m, about 4.5 m, or about 5 m.

In some embodiments, the width W can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, or at least about 1.5 m. In some embodiments, the width W can be no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced widths are also possible (e.g., at least about 1 mm and no more than about 2 m or at least about 5 cm and no more than about 30 cm), inclusive of all values and ranges therebetween. In some embodiments, the width W can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 1.5 m, or about 2 m.

In some embodiments, the thickness T can be at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, at least about 15 cm, at least about 16 cm, at least about 17 cm, at least about 18 cm, or at least about 19 cm. In some embodiments, the thickness T can be no more than about 20 cm, no more than about 19 cm, no more than about 18 cm, no more than about 17 cm, no more than about 16 cm, no more than about 15 cm, no more than about 14 cm, no more than about 13 cm, no more than about 12 cm, no more than about 11 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, or no more than about 300 μm. Combinations of the above-referenced thicknesses are also possible (e.g., at least about 200 μm and no more than about 20 cm or at least about 1 mm and no more than about 2 cm), inclusive of all values and ranges therebetween. In some embodiments, the thickness T can be about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, or about 20 cm.

Large aspect ratios (i.e., ratios of length L to thickness T or width W to thickness T) can aid in heat dissipation from the electrochemical cell stack. In some embodiments, the ratio of the length L to the thickness T of the electrochemical cell stack can be at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, or at least about 1,000. In some embodiments, the ratio of the width W to the thickness T of the electrochemical cell stack can be at least about 1.5, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, or at least about 800.

The method 20, at step 27, may optionally include inserting the electrochemical cell stack into a pouch at least partially encasing the electrochemical cell stack. In some embodiments, the pouch material can contact the anode current collector, the cathode current collector, and/or the separator. The pouch material can be large enough that a portion of the pouch material extends beyond an outer bound of the separator.

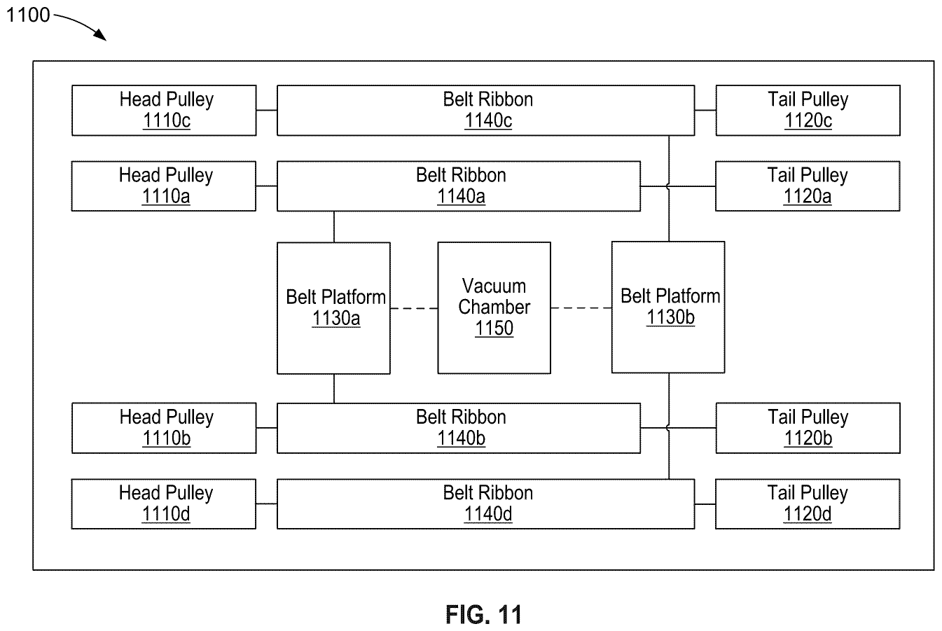

FIG. 11 is a block diagram of a system 1100 for conveying an electrochemical cell strip (i.e., a linear arrangement of multiple electrochemical cells disposed in a strip of pouch material), according to an embodiment. In some embodiments, the electrochemical cell strip may include an array of single electrochemical cells (i.e., unit cells). In some embodiments, the electrochemical cell strip may include a plurality of electrochemical cell stacks substantially similar to the electrochemical cell stack as described with respect to FIG. 10. It should be appreciated that the system 1100 can be used not only to transfer an electrochemical cell strip but also any suitable objects (e.g., items having at least one flat surface).

The system 1100 incorporates a conveyor mechanism that enables the simultaneous conveyance of at least two electrochemical cells or electrochemical cell strips at different speeds. That is, the speed may vary at different locations along a conveyor. This can be achieved by equipping the system 1100 with a minimum of two vacuum belt sections having different speeds, each driven by its own servo control.

The system 1100 includes a first head pulley 1110a and a second head pulley 1110b opposite to the first head pulley 1110a, the first head pulley 1110a and the second head pulley 1110b being driven synchronously. In some embodiments, the first head pulley 1110a and the second head pulley 1110b can be operatively coupled to the same shaft. The system 1100 also includes a first tail pulley 1120a and a second tail pulley 1120b opposite the first tail pulley 1120a, the first tail pulley 1120a and the second tail pulley 1120b configured to be driven synchronously. In some embodiments, the first tail pulley 1120a and the second tail pulley 1120b can be operatively coupled to the same shaft. The system 1100 further includes a first belt platform 1130a. In some embodiments, the first belt platform 1130a includes a plurality of openings on its surface configured to allow the passage of air therethrough. The first conveyor belt platform 1130a is coupled to a first belt ribbon 1140a. The first belt ribbon 1140a is operably coupled to the first head pulley 1110a and the first tail pulley 1120a. A second belt ribbon 1140b is operably coupled to the second head pulley 1110a and the second tail pulley 1120a. The first belt ribbon 1140a is attached to the first belt platform 1130a along a first outside edge of the first belt platform 1130a and the second belt ribbon 1140b is attached to the first belt platform 1130a along a second outside edge of the first belt platform 1130a. In some embodiments, the second outside edge of the first belt platform 1130a can be opposite the first outside edge of the first belt platform 1130a.

The system 1100 may further include a third head pulley 1110c and a fourth head pulley 1110d opposite to the third head pulley 1110c. In some embodiments, the third head pulley 1110c and the fourth head pulley 1110d can be being driven synchronously. In some embodiments, the third head pulley 1110c and the fourth head pulley 1110d can be coupled to the same shaft. In some embodiments, the third head pulley 1110c and the fourth head pulley 1110d are configured to operate independently of the first head pulley 1110a and the second head pulley 1110b.

The system 1100 may further include a third tail pulley 1120c and a fourth tail 1120d pulley opposite to the third tail pulley 1120d, the third tail pulley 1120c and the fourth tail pulley 1120d being driven synchronously. In some embodiments, the third tail pulley 1120c and the fourth tail pulley 1120d can be coupled to the same shaft. In some embodiments, the third tail pulley 1120c and the fourth tail pulley 1120d are configured to operate independently of the first tail pulley 1120a and the second tail pulley 1120b.

The system 1100 may further include a second belt platform 1130b. In some embodiments, the second belt platform 1130b can include a plurality of openings on its surface configured to allow the passage of air therethrough. In some embodiments, the second belt platform 1130b can be coupled to a third belt ribbon 1140c. The third belt ribbon 1140c can be operably coupled to the third head pulley 1110c and the third tail pulley 1120c and a fourth belt ribbon 1140d can be operably coupled to the fourth head pulley 1110d and the fourth tail pulley 1120d. The third belt ribbon 1140c is attached to the second belt platform 1130b along a first outside edge of the second belt platform 1130b. The fourth belt ribbon 1140d is attached to the second belt platform 1130b along a second outside edge of the second belt platform 1130b.

The system 1100 further includes a vacuum chamber 1150 positioned between a head pulley (e.g., the first head pulley 1110a, the second head pulley 1110b, the third head pulley 1110c, and/or the fourth head pulley 1110d) and a tail pulley (e.g., the first tail pulley 1120a, the second tail pulley 1120b, the third tail pulley 1120c, and/or the fourth tail pulley 1120d). In some embodiments, the vacuum chamber 1150 is configured to draw air through the plurality of openings in the first belt platform 1130a and the second belt platform 1130b. In some embodiments, the vacuum chamber 1150 can create a suction on the surfaces of the first belt platform 1130a and/or the second belt platform 1130b to cause an electrochemical cell strip to cling to the outside surface of the first belt platform 1130a and/or the second belt platform 1130b.

As shown, the belt platform 1130a is operably coupled to a first set of head pulleys (1110a, 1110b) and the belt platform 1130b is operably coupled to a second set of head pulleys (1110c, 1110d). The head pulleys 1110a, 1110b can be driven independently from the head pulleys 1110c, 1110d (e.g., by different servo controls). In some embodiments, the first head pulley 1110a and the second head pulley 1110b can have the same or substantially similar rotational speeds. In some embodiments, the third head pulley 1110c and the fourth head pulley 1110d can have the same or substantially similar rotational speeds. In some embodiments, the first head pulley 1110a and the second head pulley 1110b can have the same or substantially similar rotational speeds different from the rotational speeds of the third head pulley 1110c and the fourth head pulley 1110d. In some embodiments, the first head pulley 1110a, the second head pulley 1110b, the third head pulley 1110c, and the fourth head pulley 1110d are mounted on the same shaft (not shown). In same embodiments, the shaft is powered by an electric motor. In some embodiments, the system 1100 further includes two or more gears that are mounted on the shaft and are in contact with the head pulleys 1110a, 1110b, 1110c, 1110d such that two or more gears can govern the rotational speed of each head pulleys 1110a, 1110b, 1110c, 1110d.

In some embodiments, the first head pulley 1110a and the second head pulley 1110b can be driven by a first servo motor and the third head pulley 1110c and the fourth head pulley 1110d can be driven by a second servo motor (e.g., an electric motor).

In some embodiments, the first belt platform 1130a can be positioned closer to the head pulleys 1110a, 1110b, 1110c, 1110d than the second belt platform 1130b. In some embodiments, the second belt platform 1130b is located closer to the tail pulleys 1120a, 1120b, 1120c, 1120d.

In some embodiments, the first belt platform 1130a is configured to operate independently of the second belt platform 1130b such that the first belt platform 1130a conveys at a different rate (i.e., speed) than the rate of the second belt platform 1220. In some embodiments, the system 1100 can further include one or more conveyor belt platforms operating at a different speed than the speed of at least one of the first belt platform 1130a or the second belt platform 1130b. In some embodiments, the first belt platform 1130a and/or the second belt platform 1130b may be driven at a constant speed. In some embodiments, the speed of each conveyor belt may be configured (e.g., decreased/increased and/or stopped/started) to facilitate receiving, conveying and collecting electrochemical cell strips.

In some embodiments, the first belt platform 1130a and/or the second belt platform 1130b may be configured to move at a speed of at least about 10 meters per minute, at least about 15 meters per minute, at least about 20 meters per minute, at least about 25 meters per minute, at least about 30 meters per minute, at least about 35 meters per minute, at least about 40 meters per minute, at least about 45 meters per minute, at least about 50 meters per minute, at least about 55 meters per minute, at least about 60 meters per minute, at least about 65 meters per minute, at least about 70 meters per minute, at least about 75 meters per minute, at least about 80 meters per minute, at least about 85 meters per minute, at least about 90 meters per minute, at least about 95 meters per minute, at least about 100 meters per minute, at least about 105 meters per minute, at least about 110 meters per minute, at least about 115 meters per minute, at least about 120 meters per minute, at least about 125 meters per minute, at least about 130 meters per minute, at least about 135 meters per minute, at least about 140 meters per minute, or at least about 145 meters per minute. In some embodiments, the first belt platform 1130a and/or the second belt platform 1130b may be configured to move at a speed of no more than about 150 meters per minute, no more than about 145 meters per minute, no more than about 140 meters per minute, no more than about 135 meters per minute, no more than about 130 meters per minute, no more than about 125 meters per minute, no more than about 120 meters per minute, no more than about 115 meters per minute, no more than about 110 meters per minute, no more than about 105 meters per minute, no more than about 100 meters per minute, no more than about 95 meters per minute, no more than about 90 meters per minute, no more than about 85 meters per minute, no more than about 80 meters per minute, no more than about 75 meters per minute, no more than about 70 meters per minute, no more than about 65 meters per minute, no more than about 60 meters per minute, no more than about 55 meters per minute, or no more than about 50 meters per minute. Combinations of the above-referenced speeds are also possible (e.g., at least about 10 meters per minute and no more than about 120 meters per minute or at least about 75 meters per minute and no more than about 110 meters per minute), inclusive of all values and ranges therebetween. In some embodiments, the first belt platform 1130a and/or the second belt platform 1130b may be configured to move at a speed of about 10 meters per minute, about 15 meters per minute, about 20 meters per minute, about 25 meters per minute, about 30 meters per minute, about 35 meters per minute, about 40 meters per minute, about 45 meters per minute, about 50 meters per minute, about 55 meters per minute, about 60 meters per minute, about 65 meters per minute, about 70 meters per minute, about 75 meters per minute, about 80 meters per minute, about 85 meters per minute, about 90 meters per minute, about 95 meters per minute, about 100 meters per minute, about 105 meters per minute, about 110 meters per minute, about 115 meters per minute, about 120 meters per minute, about 125 meters per minute, about 130 meters per minute, about 135 meters per minute, about 140 meters per minute, about 145 meters per minute, or about 150 meters per minute.

In some embodiments, the conveyor belt platforms 1130a, 1130b can be made of rubber, elastomers, polymers, and combinations thereof. In some embodiments, the plurality of openings on the conveyor belt platforms 1130a, 1130b include one or more slit(s) along a travel direction of conveyor belt platforms 1130a, 1130b. In some embodiments, the plurality of openings on the conveyor belt platforms 1130a, 1130b include one or more slit(s) perpendicular to a direction of travel of conveyor belt platforms 1130a, 1130b. In some embodiments, the slits include two or more rows of slits positioned approximately equidistant from each other. The openings can be in the form of any suitable shape including, but not limited to, holes, slits, ovals, and/or elongated shapes.

In some embodiments, the vacuum chamber 1150 employs vacuum to hold conveyed articles (e.g., an electrochemical cell strip) in position on the conveyor belt platforms 1130a, 1130b. The vacuum chamber 1150 may include one or more vacuum sources to draw air through the openings on the belt platforms 1130a, 1130b. In some embodiments, one vacuum source may provide sufficient vacuum force for all of the belt platforms 1130a, 1130b. The vacuum chamber 1150 creates a low pressure zone with respect to atmospheric pressure such that it applies a vacuum along a predefined length of the conveyor surface, thereby creating a suction through the openings on the belt platforms 1130a, 1130b which holds electrochemical cells strips against a surface of the belt platforms 1130a, 1130b.

In order for a given type of article (e.g., an electrochemical cell strip) to be satisfactorily held onto the belt platforms 1130a, 1130b and transported, a predetermined vacuum can be applied in order to hold a given article onto the belt platforms 1130a, 1130b. The total amount of vacuum force that is desired to be exerted on a given article depends not only upon its weight and shape but also spacing between the openings and size of the opening as it is transported by a conveyor. In some embodiments, a vacuum force can be applied to the first belt platform 1130a during a first time period and the second belt platform 1130b during a second time period.

The system 1100 may further include a first servo motor (not shown) operably coupled to the first head pulley 1110a, the second head pulley 1110b, the first tail pulley 1120a and the second head pulley 1110d. The system 1100 may further include a second servo motor (not shown) operably coupled to the third head pulley 1110c, the fourth head pulley 1110d, the third tail pulley 1120c, and the fourth tail pulley 1120d.

In some embodiments, the first head pulley 1110a and the second head pulley 1110b can be driven synchronously (i.e., at a substantially same rate). In some embodiments, the third head pulley 1110c and the fourth head pulley 1110d can be driven synchronously (i.e., at a substantially same rate).

In some embodiments, the tail pulleys 1120a, 1120b, 1120c, 1120d may not be powered. That is, in some embodiments, the tail pulleys 1120a, 1120b, 1120c, 1120d are not operably coupled to a servo motor. In some embodiments, the tail pulleys 1120a, 1120b, 1120c, 1120d may be mounted on a shaft that is fixed to a framework of the system 1100, ensuring the tail pulleys 1120a, 1120b, 1120c, 1120d rotate freely and smoothly. In such embodiments, the tail pulleys 1120a, 1120b, 1120c, 1120d may be driven by the head pulleys 1110a, 1110b, 1110c, 1110d. In other words, the tension and movement of the belt ribbons 1140a, 1140b, 1140c, 1140d driven by the head pulleys 1120a, 1120b, 1120c, 1120d can create a natural rotation of the tail pulleys as the belt ribbon returns.

In some embodiments, the first belt ribbon 1140a is operably coupled to the first head pulley 1110a and the first tail pulley 1120a to form a continuous loop. In some embodiments, the second belt ribbon 1140b is operably coupled to the second head pulley 1110b and the second tail pulley 1120b to form a continuous loop. In some embodiments, the first belt ribbon 1140a is attached to the first belt platform 1130a along a first outside edge of the first belt platform 1130a and the second belt ribbon 1140b is attached to the first belt platform form 1130a along a second outside edge of the first belt platform 1130a. In some embodiments, the first belt ribbon 1140a and the second belt ribbon 1140b may be driven synchronously by the first head pulley 1110a and the second head pulley 1110b, respectively such that the first belt ribbon 1140a and the second belt ribbon 1140b move at the same speed. In such embodiments, the first belt platform 1130a moves synchronously with the first belt ribbon 1140a and the second belt ribbon 1140b such that the first belt platform 1130a moves with a speed the same or substantially similar to the speed of the first belt ribbon 1140a and the second belt ribbon 1140b.

In some embodiments, the third belt ribbon 1140c is operably coupled to the third head pulley 1110c and the third tail pulley 1120c to form a continuous loop. In some embodiments, the fourth belt ribbon 1140d is operably coupled to the fourth head pulley 1110d and the fourth tail pulley 1120d to form a continuous loop. In some embodiments, the third belt ribbon 1140c is attached to the second belt platform 1130b along a first outside edge of the second belt platform 1130b and the fourth belt ribbon 1130d is attached to the second belt platform 1130b along a second outside edge of the second belt platform 1130b. In some embodiments, the third belt ribbon 1140c and the fourth belt ribbon 1140d may be driven synchronously by the third head pulley 1110c and the fourth head pulley 1110d, respectively such that the third belt ribbon 1140c and the fourth belt ribbon 1140d move at a same speed. In such embodiments, the second belt platform 1130b moves synchronously with the third belt ribbon 1140c and the fourth belt ribbon 1140d such that the second belt platform 1130b has a speed the same or substantially similar to the speed of the third belt ribbon 1140c and the fourth belt ribbon 1140d.

In some embodiments, the servo motor may include an electric motor, a hydraulic motor, or a pneumatic cylinder.

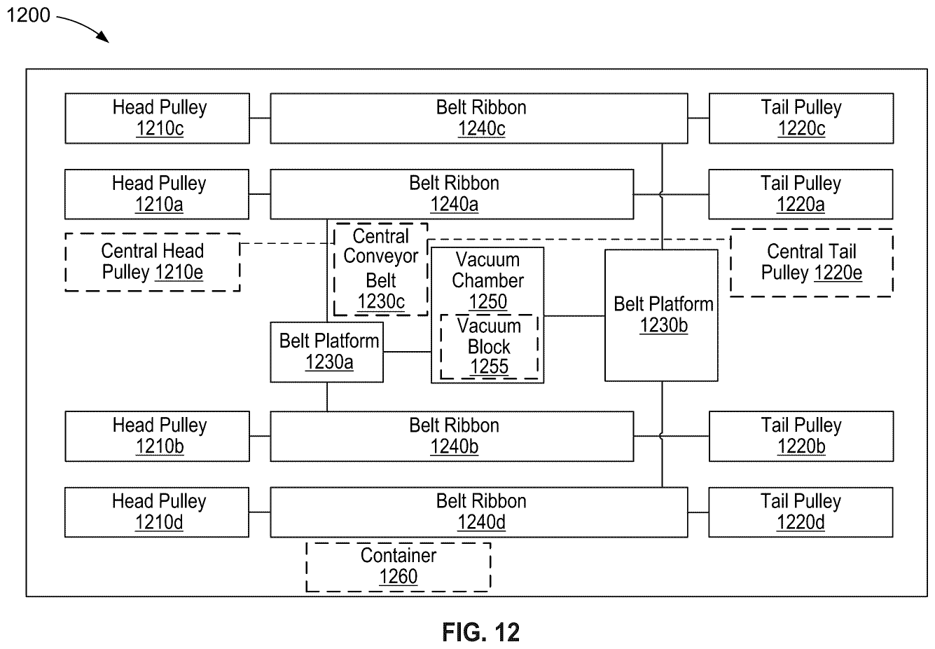

FIG. 12 is a block diagram of a system 1200 for conveying an electrochemical cell strip, according to an embodiment. As shown, the system 1200 includes a first head pulley 1210a, a second head pulley 1210b, a third head pulley 1210c, a fourth head pulley 1210d, a central head pulley 1210e, a first tail pulley 1220a, a second tail pulley 1220b, a third tail pulley 1220c, a fourth tail pulley 1220d, a central tail pulley 1220e, a first belt platform 1230a, a second belt platform 1230b, a first belt ribbon 1240a, a second belt ribbon 1240b, a third belt ribbon 1240c, a fourth belt ribbon 1240d, a vacuum chamber 1250, a vacuum block 1255, and a container 1260. In some embodiments, the first head pulley 1210a, the second head pulley 1210b, the third head pulley 1210c, the fourth head pulley 1210d, the first tail pulley 1220a, the second tail pulley 1220b, the third tail pulley 1220c, the fourth tail pulley 1220d, the first belt platform 1230a, the second belt platform 1230b, the first belt ribbon 1240a, the second belt ribbon 1240b, the third belt ribbon 1240c, the fourth belt ribbon 1240d, and the vacuum chamber 1250 can be the same or substantially similar to the first head pulley 1110a, the second head pulley 1110b, the third head pulley 1110c, the fourth head pulley 1110d, the first tail pulley 1120a, the second tail pulley 1120b, the third tail pulley 1120c, the fourth tail pulley 1120d, the first belt platform 1130a, the second belt platform 1130b, the first belt ribbon 1140a, the second belt ribbon 1140b, the third belt ribbon 1140c, the fourth belt ribbon 1140d, and the vacuum chamber 1150, as described above with reference to FIG. 11. Thus, certain aspects of the first head pulley 1210a, the second head pulley 1210b, the third head pulley 1210c, the fourth head pulley 1210d, the first tail pulley 1220a, the second tail pulley 1220b, the third tail pulley 1220c, the fourth tail pulley 1220d, the first belt platform 1230a, the second belt platform 1230b, the first belt ribbon 1240a, the second belt ribbon 1240b, the third belt ribbon 1240c, the fourth belt ribbon 1240d, and the vacuum chamber 1250 are not described in greater detail herein.

The central conveyor belt 1230c is operably coupled to the central head pulley 1210e and the central tail pulley 1220e. In some embodiments, the central conveyor belt 1230c includes a plurality of openings to allow for the passage of air therethrough. In some embodiments, the first belt platform 1230a is configured to be disposed on the central conveyor belt 1230c such that at least a portion of the plurality of openings of the first belt platform 1230a are in fluidic communication with at least a portion of the plurality of openings of the central conveyor belt 1230c. In some embodiments, the first belt platform 1230a, the second belt platform 1230b, and any other additional belt platforms included in the system 1200 may be disposed onto the central conveyor belt 1230c.

In some embodiments, the central conveyor belt 1230c can receive the electrochemical cell strips from a position horizontally in-line with the tail pulleys 1220a, 1220b, 1220c, 1220d, 1220e. In some embodiments, the central conveyor belt 1230c may be configured to have the same or a substantially similar speed with to an incoming electrochemical cell strips (e.g., electrochemical cell strips coming from another conveyance system).

In some embodiments, the central conveyor belt 1230c may be configured to move at a speed of at least about 10 meters per minute, at least about 15 meters per minute, at least about 20 meters per minute, at least about 25 meters per minute, at least about 30 meters per minute, at least about 35 meters per minute, at least about 40 meters per minute, at least about 45 meters per minute, at least about 50 meters per minute, at least about 55 meters per minute, at least about 60 meters per minute, at least about 65 meters per minute, at least about 70 meters per minute, at least about 75 meters per minute, at least about 80 meters per minute, at least about 85 meters per minute, at least about 90 meters per minute, at least about 95 meters per minute, at least about 100 meters per minute, at least about 105 meters per minute, at least about 110 meters per minute, at least about 115 meters per minute, at least about 120 meters per minute, at least about 125 meters per minute, at least about 130 meters per minute, at least about 135 meters per minute, at least about 140 meters per minute, or at least about 145 meters per minute. In some embodiments, the central conveyor belt 1230c may be configured to move at a speed of no more than about 150 meters per minute, no more than about 145 meters per minute, no more than about 140 meters per minute, no more than about 135 meters per minute, no more than about 130 meters per minute, no more than about 125 meters per minute, no more than about 120 meters per minute, no more than about 115 meters per minute, no more than about 110 meters per minute, no more than about 105 meters per minute, no more than about 100 meters per minute, no more than about 95 meters per minute, no more than about 90 meters per minute, no more than about 85 meters per minute, no more than about 80 meters per minute, no more than about 75 meters per minute, no more than about 70 meters per minute, no more than about 65 meters per minute, no more than about 60 meters per minute, no more than about 55 meters per minute, or no more than about 50 meters per minute. Combinations of the above-referenced speeds are also possible (e.g., at least about 10 meters per minute and no more than about 120 meters per minute or at least about 75 meters per minute and no more than about 110 meters per minute), inclusive of all values and ranges therebetween. In some embodiments, the central conveyor belt 1230c may be configured to move at a speed of about 10 meters per minute, about 15 meters per minute, about 20 meters per minute, about 25 meters per minute, about 30 meters per minute, about 35 meters per minute, about 40 meters per minute, about 45 meters per minute, about 50 meters per minute, about 55 meters per minute, about 60 meters per minute, about 65 meters per minute, about 70 meters per minute, about 75 meters per minute, about 80 meters per minute, about 85 meters per minute, about 90 meters per minute, about 95 meters per minute, about 100 meters per minute, about 105 meters per minute, about 110 meters per minute, about 115 meters per minute, about 120 meters per minute, about 125 meters per minute, about 130 meters per minute, about 135 meters per minute, about 140 meters per minute, about 145 meters per minute, or about 150 meters per minute.

As shown, the container 1260 receives electrochemical cell strips released from the belt platforms 1230a, 1230b. In some embodiments, the system 1200 may include two or more containers configured to receive conveyed articles (e.g., electrochemical cell strips) from a conveyor belt (e.g., from the first belt platform 1230a and/or the second belt platform 1230b).

In some embodiments, the first belt platform 1230a has an upper position (i.e., near the top of the system 1200) and a lower position (i.e., near the bottom of the system 1200). In some embodiments, the upper position of the first belt platform 1230a can be vertically in-line with a top surface of the any of the head pulleys 1210a, 1210b, 1210c, 1210d and any of the tail pulleys 1220a, 1220b, 1220c, 1220d. In some embodiments, the lower position of the first belt platform 1230a can be vertically in-line with a bottom surface of any of the head pulleys 1210a, 1210b, 1210c, 1210d and any of the tail pulleys 1220a, 1220b, 1220c, 1220d. In some embodiments, the container 1260 is configured to receive items (e.g., electrochemical cell strips) from the first belt platform 1210a. In some embodiments, the container 1260 is positioned beneath the lower position of the first belt platform 1210a.

In some embodiments, the central conveyor belt 1230c has an upper position and a lower position. In some embodiments, the upper position of the central conveyor belt 1230c can be vertically in-line with a top surface of any of the head pulleys 1210a, 1210b, 1210c, 1210d and any of the tail pulleys 1220a, 1220b, 1220c, 1220d. In some embodiments, the lower position of the central conveyor belt 1230c can be vertically in-line with a bottom surface of the any of the head pulleys 1210a, 1210b, 1210c, 1210d and any of the tail pulleys tail pulleys 1220a, 1220b, 1220c, 1220d. In some embodiments, the container 1260 is configured to receive items (e.g., electrochemical cell strips) from the central conveyor belt 1230c. In some embodiments, the container 1260 is positioned beneath the lower position of the central conveyor belt 1230c. In some embodiments, two or more containers can be positioned beneath the lower position of the central conveyor belt 1230c. In some embodiments, two or more containers can be aligned in a row along a direction of travel of the central conveyor belt 1230c.

In some embodiments, the container 1260 may include at least about 30 electrochemical cells, at least about 50 electrochemical cells, at least about 100 electrochemical cells, at least about 150 electrochemical cells, at least about 200 electrochemical cells, at least about 250 electrochemical cells, at least about 300 electrochemical cells, at least about 350 electrochemical cells, at least about 400 electrochemical cells, at least about 450 electrochemical cells, or at least about 500 electrochemical cells. In some embodiments, the container 1260 may include no more than about 1000 electrochemical cells, no more than about 800 electrochemical cells, no more than about 700 electrochemical cells, no more than about 600 electrochemical cells, no more than about 500 electrochemical cells, no more than about 400 electrochemical cells, no more than about 300 electrochemical cells, no more than about 200 electrochemical cells, or no more than about 100 electrochemical cells. Combinations of the above-referenced electrochemical cell numbers are also possible (e.g., at least about 50 and no more than about 500 or at least about 250 and no more than about 400), inclusive of all values and ranges therebetween. In some embodiments, the container 1260 may include at least about 30 electrochemical cells, about 50 electrochemical cells, about 100 electrochemical cells, about 150 electrochemical cells, about 200 electrochemical cells, about 250 electrochemical cells, about 300 electrochemical cells, about 350 electrochemical cells, about 400 electrochemical cells, about 450 electrochemical cells, about 500 electrochemical cells, about 800 electrochemical cells, or about 1,000 electrochemical cells.

In some embodiments, the system 1260 further includes a vacuum block 1255 disposed in the vacuum chamber 1250. In some embodiments, the vacuum chamber 1250 is formed within a space between an upper surface of the central conveyor belt 1230c and a lower surface of the central conveyor belt 1230c. In some embodiments, the vacuum block 1255 may have a blade-like shape such that the vacuum block 1255 can fit into the openings (e.g., slits) on the surface of the conveyor system (e.g., openings on the first belt platform 1230a and/or the central conveyor belt 1230c). In some embodiments, the system 1200 may include two or more vacuum blocks 1255. In some embodiments, the two or more vacuum blocks 1255 can be positioned in line with the openings (such as slits) on a surface of the central conveyor belt 1230c, obstructing the openings and preventing air from passing through them.

In some embodiments, the vacuum block 1255 is adjustable between a first configuration in which the vacuum block 1255 does not interfere with the passage of air through the plurality of openings of the first belt platform 1230a, the second belt platform 1230b, and/or the central conveyor belt 1230c and a second configuration in which the vacuum block 1255 does interfere with the passage of air through the plurality of openings of the first belt platform 1230a, the second belt platform 1230b, and/or the central conveyor belt 1230c. In the second configuration, the vacuum block 1255, which is formed in the space between the upper and lower surfaces of the central conveyor belt 1230c, moves towards the lower surface of the central conveyor belt 1230c. This movement causes the vacuum block 1255 to obstruct the openings (such as slits) on the surface of the first belt platform 1230a, the second belt platform 1230b, and/or the central conveyor belt 1230c. When the first belt platform 1230a and/or the second belt platform 1230b are in their lower positions, blocking the flow of air through the first belt platform 1230a and/or the second belt platform 1230b can release a vacuum force applied to electrochemical cell strips (or other objects) clinging to the first belt platform 1230a and/or the second belt platform 1230b, such that the electrochemical cell strips are released and drop into the container 1260.

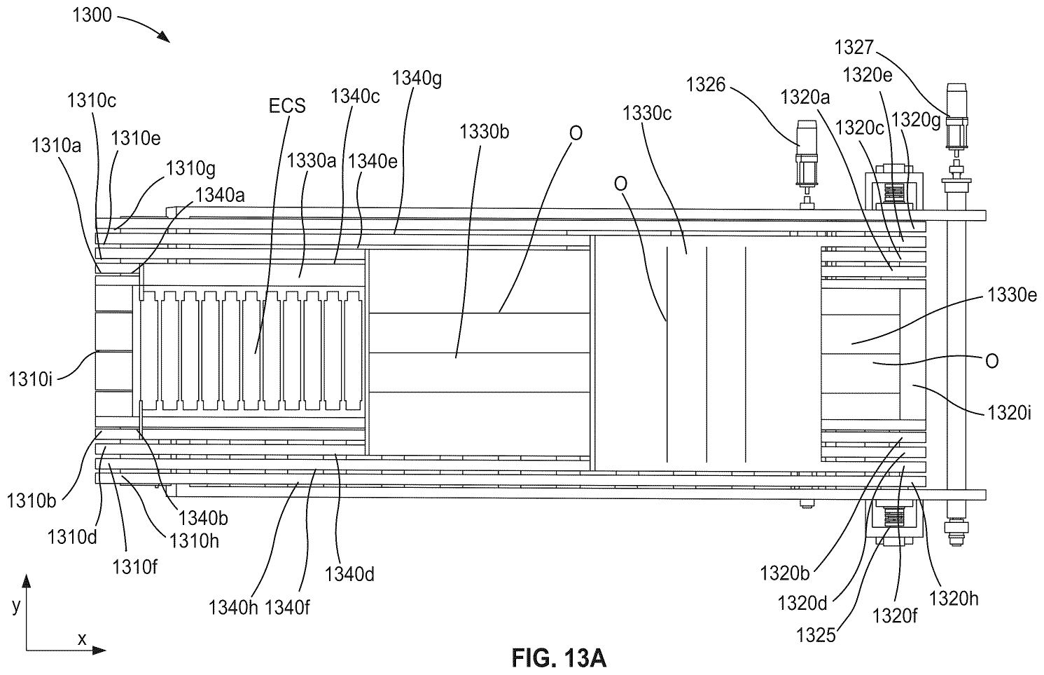

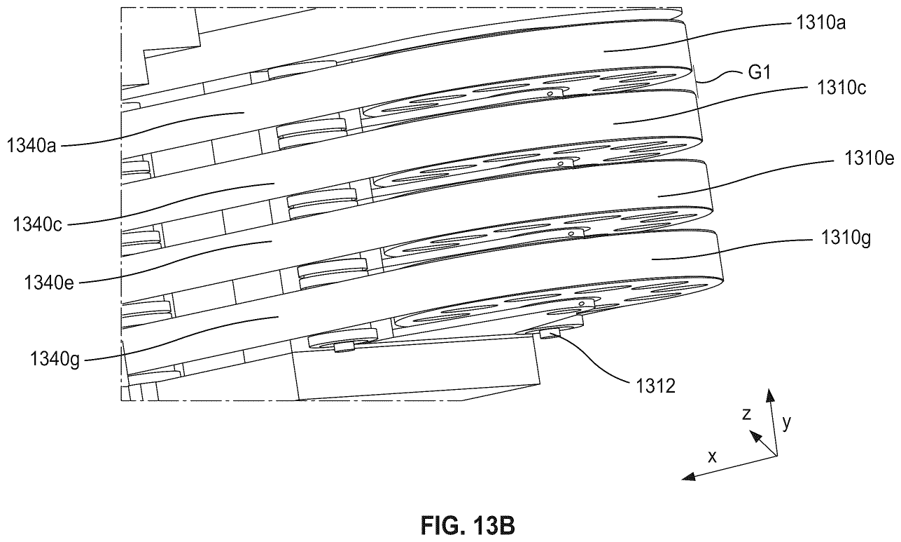

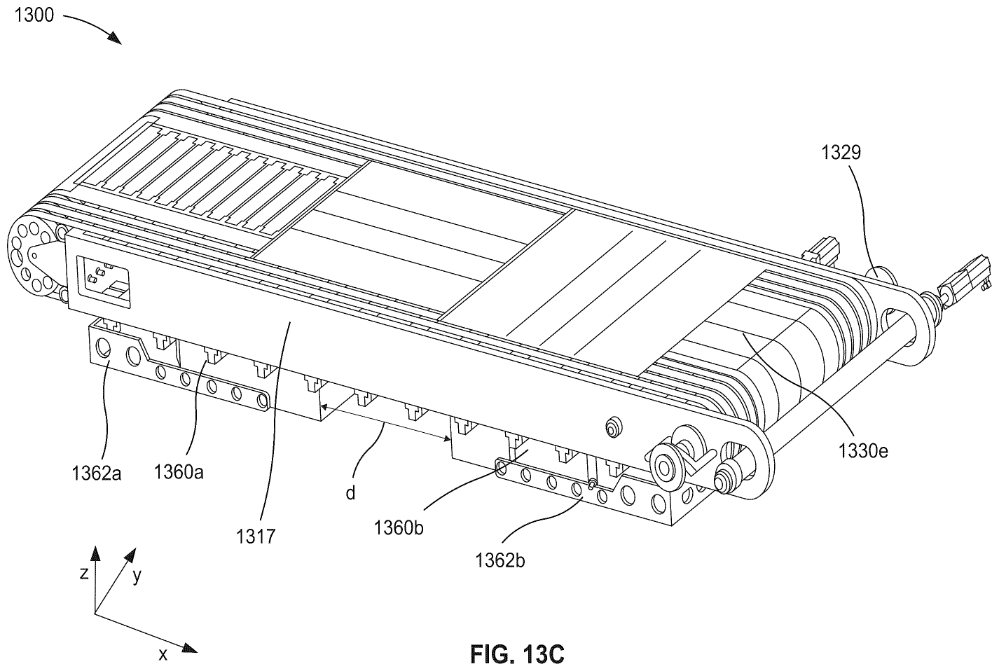

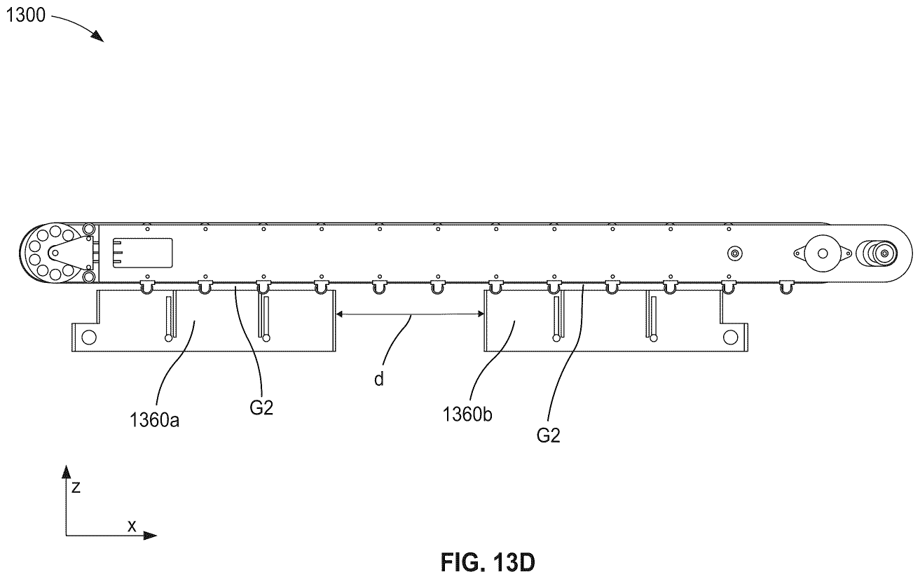

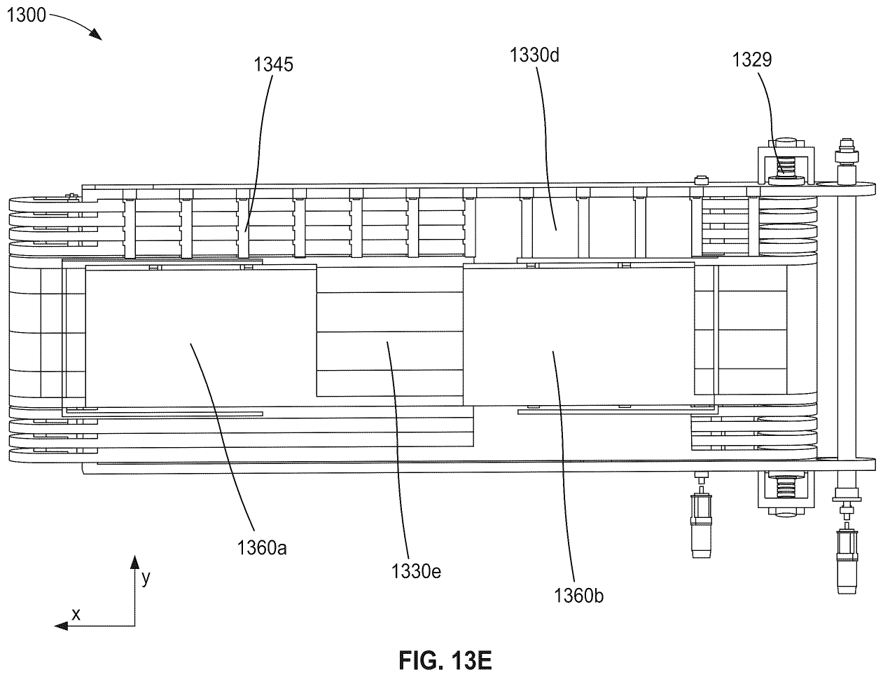

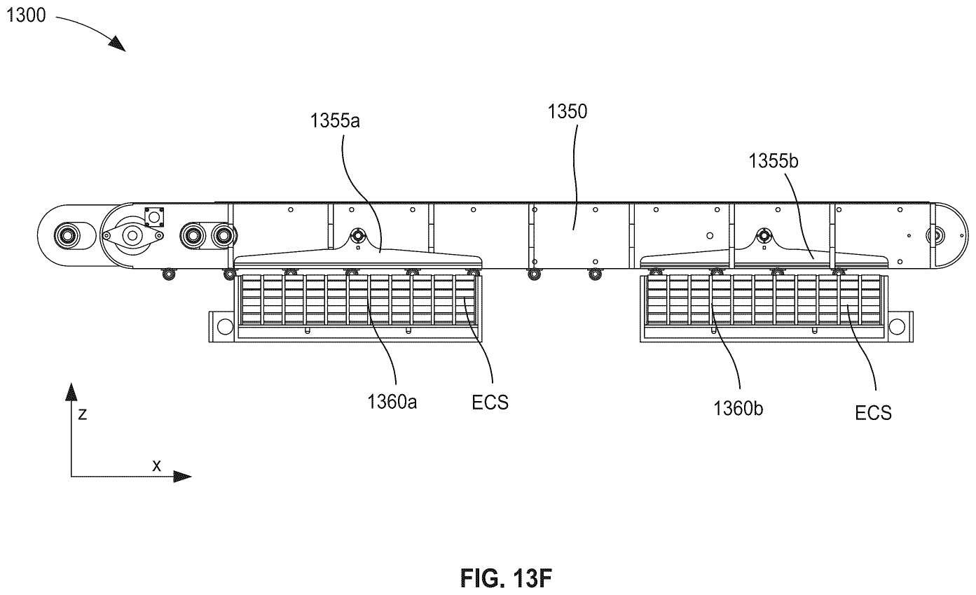

FIGS. 13A-13F are illustrations of a system 1300 for conveying an electrochemical cell strip, and various components thereof, according to an embodiment. As shown, the system 1300 includes a first head pulley 1310a, a second head pulley 1310b, a third head pulley 1310c, a fourth head pulley 1310d, a fifth head pulley 1310e, a sixth head pulley 1310f, a seventh head pulley 1310g, an eighth head pulley 1310h, a central head pulley 1310i, a first tail pulley 1320a, a second tail pulley 1320b, a third tail pulley 1320c, a fourth tail pulley 1320d, a fifth tail pulley 1320e, a sixth tail pulley 1320f, a seventh tail pulley 1320g, an eighth tail pulley 1320h, and a central tail pulley 1320i. A first belt platform 1330a is coupled to a first belt ribbon 1340a and a second belt ribbon 1340b. The first belt ribbon 1340a is operably coupled to the first head pulley 1310a and the first tail pulley 1320a. The second belt ribbon 1340b is operably coupled to the second head pulley 1310b and the second tail pulley 1320b. A second belt platform 1330b is coupled to a third belt ribbon 1340c and a fourth belt ribbon 1340d. The third belt ribbon 1340c is operably coupled to the third head pulley 1310c and the third tail pulley 1320b. The fourth belt ribbon 1340d is operably coupled to the fourth head pulley 1310d and the fourth tail pulley 1320d. A third belt platform 1330c is coupled to a fifth belt ribbon 1340e and a sixth belt ribbon 1340f. The fifth belt ribbon 1340e is operably coupled to the fifth head pulley 1310e and the fifth tail pulley 1320e. The sixth belt ribbon 1340f is operably coupled to the sixth head pulley 1310f and the sixth tail pulley 1320f. A fourth belt platform 1330d is coupled to a seventh belt ribbon 1340g and an eighth belt ribbon 1340h. The seventh belt ribbon 1340g is operably coupled to the seventh head pulley 1310g and the seventh tail pulley 1310g. The eighth belt ribbon 1340h is operably coupled to the eighth head pulley 1310h and the eighth tail pulley 1320h. The central conveyor belt 1330e is operably coupled to the central head pulley 1310i and the central tail pulley 1320i. As shown, the belt ribbons 1340a, 1340b, 1340c, 1340d, 1340e, 1340f, 1340g, 1340h are positioned with the seventh and eight belt ribbons 1340g, 1340h further from a horizontal center of the system 1300 than the fifth and sixth belt ribbons 1340e, 1340f, which are further from the horizontal center of the system 1300 than the third and fourth belt ribbons 1340c, 1340d, which are further from the horizontal center of the system 1300 than the first and second belt ribbons 1340a, 1340b.

As shown, the system 1300 includes a vacuum chamber 1350 with vacuum blocks 1355a, 1355b. The system 1300 further includes containers 1360a, 1360b. In some embodiments, the head pulleys 1310a, 1310b, 1310c, 1310d, 1310e, 1310f, 1310g, 1310h, 1310i the tail pulleys 1320a, 1320b, 1320c, 1320d, 1320e, 1320f, 1320g, 1320h, 1320i, the belt platforms 1330a, 1330b, 1330c, the belt ribbons 1340a, 1340b, 1340c, 1340d, 1340e, 1340f, 1340g, 1340h, the vacuum chamber 1350, the vacuum blocks 1355a, 1355b, and the containers 1360a, 1360b can be the same or substantially similar to the head pulleys 1210a, 1210b, 1210c, 1210d, the tail pulleys 1220a, 1220b, 1220c, 1220d, the belt platforms 1230a, 1230b, the belt ribbons 1240a, 1240b, 1240c, 1240d, the vacuum chamber 1250, the vacuum block 1255, and the container 1260, as described above with reference to FIG. 12. Thus, certain aspects of the head pulleys 1310a, 1310b, 1310c, 1310d, 1310e, 1310f, 1310g, 1310h, 1310i the tail pulleys 1320a, 1320b, 1320c, 1320d, 1320e, 1320f, 1320g, 1320h, 1320i, the belt platforms 1330a, 1330b, 1330c, the belt ribbons 1340a, 1340b, 1340c, 1340d, 1340e, 1340f, 1340g, 1340h, the vacuum chamber 1350, the vacuum blocks 1355a, 1355b, and the containers 1360a, 1360b are not described in greater detail herein. As shown, FIG. 13A shows an overhead view of the system 1300, FIG. 13B shows a bottom view of a corner of the system 1300, FIG. 13C shows a perspective view of the system 1300, FIG. 13D shows a side view of the system 1300, FIG. 13E shows a bottom view of the system 1300, and FIG. 13F shows a side cross-sectional view of the system 1300 with electrochemical cell strips ECS visible.

In some embodiments, the first head pulley 1310a and the second head pulley 1310b can be driven by a same servo motor. In some embodiments, the first head pulley 1310a and the second head. In some embodiments, the first tail pulley 1320a and the second tail pulley 1320b can be driven by a same servo motor. In some embodiments, the first tail pulley 1320a and the second tail pulley 1320b can be driven independently by a different servo motor that are synchronized.

As shown, the first belt platform 1330a, the second belt platform 1330b, the third belt platform 1330c, the fourth belt platform 1330d, and the central conveyor belt 1330e each include pluralities of openings O configured to allow the passage of air therethrough.

In some embodiments, the third head pulley 1310c and the fourth head pulley 1310d can be being driven synchronously. In some embodiments, the third head pulley 1310c and the fourth head pulley 1310d are configured to operate independently of the first head pulley 1310a and the second head pulley 1310b. In some embodiments, the third head pulley 1310c and the fourth head pulley 1310d can be driven by a same servo motor. In some embodiments, the third head pulley 1310c and the fourth head pulley 1310d can be driven independently by different servo control motors that are synchronized. In some embodiments, the third tail pulley 1320c and the fourth tail pulley 1320d are driven synchronously. The third tail pulley 1320c and the fourth tail pulley 1320d are configured to operate independently of the first tail pulley 1320a and the second tail pulley 1320b.

In some embodiments, the first belt platform 1330a is configured to be disposed on the central conveyor belt 1330e such that at least a portion of the plurality of openings of the first belt platform 1330a are in fluidic communication with at least a portion of the plurality of openings O of the central conveyor belt 1330e. In some embodiments, the first belt platform 1330a, the second belt platform 1330b or the any other additional belt platform that the system 1300 may include can be disposed onto the central conveyor belt 1330e.

The vacuum chamber 1350 is configured to draw air through the plurality of openings O in the first belt platform 1330a, the second belt platform 1330b, the third belt platform 1330c, and the fourth belt platform 1330d. In some embodiments, the vacuum chamber 1350 is formed within a space between the upper surface of the central conveyor belt 1330e and the lower surface of the central conveyor belt 1330e.

In some embodiments, the fifth head pulley 1310e and the sixth head pulley 1310f may be driven by a same servo control motor. In some embodiments, the fifth head pulley 1310e and the sixth head pulley 1310f can be driven independently by a different servo control motor that are synchronized.

In some embodiments, any of the belt platforms 1330a, 1330b, 1330c, 1330d, 1330e, can move at different speeds from one another. The system 1300 may further include a first servo motor 1327. In some embodiments, the first servo motor 1327 can operate at least two head pulleys (e.g., at least two of the eight head pulleys 1310a, 1310b, 1310c, 1310d, 1310e, 1310f, 1310g, 1310h). In some embodiments, the first servo motor 1327 may operate each of the eight head pulleys 1310a, 1310b, 1310c, 1310d, 1310e, 1310f, 1310g, 1310h. In some embodiments, the first servo motor 1327 may drive a shaft that at least two of the eight head pulleys share (e.g., are operatively coupled to). In some embodiments, the first servo motor 1327 may include a set of motors (i.e., two or more motors).

The system 1300 may further include a second servo motor 1329. In some embodiments, the second servo motor 1329 may operate the at least two tail pulleys (e.g., at least two of the eight tail pulleys 1320a, 1320b, 1320c, 1320d, 1320e, 1320f, 1320g, 1320h). In some embodiments, the second servo motor 1329 may drive a shaft that at least two of the eight head pulleys share. In some embodiments, the second servo motor 3100 may include a collection of motors (i.e., two or more motors).

The system 1300 may further include a servo motor 1326 or plurality of servo motors for independent control of each of the ribbons 1340a, 1340b, 1340c, 1340d, 1340e, 1340f, 1340g, 1340h (collectively referred to as ribbons 1340) or pairs of the ribbons 1340 and their corresponding belt platform 1330a, 1330b, 1330c, 1330d. When the belt platform 1330a, 1330b, 1330c, and/or 1330d is captured by its corresponding ribbon, the servo motor 1326 can accelerate to create a gap between any of the belt platforms 1330a, 1330b, 1330c, 1330d. The gap between the belt platforms 1330a, 1330b, 1330c, 1330d provides a time period, during which a leading belt platform 1330a, 1330b, 1330c, 1330d can dwell for a time period and offload an electrochemical cell strip into either of the containers 1360a, 1360b.

FIG. 13B includes an enlarged view of a collection of the head pulleys (1310a, 1310c, 1310e, 1310g) that drives the belt ribbons (1340a, 1340c, 1340e, 1340g, respectively). Although the head pulleys (1310a, 1310c, 1310e, 1310g described herein, it should be appreciated that the description below can also be applicable to the head pulleys 1310b, 1310d, 1310f, 1310h opposite the head pulleys 1310a, 1310c, 1310e, 1310g, respectively. As shown in FIG. 13B, the head pulleys 1310a, 1310c, 1310e, 1310g are separated from each other with a gap G1. In some embodiments, the gap G1 can be at least about 1 mm, at least about 2 mm, at least about 3 mm, at least about 4 mm, at least about 5 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the gap G1 can be no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 5 mm, no more than about 4 mm, no more than about 3 mm, no more than about 2 mm, or no more than about 1 mm. Combinations of the above-referenced lengths are also possible (e.g., at least about 1 mm and no more than about 10 cm or at least about 5 mm and no more than about 5 cm), inclusive of all values and ranges therebetween. In some embodiments, the gap G1 can be about 1 mm, about 2 mm, about 3 mm, about 4 mm, about 5 mm, about 1 cm, about 2 cm, about 3 cm, about 4 cm, about 5 cm, about 6 cm, about 7 cm, about 8 cm, about 9 cm, or about 10 cm.

As shown in FIG. 13B, the belt ribbons (1340a, 1340c, 1340e, 1340g) ride on independent head pulleys (1310a, 1310c, 1310e, 1310g, respectively) separated from each other via the gap G1. In some embodiments, at least two of the head pulleys (1310a, 1310c, 1310e, 1310g) have a different rotational speed from each other. Accordingly, in such embodiments, at least two belt ribbons (1340a, 1340c, 1340e, 1340g) that ride on those head pulleys move at different speed from each other.

In some embodiments, the separate head pulleys (1310a, 1310c, 1310e, 1310g) may be coupled to the same servo control motor. In some embodiments, the servo control motor may be a variable speed drive motor and configured to drive the belt ribbons (1340a, 1340c, 1340e, 1340g) at one or more speeds. In some embodiments, the servo control motor may be a constant speed drive motor and configured to drive the belt ribbons (1340a, 1340c, 1340e, 1340g) at a constant speed. In some embodiments, the head pulleys may be configured to share one or more common elements such as, for example, a shaft 1312. The shaft 1312 may be coupled to a drive motor (e.g., a servo motor). In such embodiments, the shaft 1312 may include two or more gears (not shown) mounted thereon. This may lead to at least two of the head pulleys (1310a, 1310c, 1310e, 1310g) rotating at different speeds. In some embodiments, two or more gears (not shown) are in contact with the head pulleys. In some embodiments, two or more gears have a different size (e.g., different pitch circle diameter). These mechanisms, including different-sized gears, may allow individual pulleys on the same shaft 1312 to have different rotational speeds.

FIG. 13C shows a side profile view of the system 1300. The system 1300 includes two containers (1360a and 1360b) to collect conveyed articles (e.g., an electrochemical cell strip). The containers 1360a and 1360b are positioned beneath a lower position of the central conveyor belt 1330e. The container 1360a is further positioned beneath the lower surface of the central conveyor belt 1330e and configured the receive items (i.e., conveyed articles such as electrochemical cell strips) from any of the belt platforms 1330a, 1330b, 1330c, 1330d. The container 1360b may be further positioned beneath a lower position of the fourth belt platform 1330d that is disposed on a lower position of the central conveyor belt 1330e. In some embodiments, the container 1360a and the container 1360b may collect items conveying at different speeds. The container 1360a and the container 1360b are separated from each other via a distance d. The distance d between the containers 1360a, 1360b container may vary depending on the design such as the dimensions of the system 1300, the speed of the conveyor belt platforms etc. The containers 1360a, 1360b can be made of any suitable material that is durable and robust enough to carry multiple items. The containers 1360a, 1360b can be made from various materials, including metals, alloys, polymers, plastics, or a combination thereof.

The container 1360a includes a handlebar 1362a and the container 1360a includes a handlebar 1362b. In some embodiments, the handlebars 1362a, 1362b can function to release the containers from the system 1300 such that the containers including collected conveyed items can be emptied. In some embodiments, the handlebars 1362a, 1362b can further function as attachment points to mount the containers 1360a, 1360b onto the system 1300.

FIG. 13C also shows a side wall 1317 of the framework that holds the components of the system 1300 together.

FIG. 13D is a side cross sectional view of the system 1300. As shown, there are two opposite sides of the system 1300 including a lower surface of the central conveyor belt 1330e and an upper surface of the central conveyor belt 1330e. FIG. 13D shows lateral views of the two containers 1360a, 1360b positioned beneath the lower surface of the central conveyor belt 1330e and separated from each other via a distance d.

The containers 1360a and 1360b, have an open top side, allowing conveyed items (e.g., electrochemical cell strips ECS) to potentially fall down into them, thereby collecting the conveyed items. The system 3000 includes a gap G2 between a surface of the lower position of the central conveyor belt 3240 and the containers open ends. The gap G2 ensures that there is enough space for conveying items to move on the surface of the lower position of the central conveyor belt 3240. As shown, the electrochemical cell strips ECS include 11 electrochemical cells each. In some embodiments, the electrochemical cell strips ECS can include about 1, about 2, about 3, about 4, about 5, about 6, about 7, about 8, about 9, about 10, about 11, about 12, about 13, about 14, about 15, about 16, about 17, about 18, about 19, about 20, about 25, about 30, about 35, about 40, about 45, about 50, about 55, about 60, about 65, about 70, about 75, about 80, about 85, about 90, about 95, or about 100 electrochemical cells, inclusive of all values and ranges therebetween.

FIG. 13E is a bottom side view of the system 1300. In some embodiments, the system 1300 includes one or more support elements 1345 to support the belt ribbons 1340a, 1340b, 1340c, 1340d, 1340e, 1340f, 1340g, 1340h to prevent stretching and sagging. In some embodiments, the one or more support elements 1345 may include free-spinning rollers or pulley-like elements. In some embodiments, the one or more support elements 1345 may also aid the containers 1360a, 1360b to become mounted on the system 1300. As shown, the fourth belt platform 1340d is disposed on the lower surface of the central conveyor belt 1330e. In some embodiments, the container 1360a and/or the container 1360b may receive the conveying items from the fourth belt platform 1340d.

FIG. 13F is a cross-sectional side view of the system 1300 with the electrochemical cell strips ECS visible. The vacuum chamber 1350 is formed within a space between the upper surface of the central conveyor belt 1330e and the lower surface of the central conveyor belt 1330e. The vacuum chamber 1350 is also positioned between the head pulleys 1310a, 1310b, 1310c, 1310d, 1310e, 1310f, 1310g, 1310h and the tail pulleys 1320a, 1320b, 1320c, 1320d, 1320e, 1320f, 1320g, 1320h. The vacuum chamber 1350 is configured to draw air through the plurality of openings O on a surface of the central conveyor belt 1340e.

In some embodiments, the vacuum chamber 1350 employs vacuum to hold conveyed articles (e.g., an electrochemical cell strip) in position on the belt platforms (e.g., the belt platforms 1330a, 1330b, 1330c, and/or 1330d). The vacuum chamber 1350 may include one or more vacuum sources to draw air through the openings on the conveyor belt platforms. In some embodiments, one vacuum source may provide sufficient vacuum force for all of the conveyor belts. In some embodiments, two or more vacuum sources may be placed within the vacuum chamber 1350.

In some embodiments, the system 1350 further includes vacuum blocks 1355a and 1355b (collectively referred as vacuum blocks 1355) disposed in the vacuum chamber 1350. In some embodiments, the system 1300 may include a plurality of vacuum blocks. In some embodiments, the plurality of vacuum blocks may include a row of vacuum blocks positioned approximately equidistant from each other perpendicular to the travel direction of the central conveyor belt 1330e. In some embodiments, the plurality of vacuum blocks 1355 are positioned above the containers 1360a, 1360b and below the surface of the lower surface of the central conveyor belt 1330e. In some embodiments, the plurality of vacuum blocks 1355 are configured such that the plurality of vacuum blocks 1355 can cover the openings O on the surface of the central conveyor belt 1330e. In some embodiments, the vacuum blocks 1355 may have a blade-like shape. In some embodiments, the position of the vacuum blocks 1355 is adjustable between a first configuration in which the vacuum blocks 1355 do not interfere with the passage of air through the plurality of openings O of the central conveyor belt 1330e and a second configuration in which the vacuum block 1355 do interfere with the passage of air through the plurality of openings O of the central conveyor belt 1330e. In the second configuration, the vacuum blocks 1355, which are formed in the space between the upper and lower positions of the central conveyor belt 1330e, moves towards surface of the lower surface of the central conveyor belt 1330e. This movement causes the vacuum block 1355 to obstruct the openings O (such as slits) on the surface of the central conveyor belt 1330e. Once the openings O on the surface of the lower position of the central conveyor belt 1330e are blocked and suction is stopped, electrochemical cell strips that arrive above the containers 1360a, 1360b fall down into the containers due to gravity.

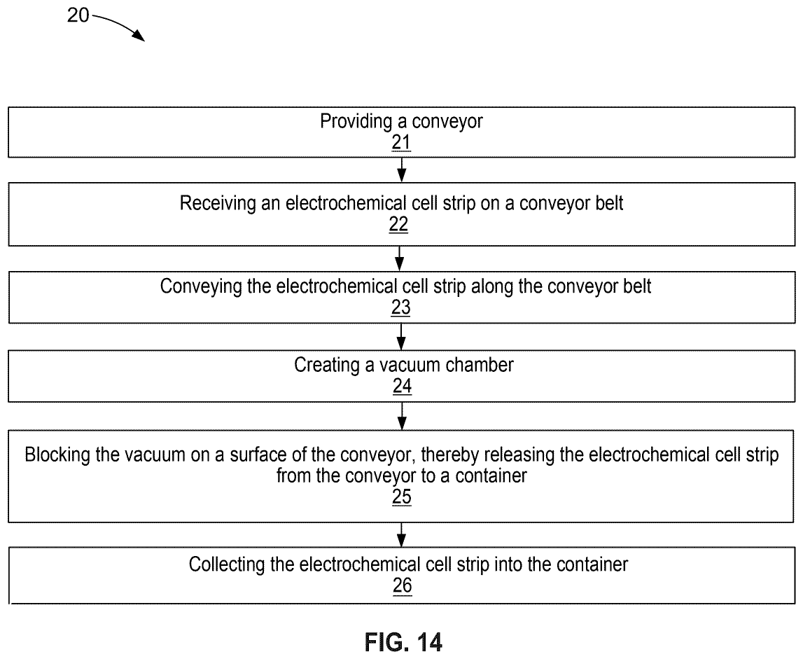

FIG. 14 is a schematic flow chart of a method 20 of conveying an electrochemical cell strip, according to an embodiment. The method 20 includes providing a conveyor system at step 21. In some embodiments, the conveyor system is substantially similar to the systems 1100, 1200, and 1300 described with respect to FIG. 11, 12 and FIGS. 13A-13F. The method 20 further includes receiving an electrochemical cell strip (i.e., a linear arrangement of electrochemical cells or electrochemical cell stacks) on the conveyor at step 22. In some embodiments, the electrochemical cell strip may be received from another conveyance system or a drum. Once, the electrochemical cell strip is received onto the conveyor, the electrochemical cell strip can be conveyed along the conveyor belt until the strip is collected into a container at step 23. In some embodiments, the electrochemical cell strip may have a speed varying at different points along the conveyor. In some embodiments, the conveyor can have a first side and a second side opposite to the first side. In some embodiments, the second side is closer to ground (i.e., underside of the conveyor). In some embodiments, the electrochemical cell strip may be conveyed from the conveyor's first side to its second side.

At step 24, the method 20 further includes creating a vacuum chamber below a surface of the conveyor belt that employs a vacuum to hold conveyed articles (i.e., the electrochemical cell strip) in position on the conveyor belt. In some embodiments, the conveyor belt can include a plurality of openings on its surface configured to allow the passage of air therethrough. The vacuum chamber creates a low-pressure zone with respect to atmospheric pressure such that it applies a vacuum along a predefined length of the conveyor surface, thereby creating a suction through the openings on the conveyor belt which holds electrochemical cell strips against a surface of the conveyor belt. At step 25, the method 20 further includes blocking the vacuum on a surface of a second side of the conveyor to release the electrochemical cell strip from the surface of the second side of the conveyor into a container. In some embodiments, the container may be positioned underneath the second side of the conveyor. In some embodiments, blocking the vacuum, at step 25, includes blocking the openings on the surface of the second side of the conveyor such that the suction through the openings can be obstructed or reduced. Once the vacuum is blocked, the electrochemical cell strip conveyed on the surface of the second side of the conveyor can fall into the container due to gravity. In some embodiments, the container can be both attached to and detached from the conveyor. Once the container is full or at least partially full, the conveyor can be stopped and the container can be detached from the container, at step 26. In some embodiments, the conveyor can be stopped automatically once the container is full.

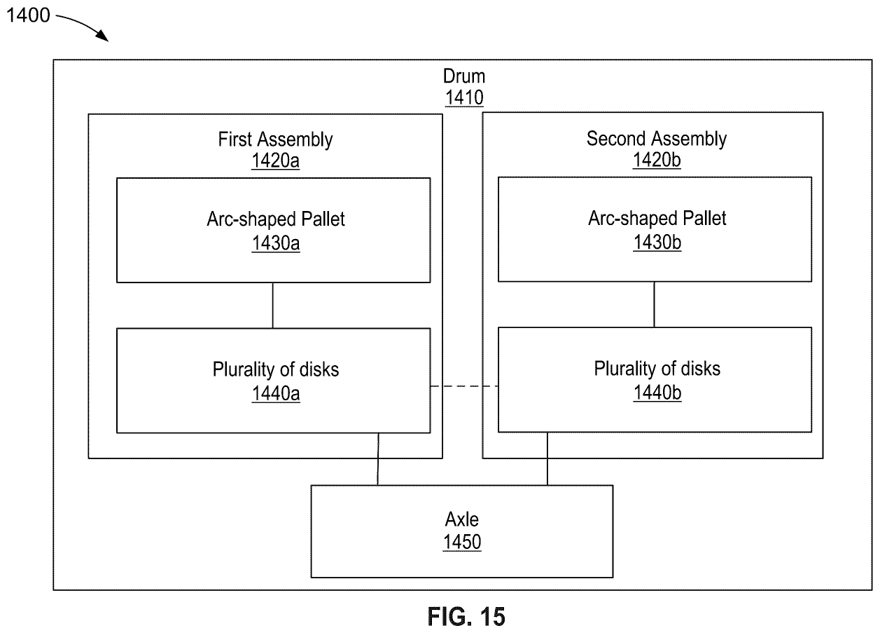

FIG. 15 is a block diagram of a system 1400 for manufacturing an electrode, according to an embodiment. The system 1400 includes a drum 1410 including or constructed from a first assembly 1420a and a second assembly 1420b. In some embodiments, the first assembly 1420a may include a plurality of disks 1440a spaced apart by a distance along an axial direction. In some embodiments, the second assembly 1420b may include a plurality of disks 1440b spaced apart by a distance along an axial direction. In some embodiments, each of the plurality of disks 1440a, 1440b have an outer surface and an inner surface. In some embodiments, the first assembly 1420a may further include an arc-shaped pallet 1430a disposed on the plurality of disks 1440a, the arc-shaped pallet 1430a extending over a portion of the outer surface of the plurality of disks 1440a. In some embodiments, the second assembly 1420b may further include an arc-shaped pallet 1430b disposed on the plurality of disks 1440b, the arc-shaped pallet 1430b extending over a portion of the outer surface of the plurality of disks 1440b. In some embodiments, the system 1400 may further include a center axle 1450 disposed and configured to engage the inner surfaces of the plurality of disks 1440a of the first assembly 1420a and the inner surfaces of the plurality of disks 1440b of the second assembly 1420b. In some embodiments, the first assembly 1420a and the second assembly 1420b can be coupled together. In such embodiments, the plurality of disks 1440a of the first assembly 1420a can be positioned in the spaces between the plurality of disks 1440b of the second assembly 1420 to form the drum.

In some embodiments, the system 1400 can be useful for manufacturing of semi-solid electrodes. In some embodiments, the semi-solid electrodes may be used to form large format cells.

In some embodiments, the arc-shaped pallet 1430a of the first assembly 1420a extends over half the surface of the outer surface of the plurality of disks 1440a. In some embodiments, the arc-shaped pallet 1430b of the second assembly 1420b extends over half the surface of the outer surface of the plurality of disks 1440b. In some embodiments, the arc-shaped pallets 1430a, 1430b (collectively referred to as the arc-shaped pallets 1430) may include one arc-shaped pallet, and the drum 1410 may include two arc-shaped pallets. In some embodiments, the arc-shaped pallets 1430 can include two or more arch-shaped pallets 1430.

In some embodiments, the plurality of disks 1440a, 1440b (collectively referred to as the disks 1440) may include cylindrical roller bearings, spherical roller bearings, tapered roller bearings, needle roller bearings, thrust roller bearings, crossed roller bearings, spherical plain bearings, cam follower bearings, cone and cup bearings, thrust needle roller bearings, cylindrical roller thrust bearings, and spherical thrust roller bearings. In some embodiments, the plurality of disks may be made of a metal, a metal alloy or combination thereof.

There is an increasing interest in manufacturing semi-solid unit cells in larger formats due to improved efficiency of large format cells. In some embodiments, the design of the system 1400 can allow the arc-shaped pallets 1430 to be supported by the axle 1450 (i.e., a central axle). In some embodiments, the axle 1450 can not only simplify the fabrication of the arc-shaped pallets 1430 but also offers superior control over pallet-to-pallet deviations, thereby enhancing the accuracy of the coat weight of the semi-solid applied to a current collector material wrapped or disposed around the drum 1410.

In some embodiments, the axle 1450 is a fixed central axle, and the arc-shaped pallets 1430 can rotate around the fixed center axle. In some embodiments, this may enable the current collector material to be tucked between two arc-shaped pallets 1430a and 1430b. This arrangement ensures that the slurry (e.g., a semi-solid slurry) is not placed on the current collector material between pallets 1430a and 1430b and also helps resist slippage between the current collector material and the surface of the drum 1410 during casting. In some embodiments, an extended angle of the arc-shaped pallets 1430 provides more time to tuck the current collector material between the arc-shaped pallets 1430a and 1430b, a feature that becomes increasingly beneficial as the casting rate of unit cells continues to rise.

In some embodiments, the axle 1450 may be directly coupled to a motor or another power source (e.g., an electric motor), enabling direct transfer of rotational motion. For instance, an electric motor can be attached to the axle 1450 to provide continuous or controlled rotation. In some embodiments, the axle 1450 may be rotated via a gear mechanism. For example, by connecting gears to the axle 1450 and applying force to one gear, the axle 1450 can be rotated.

In some embodiments, the arc-shaped pallets 1430 have a circular shape and have a central angle defined as the angle subtended by that arc-shaped pallet 1430a and 1430b at the center of the circle. In some embodiments, the central angle of the each of the arc-shaped pallets 1430a, 1430b may be at least about 20 degrees, at least about 30 degrees, at least about 40 degrees, at least about 50 degrees, at least about 60 degrees, at least about 70 degrees, at least about 80 degrees, at least about 90 degrees, at least about 100 degrees, at least about 110 degrees, at least about 120 degrees, at least about 130 degrees, at least about 140 degrees, at least about 150 degrees, at least about 160 degrees, at least about 170 degrees, or at least about 180 degrees. In some embodiments, the central angle of the each of the arc-shaped pallets 1430a, 1430b may be no more than about 360 degrees, no more than about 350 degrees, no more than about 340 degrees, no more than about 330 degrees, no more than about 320 degrees, no more than about 310 degrees, no more than about 300 degrees, no more than about 290 degrees, no more than about 280 degrees, no more than about 270 degrees, no more than about 260 degrees, or no more than about 250 degrees. Combinations of the above-referenced values are also possible (e.g., at least about 30 degrees and no more than about 180 degrees or at least about 60 degrees and no more than about 360 degrees), inclusive of all values and ranges therebetween.

In some embodiments, the central angle of the arc-shaped pallets 1430 may be about 180 degrees.

In some embodiments, the arc-shaped pallets 1430 may have a surface arc length of at least about 20 cm, at least about 25 cm, at least about 30 cm, at least about 35 cm, at least about 40 cm, at least about 45 cm, at least about 50 cm, at least about 55 cm, at least about 60 cm, at least about 65 cm, at least about 70 cm, at least about 75 cm, at least about 80 cm, at least about 85 cm, at least about 90 cm, at least about 95 cm, at least about 100 cm, at least about 150 cm, or at least about 200 cm. In some embodiments, the arc-shaped pallet 1430 may have a surface arc length of no more than about 250 cm, no more than about 200 cm, no more than about 150 cm, no more than about 100 cm, no more than about 95 cm, no more than about 90 cm, no more than about 85 cm, no more than about 80 cm, no more than about 75 cm, no more than about 70 cm, no more than about 65 cm, no more than about 60 cm, no more than about 55 cm, no more than about 50 cm, no more than about 45 cm, no more than about 40 cm, no more than about 35 cm, or no more than about 30 cm. Combinations of the above-referenced surface arc lengths are also possible (e.g., at least about 20 cm and no more than about 250 cm or at least about 40 cm and no more than about 100 cm). In some embodiments, the arc-shaped pallet 1430 may have a surface arc length of about 20 cm, about 25 cm, about 30 cm, about 35 cm, about 40 cm, about 45 cm, about 50 cm, about 55 cm, about 60 cm, about 65 cm, about 70 cm, about 75 cm, about 80 cm, about 85 cm, about 90 cm, about 95 cm, about 100 cm, about 150 cm, about 200 cm, or about 250 cm.

In some embodiments, surface arc length of the arc-shaped pallet 1430 can be varied such that an electrochemical cell having a width of at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, or at least about 1.5 m can be formed.

In some embodiments, the drum 1410 may formed of a plurality of arc-shaped members (i.e., pallets). In some embodiments, the plurality of arc-shaped pallets includes 2, 3, 4, 5, 6, 7, 8, 9, 10, 11, 12, 13, 14, 15, 16, 17, 18, 19, or 20.

In some embodiments, the drum 1410 has a radius of at least about 50 cm, at least about 55 cm, at least about 60 cm, at least about 65 cm, at least about 70 cm, at least about 75 cm, at least about 80 cm, at least about 85 cm, at least about 90 cm, at least about 95 cm, at least about 100 cm, at least about 105 cm, at least about 110 cm, at least about 115 cm, at least about 120 cm, at least about 125 cm, at least about 130 cm, at least about 135 cm, at least about 140 cm, at least about 150 cm, at least about 155 cm, at least about 160 cm, at least about 165 cm, at least about 170 cm, at least about 175 cm, at least about 180 cm, at least about 185 cm, at least about 190 cm, at least about 195 cm, at least about 200 cm, at least about 220 cm, at least about 240 cm, at least about 260 cm, at least about 280 cm, at least about 300 cm, at least about 350 cm, at least about 400 cm, or at least about 450 cm. In some embodiments, the drum 1410 has a radius between about 50 cm to about 10 m, about 50 cm to about 500 cm, about 20 cm to about 450 cm, about 20 cm to about 400 cm, about 20 cm to about 350 cm, about 20 cm to about 300 cm, about 20 cm to about 250 cm, about 20 cm to about 200 cm, about 20 cm to about 150 cm, about 20 cm to about 140 cm, about 20 cm to about 130 cm, about 20 cm to about 120 cm, about 20 cm to about 110 cm, about 20 cm to about 100 cm, about 20 cm to about 90 cm, about 20 cm to about 80 cm, about 20 cm to about 60 cm, inclusive of all values and ranges therebetween. In some embodiments, the drum 110 has a radius of no more than about 10 m, no more than about 500 cm, no more than about 450 cm, no more than about 400 cm, no more than about 350 cm, no more than about 300 cm, no more than about 280 cm, no more than about 260 cm, no more than about 240 cm, no more than about 220 cm, no more than about 200 cm, no more than about 195 cm, no more than about 190 cm, no more than about 185 cm, no more than about 180 cm, no more than about 175 cm, no more than about 170 cm, no more than about 165 cm, no more than about 160 cm, no more than about 155 cm, no more than about 150 cm, no more than about 145 cm, no more than about 140 cm, no more than about 135 cm, no more than about 130 cm, no more than about 125 cm, no more than about 120 cm, no more than about 115 cm, no more than about 110 cm, no more than about 105 cm, no more than about 100 cm, no more than about 95 cm, no more than about 90 cm, no more than about 85 cm, no more than about 80 cm, no more than about 75 cm, no more than about 70 cm, no more than about 65 cm, no more than about 60 cm, no more than about 55 cm, no more than about 50 cm, no more than about 45 cm, no more than about 40 cm, no more than about 35 cm, no more than about 30 cm, or no more than about 25 cm. Combinations of the above-referenced radius values are also possible (e.g., at least about 50 cm and no more than about 500 cm or at least about 40 cm and no more than about 200 cm), inclusive of all values and ranges therebetween. In some embodiments, the drum 110 has a radius of about 50 cm, about 55 cm, about 60 cm, about 65 cm, about 70 cm, about 75 cm, about 80 cm, about 85 cm, about 90 cm, about 95 cm, about 100 cm, about 105 cm, about 110 cm, about 115 cm, about 120 cm, about 125 cm, about 130 cm, about 135 cm, about 140 cm, about 150 cm, about 155 cm, about 160 cm, about 165 cm, about 170 cm, about 175 cm, about 180 cm, about 185 cm, about 190 cm, about 195 cm, about 200 cm, about 220 cm, about 240 cm, about 260 cm, about 280 cm, about 300 cm, about 350 cm, about 400 cm, about 450 cm, or about 500 cm.

The drum 1410 can move at various speeds (e.g., about 5 rpm, about 10 rpm, about 15 rpm, about 20 rpm, about 25 rpm, about 30 rpm, about 40 rpm, about 50 rpm, about 60 rpm, about 70 rpm, about 80 rpm, about 90 rpm, or about 100 rpm, inclusive of all values and ranges therebetween).

In some embodiments, the arc-shaped pallets 1430 have support ribs designed to withstand high casting forces. Each rib can be fitted with a disk to transfer the loads from the casting surface of the arc-shaped pallets 1430 to the axle 1450.

In some embodiments, the axle 1450 may offer a precise path for the arc-shaped pallets 1430 to pivot around. The use of the axle 1450 can simplify construction and streamlines the manufacturing of the drum 1410, while improving the accuracy of the pallet surface, leading to enhanced cell accuracy. In some embodiments, the center axle 1450 has a cylindrical shape and each of the plurality of disks 1440 has a spherical shape.

In some embodiments, the center axle 1450 may be formed from a metal, a metal alloy or combination thereof. In some embodiments, the central axle 1450 and/or the plurality of disks 1440 can be constructed from a variety of materials, including chrome-molybdenum steel, carbon steel, nickel steel, and/or carbon steel.

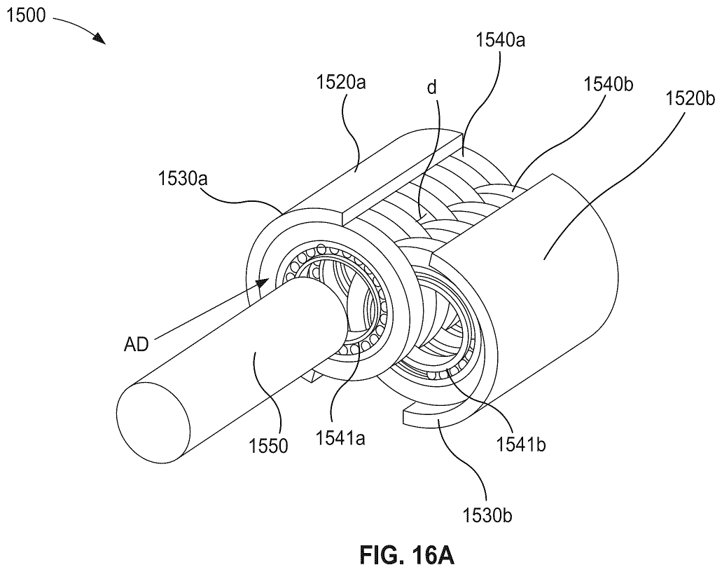

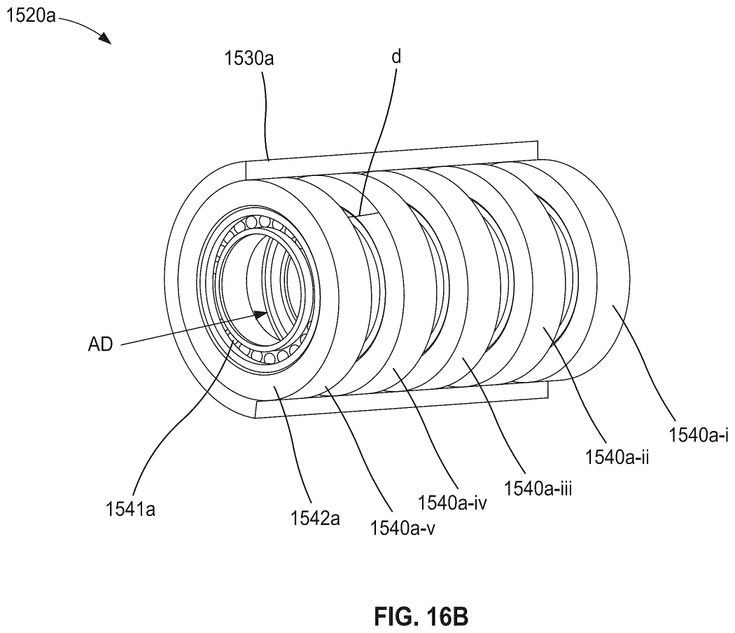

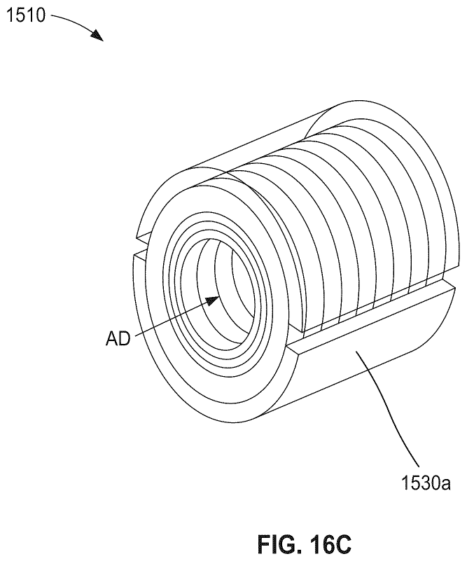

FIGS. 16A-16C are illustrations of a system 1500 for manufacturing an electrode, and various components thereof, according to an embodiment.

The system 1500 includes a drum 1510 constructed from a first assembly 1520a and a second assembly 1520b. In some embodiments, the first assembly 1520a may include a plurality of disks 1540a (i.e., 1540a-i, 1540a-ii, 1540a-iii, 1540a-iv, 1540a-v) spaced apart by a distance “d” along an axial direction “AD”. In some embodiments, the second assembly 1520b may include a plurality of disks 1440b (i.e., 1540b-i, 1540b-ii, 1540b-iii, 1540b-iv, 1540b-v) spaced apart by a distance “d” along an axial direction “AD”. In some embodiments, the plurality of disks 1540a have an outer surface 1542a and an inner surface 1541a. In some embodiments, each of the plurality of disks 1540b have an outer surface 1542b and an inner surface 1541b. In some embodiments, the first assembly 1520a may further include an arc-shaped pallet 1530a disposed on the plurality of disks 1540a, the arc-shaped pallet 1530a extending over a portion of the outer surface of the plurality of disks 1540a. In some embodiments, the second assembly 1520b may further include an arc-shaped pallet 1530b disposed on the plurality of disks 1540b, the arc-shaped pallet 1530b extending over a portion of the outer surface of the plurality of disks 1540b. In some embodiments, the system 1500 may further a center axle 1550 disposed and configured to engage the inner surfaces 1541a of the plurality of disks 1540a of the first assembly 1520a and the inner surfaces 1541b of the plurality of disks 1540b of the second assembly 1520b. In some embodiments, the first assembly 1520a and the second assembly 1520b can be configured to be coupled together. In such embodiments, the plurality of disks 1540a of the first assembly 1520a can be positioned in the spaces between the plurality of disks 1540b of the second assembly 1520 to form the drum, as shown in FIG. 16A.

In some embodiments, the drum 1510, the first assembly 1520a, the second assembly 1520b, the plurality of disks 1540a, 1540b, the arc-shaped pallets 1530a, 1530b, and the axle 1550 can be the same or substantially similar to the drum 1410, the first assembly 1420a, the second assembly 1420b, the plurality of disks 1440a, 1440b, the arc-shaped pallets 1430a, 1430b, and the axle 1450 as described with respect to FIG. 15.

As shown in FIGS. 16A-16C, the arc-shaped pallet 1530a of the first assembly 1520a extends over half the surface of the outer surface of the plurality of disks 1540a and the arc-shaped pallet 1530b of the second assembly 1520b extends over half the surface of the outer surface of the plurality of disks 1440b.

In some embodiments, the distance d between each arc-shaped pallet can be at least at least about 1 cm, at least about 3 cm, at least about 5 cm, at least about 7 cm, at least about 10 cm, at least about 15 cm, at least about 20 cm, at least about 25 cm, at least about 30 cm, at least about 35 cm, at least about 40 cm, at least about 45 cm, or at least about 50 cm. In some embodiments, the distance d between each arc-shaped pallet can be no more than about 500 cm, no more than about 450 cm, no more than about 400 cm, no more than about 350 cm, no more than about 300 cm, no more than about 250 cm, no more than about 200 cm, no more than about 150 cm, no more than about 100 cm, no more than about 50 cm, no more than about 40 cm, no more than about 30 cm, no more than about 20 cm, or no more than about 10 cm. Combinations of the above-referenced distances d are also possible (e.g., at least about 5 cm and no more than about 100 cm or at least about 20 cm and no more than about 200 cm), inclusive of all values and ranges therebetween.

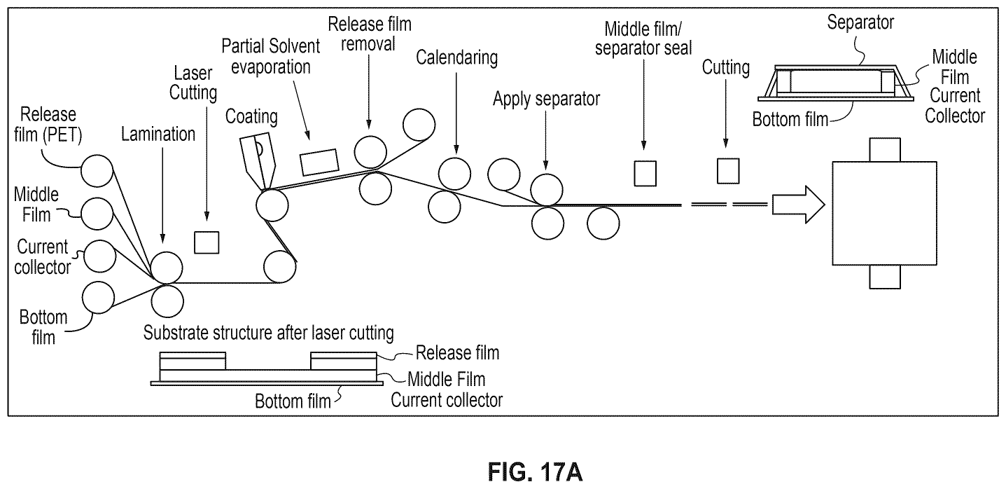

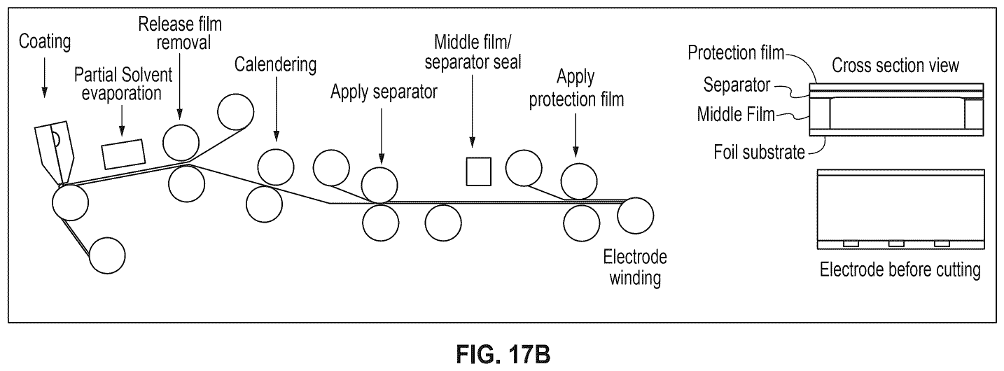

FIGS. 17A-17B are illustrations of a roll-to-roll system for semi-solid electrode manufacturing, according to an embodiment. As shown in FIG. 17A, the process starts with laminating multilayer films on a current collector via a rolling process. In some embodiments, the rolling process can include passing multiple films and a current collector material through heated rolls to laminate the films on the current collector. A coating area with exposed current collector material and without films can be created by cutting the laminated films. The size of the coating area is determined by the designed electrode size. After cutting, the multilayered substrate can pass through a coating apparatus where the electrode slurry is dispersed on substrate. The coating apparatus can include any coating systems for conventional LIB, including, but not limited, to a die coater and/or a comma coater. The coated slurry is then partially dried by controlled evaporation of solvents. The controlled evaporation can be achieved by adjusting drying temperature, convection air speed, line speed (time) and/or other parameters. The top film is then removed from the substrate through a rolling process, wherein any residue slurry outside of electrode coating area is removed. The electrodes are calendered to the desired thickness by a calender machine. A separator is then applied to the top of electrodes by passing two rolls, which is fixed on the substrate by heat sealing between separator and film frame surrounding electrodes. Finally, discrete electrodes are cut according to designed electrode dimensions.

An optional roll-to-toll system is shown in FIG. 17B. In FIG. 17B, a roll of coated electrodes is manufactured, rather than discrete electrodes, as depicted in FIG. 17A. After application of a separator, a protection film is applied on the top of the electrodes by a rolling process. The resulting multilayered endframe electrodes are wound to a roll of electrodes that can be used for subsequent cell assembly. The protection film functioned as protecting the electrode surface and preventing or minimizing solvent evaporation during storage.

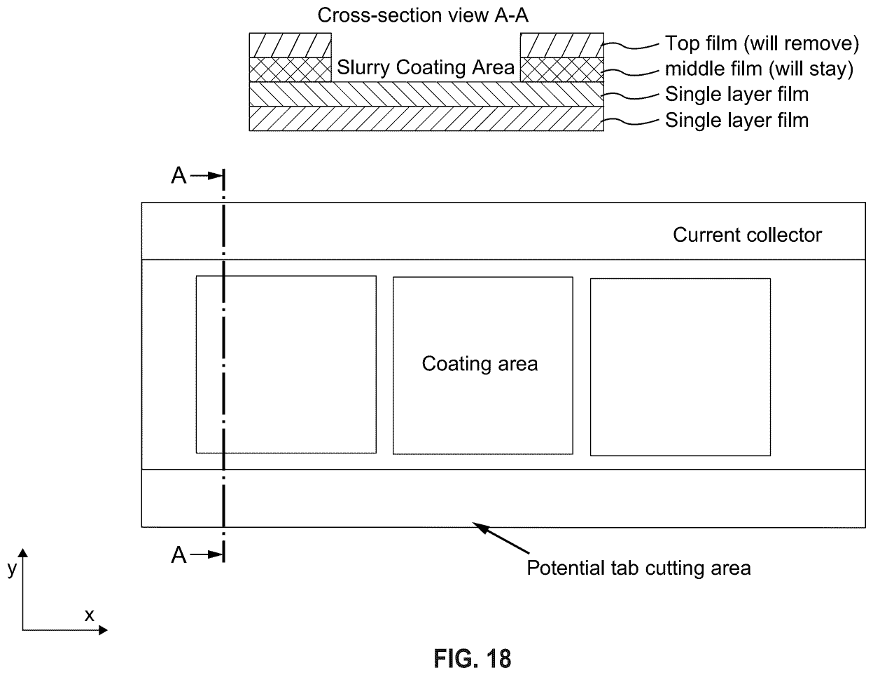

FIG. 18 is an illustration of an endframe substrate before coating via the roll-to-roll process, according to an embodiment. Inset shows a cross-section view of the endframe substrate taken along the line A-A shown in FIG. 18. The cross-section shows the multilayered structure that includes a top film, a middle film, a current collector, and a film under current collector. The configuration is slightly different from FIG. 7 in that the middle film is directly laminated to current collector rather than on bottom film. The top film can be removed after slurry coating. The middle film can include a single layer or multiple layers. The top view of the endframe substrate shows the multilayer films laminated on current collector. The width of the current collector can be larger than multilayer films on one side or both sides so that edge foil can be cut for tab connections. In some embodiments, one or two electrodes can be placed in the width direction (i.e., along the x-axis in FIG. 18) depending on electrode design. The central areas where current collector is exposed is for electrode slurry coating.

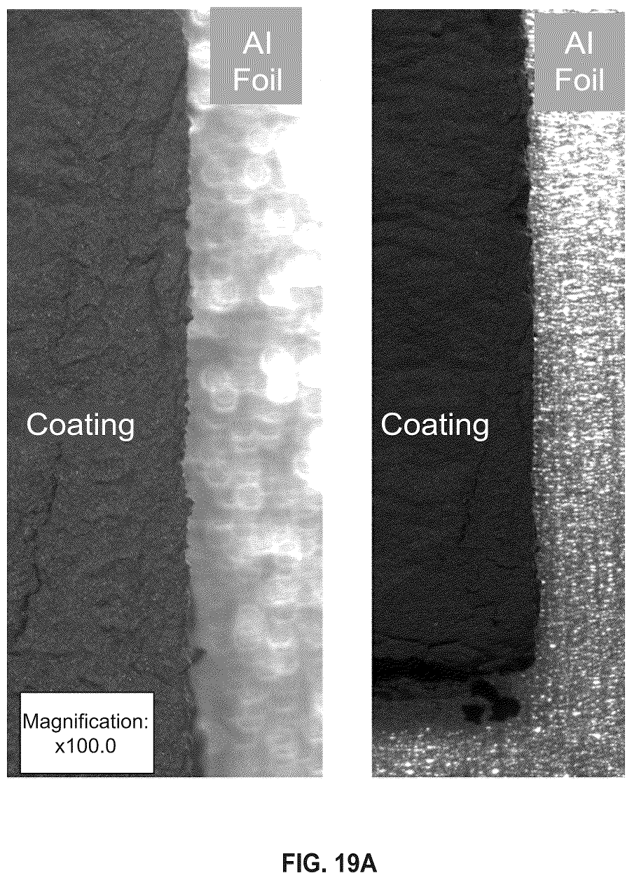

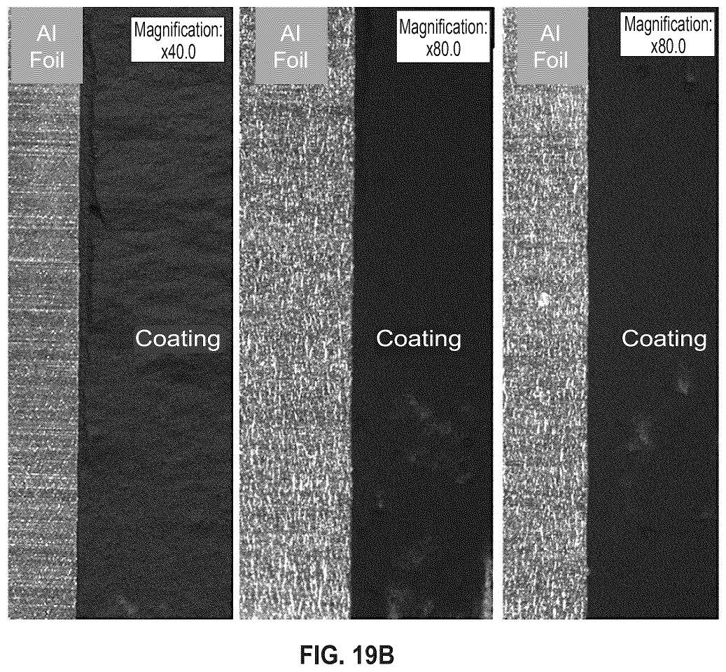

The optical images of coated electrodes are shown in FIGS. 19A-B, in which the films on current collector were removed (i.e., only electrode material coated on current collector). The middle film in FIG. 18 with or without adhesive facing current collector has important impact on coating edge quality. The adhesive provides a good seal between middle film and current collector and prevents slurry from spreading to the space between the two layers. For example, electrode edges are not straight, well defined when middle film is without adhesive (FIG. 19A), while the electrode edges are straight, well defined when middle film is with adhesive. FIG. 19B is an optical microscope image of a semi-solid electrode showing edge quality with adhesive on a middle film facing the current collector. The images thus demonstrate the importance of endframe structure design.

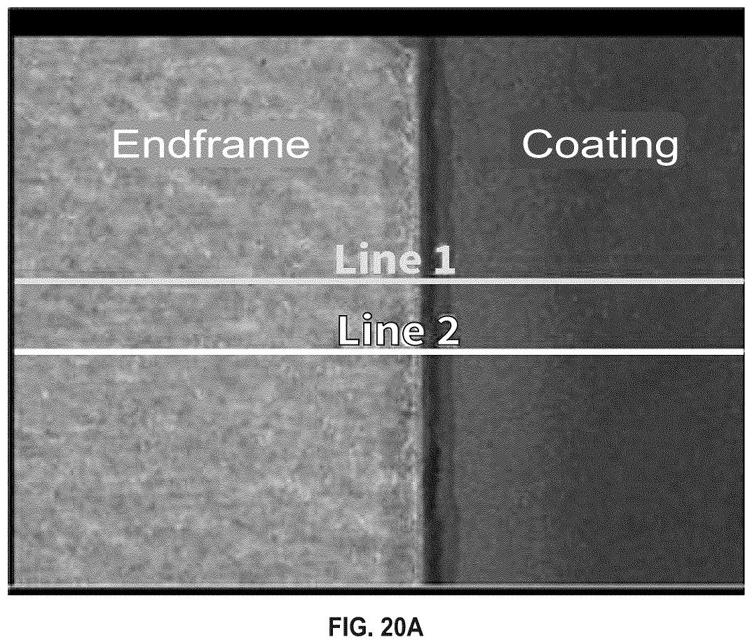

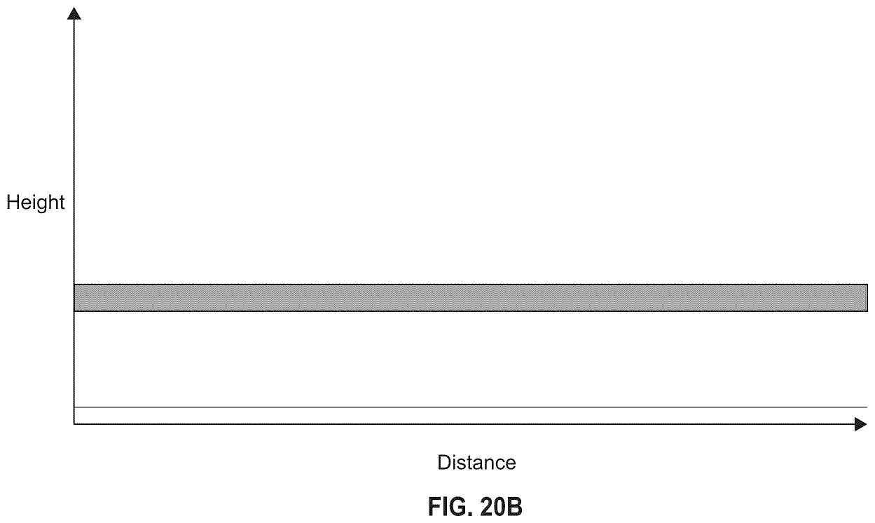

The electrode quality is further examined by line scan of electrode height in optical microscope (FIGS. 20A-20B). In this case, the top film on the current collector was removed and the electrode was calendered. The lines are on the center of the electrode (FIG. 20A). The line scan height profile is shown in FIG. 20B. The height profile shows a straight-line indicating uniform height cross the electrode and films. The films thus act as frames that define the coating thickness after calendering. The line scan results demonstrate uniform electrodes can be fabricated by a roll-to-roll process with endframe.

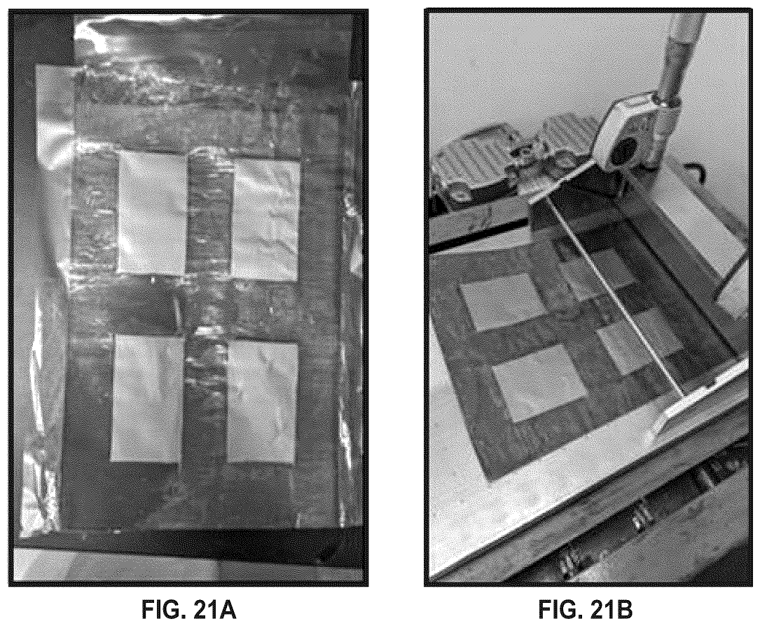

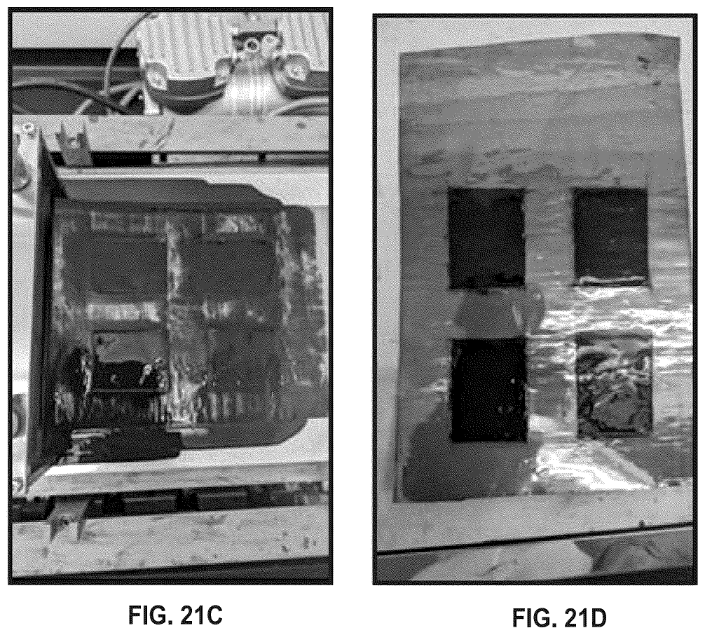

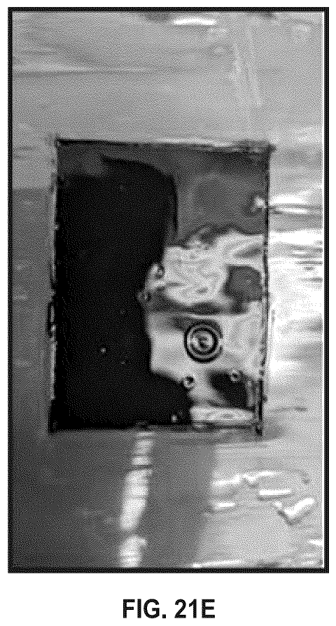

FIGS. 21A-E are illustrations of multi-electrode continuous coating with a doctor blade. This demonstration shows the feasibility by simulation in a small-scale hand coating. This can be easily scaled to a roll-to-roll coating with a conventional electrode coater in LIB industry. The process starts with assembling of endframe substrate (FIG. 21A). After setting an appropriate gap size of the doctor blade (FIG. 21B), electrode slurry was coated on the substrate (FIG. 21C). After removal of the top film, multiple electrodes with well-defined edges were fabricated (FIGS. 21D and 21E).

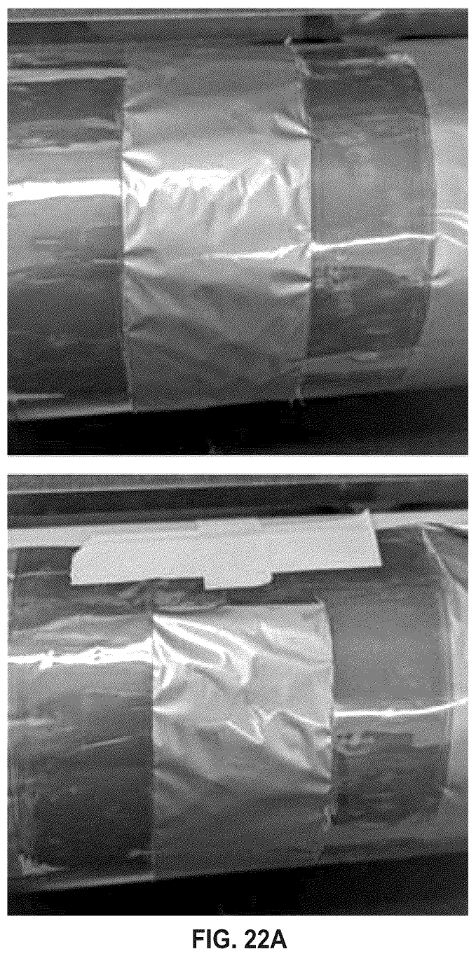

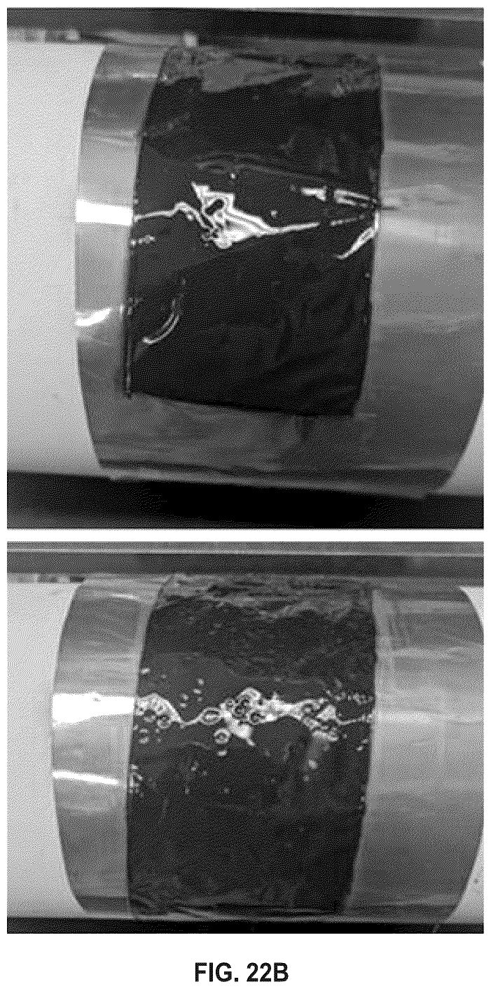

To demonstrate the feasibility of fabricating electrodes in rolls, the electrodes with endframes were wound on a 3-inch core (FIGS. 22A-22B). FIG. 22A and FIG. 22B show the endframe electrode before and after slurry coating, respectively. The coated semi-solid electrodes show good adhesion and flexibility so that they can be wound on a 3-inch core without issues. The results thus demonstrate that it is feasible to fabricate endframe electrodes in rolls.

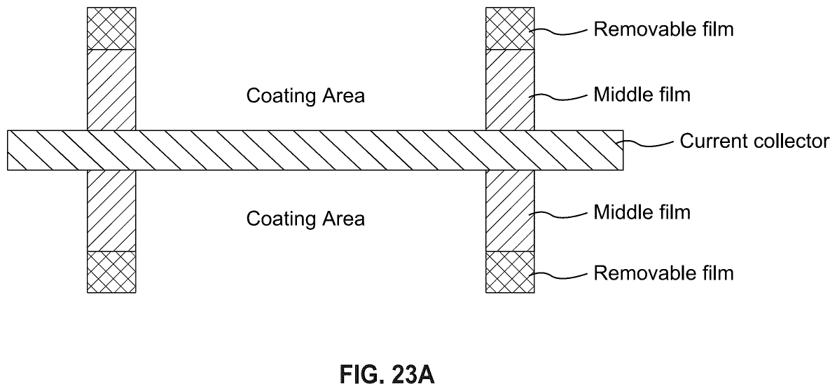

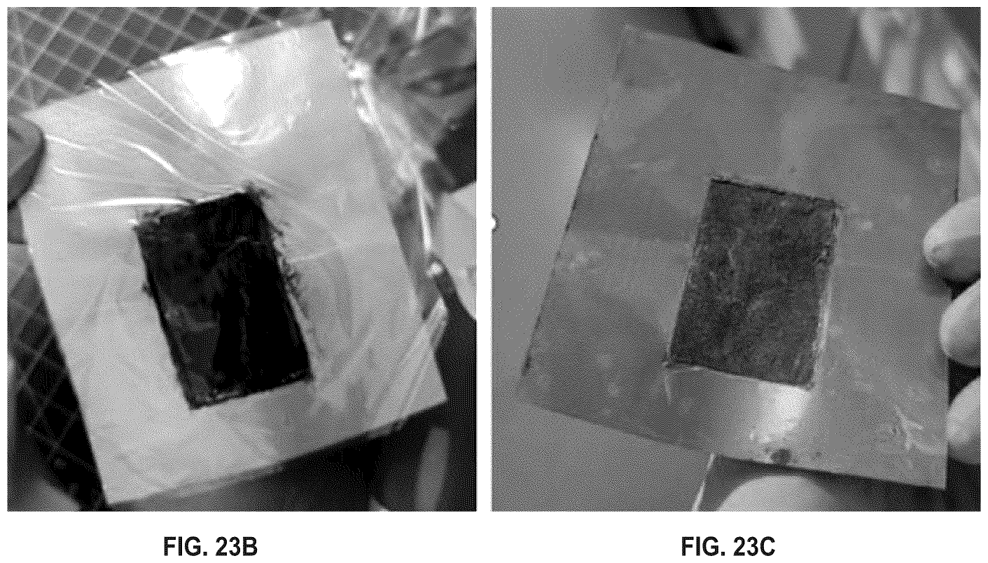

To demonstrate the feasibility of fabricating double sided electrodes, electrode slurry was coated on both sides of the endframe substrate (FIG. 23A-C). This can be accomplished by slightly modifying the endframe structure (FIG. 23A), in which the middle film and the top film are laminated on both sides of the current collector. The coated electrodes shaped with a doctor blade are shown in FIGS. 23B and 23C, in which electrodes with one side (FIG. 23B) or both sides (FIG. 23C) were coated. The results thus demonstrated that double sided electrodes can be fabricated by the roll-to-roll process with endframe.

A critical process in this roll-to-roll process is how to prepare slurries that can be coated by a conventional coater. The slurries manufacturing methods from earlier patent applications (U.S. Patent Publication No. 2022/0238923 and U.S. patent application Ser. No. 18/212,414) are not suitable for this roll-to-roll process due to high viscosity of the electrodes. In order to reduce the slurry viscosity, additional solvents will be added to the slurry. The solvents can include those with high evaporation rate and are compatible to the electrode and electrolyte components. Examples of solvents include dimethyl carbonate (DMC), ethyl methyl carbonate (EMC). The solvents are evaporated at room temperature or higher temperature by air circulation. The amount of solvent evaporation depends on the electrode composition design. Typically, solvent evaporation will increase the active material content in the electrodes, which leads to higher cell energy density.

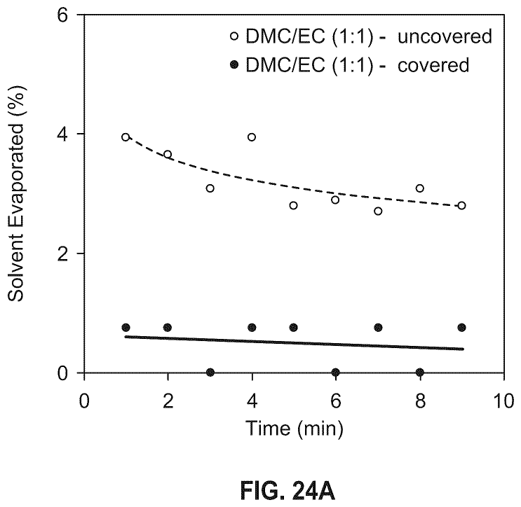

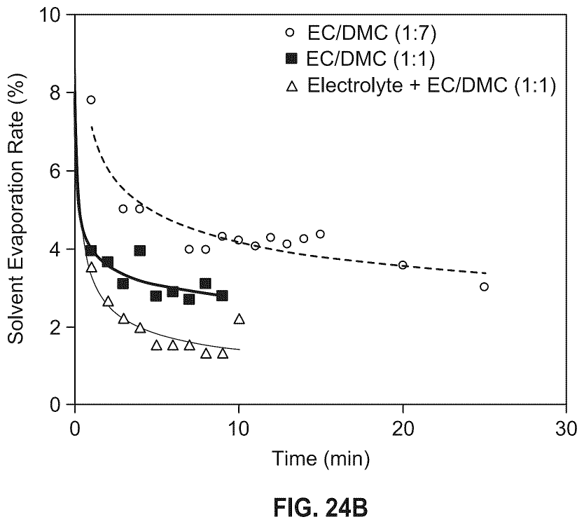

The solvent evaporation study results are shown in FIGS. 24A-24B. For electrodes exposed to air in dry room (FIG. 24A), the evaporation continues with time although the evaporation rate slows. On the other hand, when the electrode surface is covered, the evaporation rate is dramatically reduced to a minimum rate. This demonstrates that the electrode composition can be kept unchanged by adding a top protection film. This is especially important when endframe electrodes are wound to rolls after coating and stored for the next cell assembly process. To control the evaporation speed, the slurry solvent compositions were investigated (FIG. 24B). More volatile solvent in the slurry leads to faster evaporation. For example, DMC/EC (7:1) shows much faster solvent evaporation than DMC/EC (1:1) in the electrode slurry. The effect of electrolyte addition on the solvent evaporation is also shown in FIG. 24B. The difference in solvent evaporation rate is mainly due to the difference in solvent type and concentration.

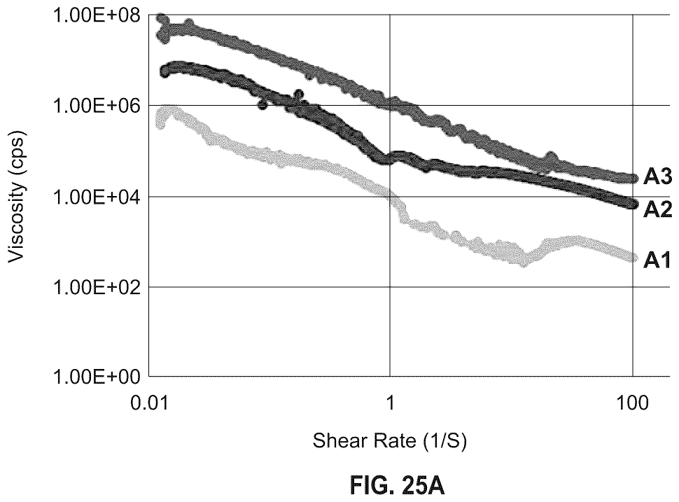

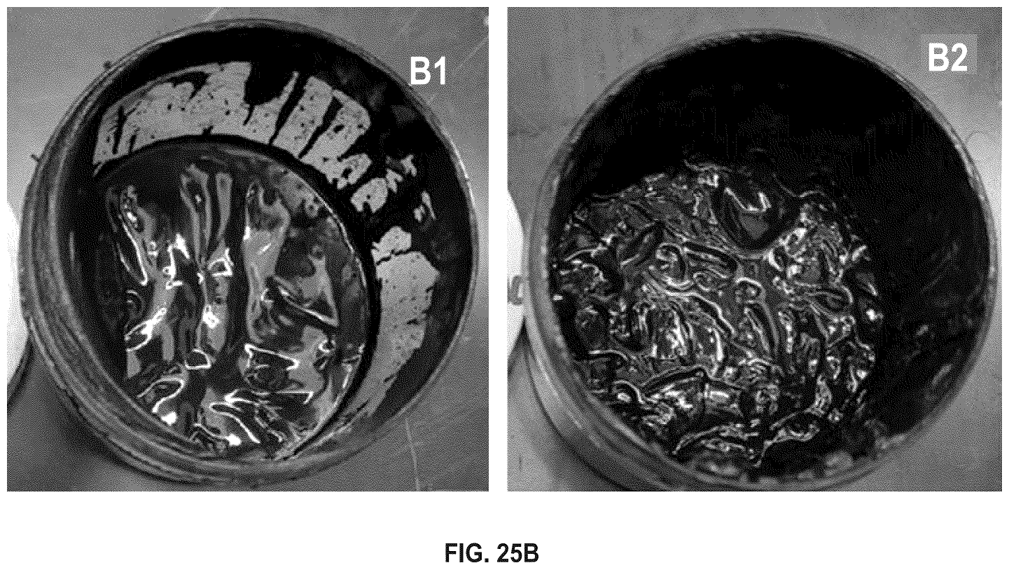

The slurry viscosity vs. shear rate is shown in FIG. 25A. Slurry with high surface area active material (A3) shows higher viscosity than that with lower surface area active material at similar solid content. On the other hand, slurry with lower solid content (A2) shows lower viscosity than that with higher solid content, regardless of if lithium salt is added or not. The results thus demonstrate slurry viscosity is affected by solid content and surface area of active materials. Lithium salt can be added to slurry as in the form of electrolyte during the slurry preparation process. This is further confirmed by the photos of slurries with and without electrolyte, in which both slurries exhibit similar appearance (FIG. 25B).

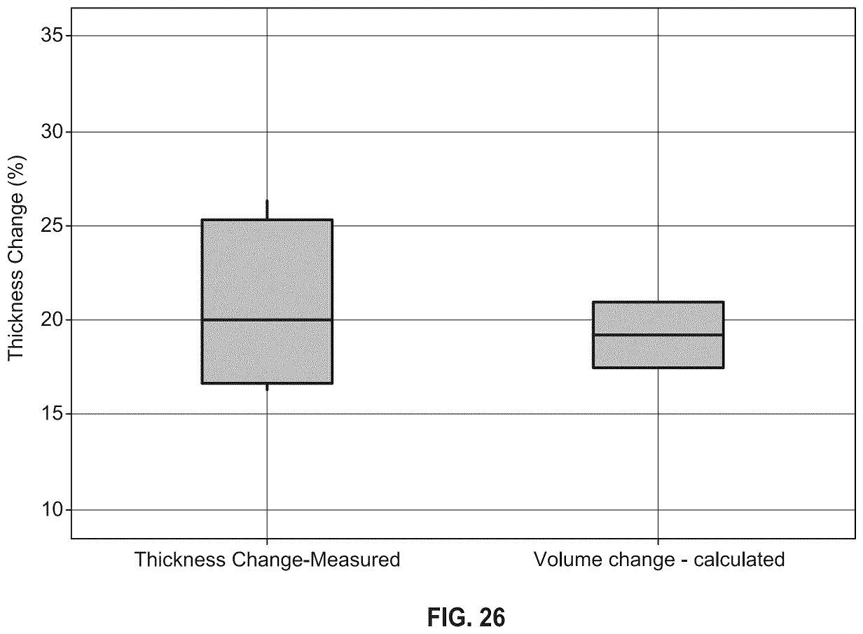

In order to increase the energy density, electrodes need to be densified. The measured thickness change of electrodes after densification is consistent to the calculated thickness change based on slurry weight change after solvent evaporation (FIG. 26), which shows full densification of the electrodes (no void space). The electrode density after densification can be controlled by solvent amount in the slurry and the amount of solvent evaporation.

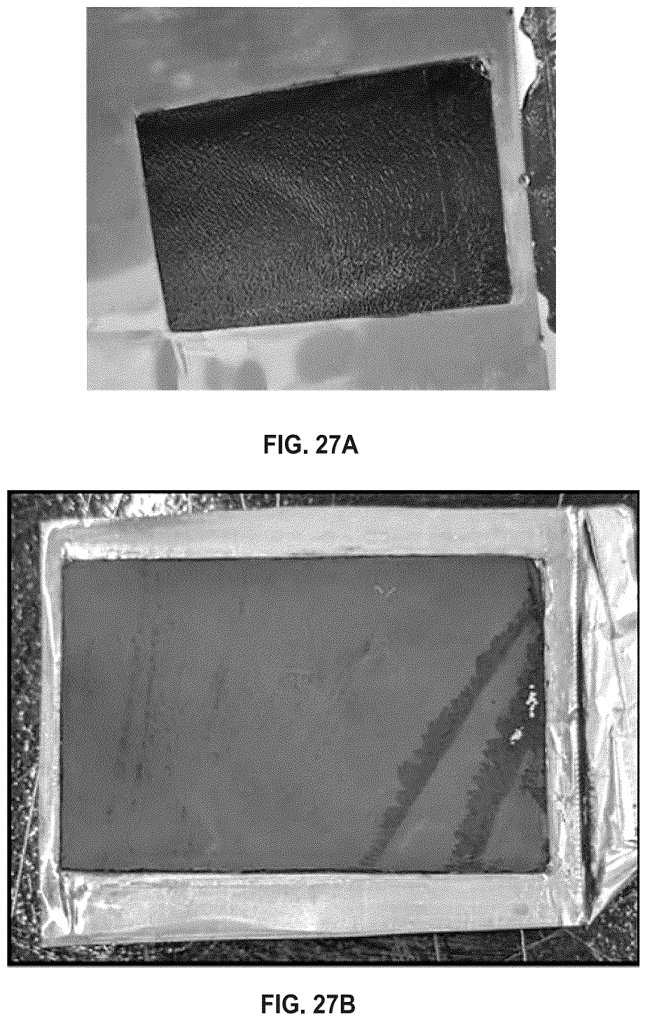

The mechanical stability of endframe electrodes, especially under pressure, were investigated and results are shown in FIGS. 27A-B. Endframe electrodes were assembled into a pouch cell and pressed under a pressure typical for cell formation (˜14 psi). There is no change of electrode dimension and edge quality before (FIG. 27A) and after applying pressure (FIG. 27B). These images demonstrate that the endframe electrodes are mechanically stable. The endframe provides mechanical support to prevent a semi-solid electrode from deformation under pressure. The deformation of electrodes can not only result in cell performance degradation but also cause safety concerns when lithium plating occurs due to a change in electrode size under pressure.

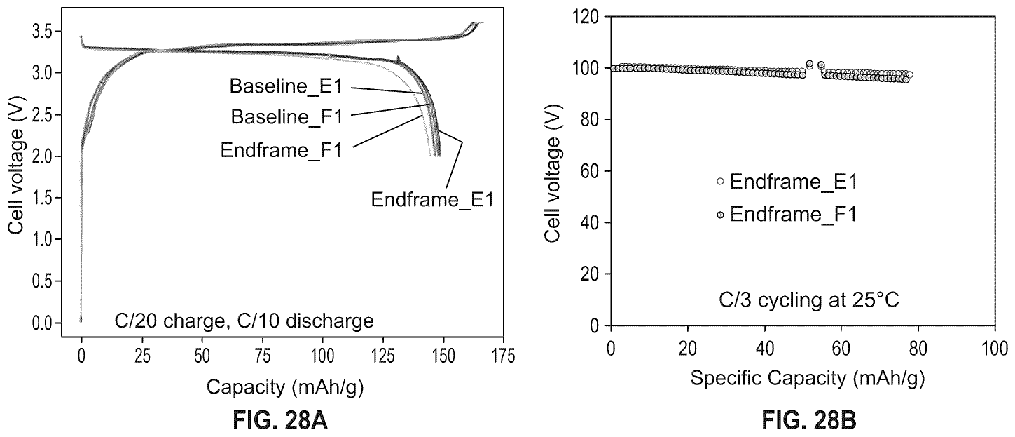

The endframe electrodes with a lithium iron phosphate cathode and a graphite anode were assembled in pouch cells and the electrochemical testing results are shown in FIGS. 28A-B. For comparison, cells with electrodes fabricated by previous method described in U.S. Patent Publication No. 2022/0238923 were fabricated and noted as “baseline”. The cells with electrodes fabricated by the roll-to-roll process show similar 1^{st} cycle capacity to the baseline cells (FIG. 28A). The effect of electrolyte (E1 vs. F1) is not significant due to low current (C/10) during formation. Long term cycling (FIG. 28B) shows the cells with endframe electrodes are stable in cycling with small capacity fade (95% capacity retention with 80 cycles).

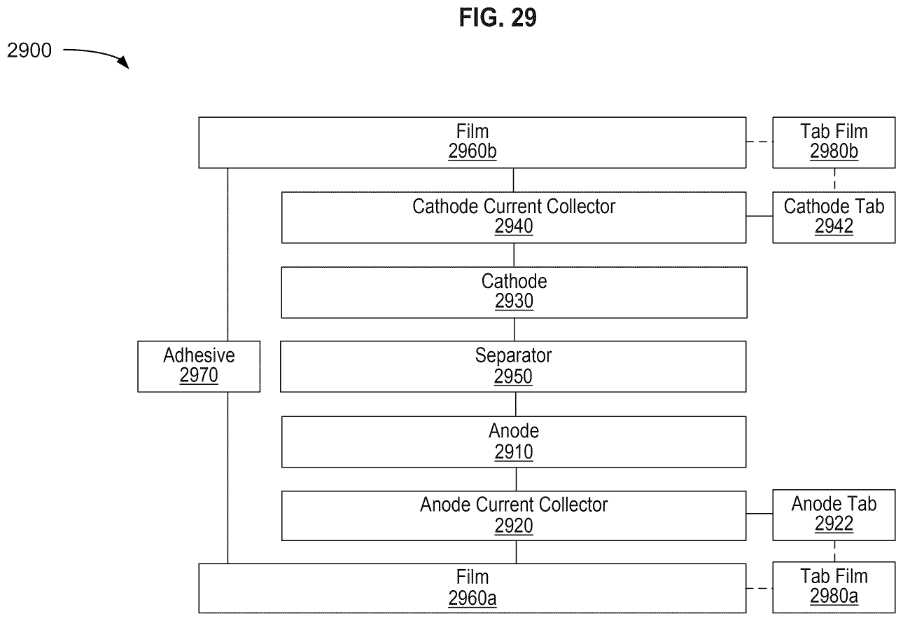

FIG. 29 is a block diagram of an electrochemical cell 2900, according to an embodiment. As shown, the electrochemical cell 2900 includes an anode 2910 coupled to an anode current collector 2920, a cathode 2930 coupled to a cathode current collector 2940, and a separator 2950 disposed between the anode 2910 and the cathode 2930. An anode tab 2922 is coupled to the anode current collector 2920 and a cathode tab 2942 is coupled to the cathode current collector 2940. A film 2960a is coupled to the anode current collector 2920 and a film 2960b is coupled to the cathode current collector 2940. The film 2960a is coupled to the film 2960b via an adhesive 2970. A tab film 2980a optionally joins the anode tab 2922 and the film 2960a while a tab film 2980b optionally joins the cathode tab 2942 and the film 2960b.

In some embodiments, the anode 2910 can include an anode material. In some embodiments, the cathode 2930 can include a cathode material. In some embodiments, the anode 2910 and/or the cathode 2930 can include a conventional solid electrode. In some embodiments, the anode 2910 and/or the cathode 2930 can include a semi-solid electrode material. In some embodiments, the anode 2910 can include zinc metal foil, zinc powder, zinc paste (including zinc powder and binder), indium-doped zinc metal, porous zinc metal, or any combination thereof. In some embodiments, the anode 2910 can include graphite, lithium metal (Li), sodium metal (Na), potassium metal (K), silicon oxide (SiO), graphite, silicon, carbon, hard carbon, lithium-intercalated carbon, lithium nitrides, lithium alloys, lithium alloy forming compounds, sodium-intercalated carbon, sodium nitrides, sodium alloys, sodium alloy forming compounds, potassium-intercalated carbon, potassium nitrides, potassium alloys, potassium alloy forming compounds, or any combination thereof.

In some embodiments, the cathode 2930 can include NiOOH, silver, MnO₂, polymorphs, various tunnel structures (α, γ-MnO₂), layer structure (δ and birnessite MnO₂), 3D structure (λ-MnO₂), spinel Mn₃O₄, ZnMn₂O₄, LiMn₂O₄, Zn_{0.25}V₂O₅·nH₂O, V₂O₅·nH₂O, Ca_{0.20}—V₂O₅·80H₂O nickel-based double hydroxides (Ni-DH), NiCo-DH, α-Ni(OH)₂, Co₃O₄, sulfur heterocyclic quinone dibenzo[b,i]thian-threne-5,7,12,14-tetraone (DTT), calix(4)quinone, P-chloranil, or any combination thereof. In some embodiments, the cathode 2930 can include a metal-oxide such as LiCoO₂ (lithium cobalt oxide, LCO), Li(Ni, Mn, Co)O₂ (lithium nickel manganese cobalt oxide, NMC, which is also referred to herein as NCM), LiNi_{0.8}Co_{0.15}Al_{0.05}O₂ (lithium nickel cobalt aluminum oxide, NCA), LiMn₂O₄ (lithium manganese oxide, LMO), LiCoPO₄ (lithium cobalt phosphate, LCP), LiNiPO₄ (lithium nickel phosphate, LNP), LiFePO₄ (lithium iron phosphate, LFP), LiMnPO₄ (lithium manganese phosphate, LMP), LiMn_{0.85}Fe_{0.15}PO₄ (lithium manganese iron phosphate, LMFP), and/or Li₄Ti₅O₁₂ (lithium titanate, LTO). In some embodiments, the cathode 2930 can include a metal-oxide such as NaCoO₂ (sodium cobalt oxide, Na(Ni, Mn, Co)O₂ (sodium nickel manganese cobalt oxide), NaNi_{0.8}Co_{0.15}Al_{0.05}O₂ (sodium nickel cobalt aluminum oxide), NaMn₂O₄ (sodium manganese oxide), NaCoPO₄ (sodium cobalt phosphate), NaNiPO₄ (sodium nickel phosphate), NaFePO₄ (sodium iron phosphate), NaMnPO₄ (sodium manganese phosphate), NaMn_{0.85}Fe_{0.15}PO₄ (sodium manganese iron phosphate), Na₄Ti₅O₁₂ (sodium titanate), sodium manganese oxide, sodium vanadium oxide, sodium sulfur compounds, and/or Prussian blue/white analogues. In some embodiments, the cathode 2930 can include a metal-oxide such as KCoO₂ (potassium cobalt oxide, K(Ni, Mn, Co)O₂ (potassium nickel manganese cobalt oxide), KNi_{0.8}Co_{0.15}Al_{0.05}O₂ (potassium nickel cobalt aluminum oxide), KMn₂O₄ (potassium manganese oxide), KCoPO₄ (potassium cobalt phosphate), KNiPO₄ (potassium nickel phosphate), KFePO₄ (potassium iron phosphate), KMnPO₄ (potassium manganese phosphate), KMn_{0.85}Fe_{0.15}PO₄ (potassium manganese iron phosphate), K₄Ti₅O₁₂ (potassium titanate), Prussian blue/white analogues, potassium cobalt oxide (KCO), potassium iron phosphate (KFP), potassium nickel cobalt manganese oxide (KNMC), potassium manganese oxide, potassium vanadium oxide, or any combination thereof.

In some embodiments, the anode current collector 2920 and/or the cathode current collector 2940 can include copper, aluminum, titanium, or other metals that do not form alloys or intermetallic compounds with lithium, carbon, and/or coatings comprising such materials disposed on another conductor.

In some embodiments, the separator 2950 can include polyethylene, polypropylene, high density polyethylene, polyethylene terephthalate, polystyrene, a thermosetting polymer, hard carbon, a thermosetting resin, a polyimide, a ceramic coated separator, an inorganic separator, cellulose, glass fiber, a polyethylenoxide (PEO) polymer in which a lithium salt is complexed to provide lithium conductivity, NAFION™ membranes which are proton conductors, or any other suitable separator material, or combinations thereof.

In some embodiments, the electrochemical cell 2900 can include an electrolyte. In some embodiments, the electrolyte can include a liquid electrolyte. In some embodiments, the electrolyte can include a solid-state electrolyte. In some embodiments, the electrolyte can include an electrolyte solvent and an electrolyte salt.

In some embodiments, the electrolyte solvent can include a polar solvent. In some embodiments, the electrolyte solvent can include a non-polar solvent. In some embodiments, the electrolyte solvent can include dimethoxyethane (DME), an ether, bis (2-fluoroethyl) ether, 1,2-dimethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, bis-(2-fluoro-ethyl)-ether, 1,2-diethoxyethane, dimethyl carbonate, 1,3-dioxolane, 1,4-dioxolane, ethyl methyl carbonate, diethyl carbonate, tetrahydropyran, dimethyl sulfoxide, ethyl vinyl sulfone, tetramethylene sulfone, ethyl methyl sulfone, ethylene carbonate, vinylene carbonate, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate,1,3-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, fluoroethylene carbonate, ethyl acetate, ethyl butyrate, methyl acetate, methyl butyrate, methyl propionate, methyl pentafluoropropionate, propyl acetate, 2, 2, 2,-trifluoroethyl acetate, 2, 2, 2,-trifluoroethyl butyrate, or any combination thereof. In some embodiments, the electrolyte solvent can include can include fluoroether, and/or fluorobutane, for instance, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanessulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, 3,3,4,4,5,5-hexafluorotetrahydropyran or any combination thereof.

In some embodiments, the electrolyte salt can include lithium bis(fluorosulfonyl)imide (LiF₂LiNO₄S₂), lithium bis(trifluoromethylsulfonyl)imide (LiC₂F₆NO₄S₂), lithium bis(oxalato)borate, lithium hexafluorophosphate (LiPF₆), lithium hexafluoroarsenate (LiAsF₆), lithium bis(trifluoromethane) sulfonimide (LiN(SO₂CF₃)₂), lithium trifluoromethanesulfonate (LiCF₃SO₃), lithium perchlorate (LiClO₄), lithium difluoro oxalato borate anion (LiBF₂(C₂O₄)), lithium iodide (LiI), lithium bromide (LiBr), lithium chloride (LiCl), lithium hydroxide (LiOH), lithium nitrate (LiNO₃), and lithium sulfate (LiSO₄) and lithium 2-trifluoromethyl-4,5-dicyanoimidazole (LiTDI), lithium sulfate (LiSO₄), and/or lithium difluorophosphate (LiPO₂F₂). In some embodiments, the electrolyte salt can include sodium bis(fluorosulfonyl)imide (NaF₂LiNO₄S₂), sodium bis(trifluoromethylsulfonyl)imide (NaC₂F₆NO₄S₂), sodium bis(oxalato)borate, sodium hexafluorophosphate (NaPF₆), sodium hexafluoroarsenate (NaAsF₆), sodium bis(trifluoromethane) sulfonimide (NaN(SO₂CF₃)₂), sodium trifluoromethanesulfonate (NaCF₃SO₃), sodium perchlorate (NaClO₄), sodium difluoro oxalato borate anion (NaBF₂(C₂O₄)), sodium iodide (NaI), sodium bromide (NaBr), sodium chloride (NaCl), sodium hydroxide (NaOH), sodium nitrate (NaNO₃), and sodium sulfate (NaSO₄) and sodium 2-trifluoromethyl-4,5-dicyanoimidazole (NaTDI), sodium sulfate (NaSO₄), and/or sodium difluorophosphate (NaPO₂F₂). In some embodiments, the electrolyte salt can include potassium bis(fluorosulfonyl)imide (KF₂LiNO₄S₂), potassium bis(trifluoromethylsulfonyl)imide (KC₂F₆NO₄S₂), potassium bis(oxalato)borate, potassium hexafluorophosphate (KPF₆), potassium hexafluoroarsenate (KAsF₆), potassium bis(trifluoromethane) sulfonimide (KN(SO₂CF₃)₂), potassium trifluoromethanesulfonate (KCF₃SO₃), potassium perchlorate (KClO₄), potassium difluoro oxalato borate anion (KBF₂(C₂O₄)), potassium iodide (KI), potassium bromide (KBr), potassium chloride (KCl), potassium hydroxide (KOH), potassium nitrate (KNO₃), and potassium sulfate (KSO₄) and potassium 2-trifluoromethyl-4,5-dicyanoimidazole (KTDI), potassium sulfate (KSO₄), and/or potassium difluorophosphate (KPO₂F₂).

In some embodiments, the solid-state electrolyte can include an oxide-based electrolyte. In some embodiments, the solid-state electrolyte material can include lithium lanthanum zirconium oxide (LLZO), Li_{1.3}Al_{0.3}Ti_{1.7}(PO₄)₃ (LATP), lithium phosphorus oxynitride (LiPON), li-ion conducting solid-state electrolyte ceramics (LLTO), and/or Li₃BO₃—Li₂SO₄—Li₂CO₃ (LiBSCO). In some embodiments, the solid-state electrolyte material can include one or more oxide-based solid electrolyte materials including a garnet structure, a perovskite structure, a phosphate-based Lithium Super Ionic Conductor (LISICON) structure, a glass structure such as La_{0.51}Li_{0.34}TiO_{2.94}, Li_{1.3}Al_{0.3}Ti_{1.7}(PO₄)₃, Li_{1.4}Al_{0.4}Ti_{1.6}(PO₄)₃, Li₇La₃Zr₂O₁₂, Li_{6.66}La₃Zr_{1.6}Ta_{0.4}O_{12.9} (LLZO), 50Li₄SiO₄·50Li₃BO₃, Li_{2.9}PO_{3.3}N_{0.46} (lithium phosphorousoxynitride, LiPON), Li_{3.6}Si_{0.6}P_{0.4}O₄, Li₃BN₂, Li₃BO₃—Li₂SO₄, and/or sulfide containing solid electrolyte materials including a thio-LISICON structure, a glassy structure and a glass-ceramic structure such as Li_{1.07}Al_{0.69}Ti_{1.46}(PO₄)₃, Li_{1.5}Al_{0.5}Ge_{1.5}(PO₄)₃, Li₁₀GeP₂S₁₂ (LGPS), 30Li₂S·26B₂S₃·44LiI, 63Li₂S·36SiS₂·1Li₃PO₄, 57Li₂S·38SiS₂·5Li₄SiO₄, 70Li₂S·30P₂S₅, 50Li₂S·50GeS₂, Li₇P₃S₁₁, Li_{3.25}P_{0.95}S₄, and Li_{9.54}Si_{1.74}P_{1.44}S_{11.7}Cl_{0.3}, and/or closo-type complex hydride solid electrolyte, LiBH₄—LiI, LiBH₄—LiNH₂, LiBH₄—P₂S₅, Li(CB_{X}H_{X+1})—LiI, Li(CB₉H₁₀)— and/or LiI. In some embodiments, the solid-state electrolyte material can be sulfide-based. In some embodiments, the solid-state electrolyte can include lithium phosphorus sulfide (LPS), Li₁₀GeP₂Si₂ (LGPS), lithium tin phosphorus sulfide (LSPS), and/or Li_{5.5}PS_{4.5}Cl_{1.5} (LPSCI). In some embodiments, the solid-state electrolyte material can include a complex hydride solid electrolyte. In some embodiments, the solid-state electrolyte material can include LiBH₄—LiI and/or LiBH₄—P₂S₅. In some embodiments, the electrolyte can have any of the properties of the electrolytes described in International Patent Application No. PCT/US24/52434 (“the '434 application”), filed Oct. 22, 2024, and titled “High Performance Electrolyte for Electrochemical Energy Storage Devices, and Methods of Producing the Same,” the disclosure of which is hereby incorporated by reference in its entirety.

In some embodiments, the electrolyte can be applied to the anode 2910, the cathode 2930, and/or the separator 2950 via spraying, printing, coating, filling, or any combination thereof.

As shown, the film 2960a is coupled to the film 2960b via the adhesive 2970. In some embodiments, the film 2960a and/or the film 2960b (collectively referred to as films 2960) can extend around at least a portion of the parameter of the anode current collector 2920 and the cathode current collector 2940. In some embodiments, the films 2960 can include a polymer, polyethylene, polypropylene, polyethylene terephthalate (PET), or any combination thereof.

The film 2960a is bonded to the film 2960b along a sealing region via the adhesive 2970. The sealing region inhibits liquid electrolyte from escaping the electrochemical cell 2900. In some embodiments, the adhesive 2970 can have low wettable characteristics with the electrolyte. In some embodiments, the film 2960a can be laminated to the film 2960b. In some embodiments, the adhesive 2970 can include a hot melt adhesive, an epoxy adhesive, a polyurethane clue, an acrylic adhesive, a liquid adhesive, a solvent-based adhesive, a spray adhesive, or any combination thereof.

In some embodiments, the sealing region created by the bonding between the film 2960a and the film 2960b can cover at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95% of the perimeter of the anode current collector 2920 and/or the cathode current collector 2940. In some embodiments, the sealing region created by the bonding between the film 2960a and the film 2960b can cover no more than about 100%, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, or no more than about 10% of the perimeter of the anode current collector 2920 and/or the cathode current collector 2940. Combinations of the above-referenced percentages are also possible (e.g., at least about 5% and no more than about 100% or at least about 50% and no more than about 80%), inclusive of all values and ranges therebetween. In some embodiments, the sealing region created by the bonding between the film 2960a and the film 2960b can cover about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the perimeter of the anode current collector 2920 and/or the cathode current collector 2940.

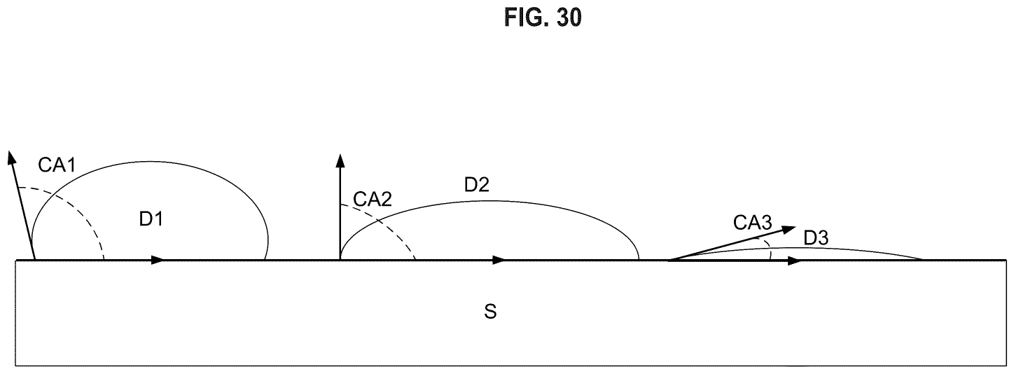

In some embodiments, the electrolyte can be substantially non-wettable with the adhesive 2970. In some embodiments, the electrolyte can be substantially non-wettable with the films 2960. The contact angle of the electrolyte with the adhesive 2970 and/or the films 2960 can be a quantitative measure of the wettability of the electrolyte on said surfaces. As used herein, “contact angle” refers to an angle formed between a line drawn tangentially to a droplet of liquid on a surface and a line drawn tangent to the surface, on which the droplet of liquid rests, as illustrated in FIG. 30. Contact angle is a function of fluid properties (e.g., viscosity, surface tension), as well as the miscibility between the surface material and the liquid. As shown in FIG. 30, droplet D1 forms a contact angle CA1 with a surface S of greater than 90°. Droplet D2 forms a contact angle CA2 with the surface S of about 90°. Droplet D3 forms a contact angle CA3 with the surface S of less than 90°. Liquids and surfaces with differing miscibility (e.g., water on a hydrophobic surface) often form contact angles greater than 90°, while liquids and surfaces with similar miscibility (e.g., water on a hydrophilic surface) often form contact angles less than 90°.

In some embodiments, the contact angle formed between the electrolyte and the films 2960 can be at least about 30°, at least about 35°, at least about 40°, at least about 45°, at least about 50°, at least about 55°, at least about 60°, at least about 65°, at least about 70°, at least about 75°, at least about 80°, at least about 85°, at least about 90°, at least about 95°, at least about 100°, at least about 105°, at least about 110°, at least about 115°, at least about 120°, at least about 125°, at least about 130°, at least about 135°, at least about 140°, or at least about 145°. In some embodiments, the contact angle formed between the electrolyte and the films 2960 can be no more than about 150°, no more than about 145°, no more than about 140°, no more than about 135°, no more than about 130°, no more than about 125°, no more than about 120°, no more than about 115°, no more than about 110°, no more than about 105°, no more than about 100°, no more than about 95°, no more than about 90°, no more than about 85°, no more than about 80°, no more than about 75°, no more than about 70°, no more than about 65°, no more than about 60°, no more than about 55°, no more than about 50°, no more than about 45°, no more than about 40°, or no more than about 35°. Combinations of the above-referenced contact angles are also possible (e.g., at least about 30° and no more than about 150° or at least about 80° and no more than about 120°), inclusive of all values and ranges therebetween. In some embodiments, the contact angle formed between the electrolyte and the films 2960 can be about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, about 135°, about 140°, about 145°, or about 150°.

In some embodiments, the contact angle formed between the electrolyte and the adhesive 2970 can be at least about 30°, at least about 35°, at least about 40°, at least about 45°, at least about 50°, at least about 55°, at least about 60°, at least about 65°, at least about 70°, at least about 75°, at least about 80°, at least about 85°, at least about 90°, at least about 95°, at least about 100°, at least about 105°, at least about 110°, at least about 115°, at least about 120°, at least about 125°, at least about 130°, at least about 135°, at least about 140°, or at least about 145°. In some embodiments, the contact angle formed between the electrolyte and the adhesive 2970 can be no more than about 150°, no more than about 145°, no more than about 140°, no more than about 135°, no more than about 130°, no more than about 125°, no more than about 120°, no more than about 115°, no more than about 110°, no more than about 105°, no more than about 100°, no more than about 95°, no more than about 90°, no more than about 85°, no more than about 80°, no more than about 75°, no more than about 70°, no more than about 65°, no more than about 60°, no more than about 55°, no more than about 50°, no more than about 45°, no more than about 40°, or no more than about 35°. Combinations of the above-referenced contact angles are also possible (e.g., at least about 300 and no more than about 1500 or at least about 800 and no more than about 120°), inclusive of all values and ranges therebetween. In some embodiments, the contact angle formed between the electrolyte and the adhesive 2970 can be about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, about 135°, about 140°, about 145°, or about 150°.

As shown, the cathode tab 2942 extends from the cathode current collector 2940 and the anode tab 2922 extends from the anode current collector 2920. In some embodiments, the cathode tab 2942 can be part of the same piece of material as the cathode current collector 2940. In some embodiments, the cathode tab 2942 can be a different piece of material from the cathode current collector 2940. In some embodiments, the anode tab 2922 can be part of the same piece of material as the anode current collector 2920. In some embodiments, the anode tab 2922 can be a different piece of material from the anode current collector 2920. As shown, the cathode tab 2942 is optionally coupled to the film 2960b via the tab film 2980b and the anode tab 2922 is optionally coupled to the film 2960a via the tab film 2980a. By coupling the anode tab 2922 and the cathode tab 2942 (collectively the tabs) to the films 2960 via the tab films 2980a, 2980b (collectively referred to as the tab films 2980), leakage of liquid electrolyte can be further prevented. In some embodiments, the anode tab 2922 can be coupled to the film 2960a via the tab film 2980a along a second sealing region. In some embodiments, the cathode tab 2942 can be coupled to the film 2960b via the tab film 2980b along a third sealing region. In some embodiments, the second sealing region and the third sealing region can be in the same region or location of the electrochemical cell 2900. In some embodiments, the second sealing region and the third sealing region can be in different parts, regions, or locations of the electrochemical cell 2900.

In some embodiments, the tab films 2980 can include fluorine-containing materials, polytetrafluoroethylene (PTFE), perfluoroalkoxy alkane (PFA), non-double bonding rubber, non-double-bonding plastic, EPDM, polyethylene, polypropylene, microscale structural material, nanoscale structural material, or any combination thereof. Sealing stress at the tabs can be greater than the sealing stress in the first sealing region around the anode current collector 2920 and the cathode current collector 2940. Therefore, the second and/or third sealing regions can use a different sealing method/material. In some embodiments, the tab films 2980 can modify the surface of the metal of the tabs. In some embodiments, the tab films 2980 can cover the entirety of a width of the tabs. In some embodiments, the tab films 2980 can cover a portion of the width of the tabs (e.g., about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95%, inclusive of all values and ranges therebetween).

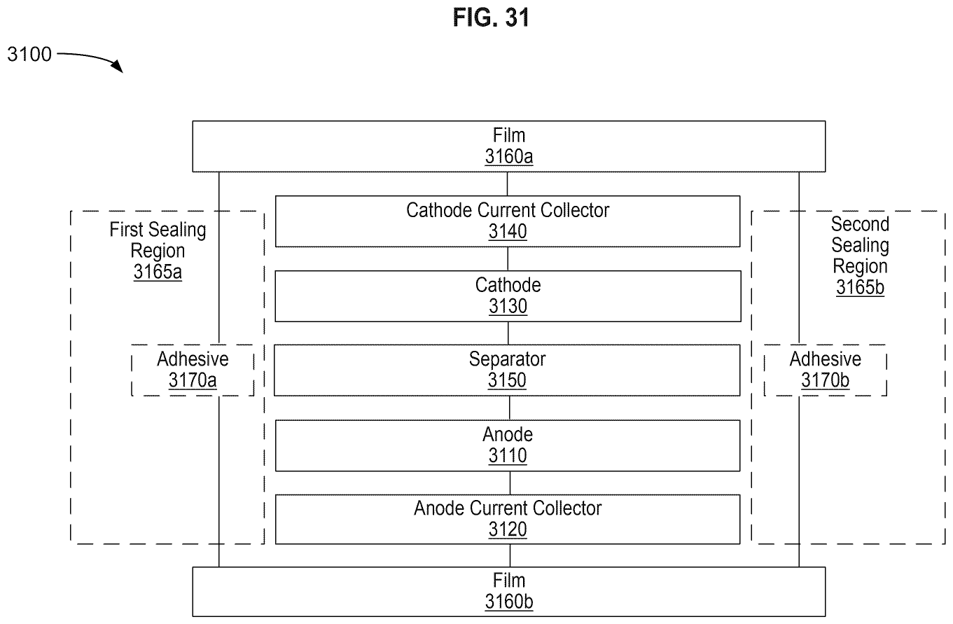

FIG. 31 is a block diagram of an electrochemical cell 3100, according to an embodiment. As shown, the electrochemical cell 3100 includes an anode 3110, an anode current collector 3120, a cathode 3130, a cathode current collector 3140, a separator 3150, films 3160a, 3160b (collectively referred to as films 3160), and adhesives 3170a, 3170b (collectively referred to as adhesives 3170). The film 3160a is coupled to the film 3160b along a first sealing region 3165a and a second sealing region 3165b. In some embodiments, the anode 3110, the anode current collector 3120, the cathode 3130, the cathode current collector 3140, the separator 3150, the films 3160, and the adhesives 3170 can be the same or substantially similar to the anode 2910, the anode current collector 2920, the cathode 2930, the cathode current collector 2940, the separator 2950, the films 2960, and the adhesive 2970, as described above with reference to FIG. 29. Thus, certain aspects of the anode 3110, the anode current collector 3120, the cathode 3130, the cathode current collector 3140, the separator 3150, the films 3160, and the adhesives 3170 are not described in greater detail herein.

As shown, the adhesive 3170a bonds the film 3160a to the film 3160b along the first sealing region 3165a and the adhesive 3170b bonds the film 3160a to the film 3160b along the second sealing region 3165b. In some embodiments, the first sealing region can cover an outside perimeter of the anode current collector 3120 and the cathode current collector 3140, while the second sealing region covers an inside perimeter of the anode current collector 3120 and the cathode current collector 3140. This can be the case if, for example, the electrochemical cell 3100 has a donut shape, such that a void region exists in the middle of the anode 3110, the anode current collector 3120, the cathode 3130, the cathode current collector 3140, and the separator 3150. The second sealing region 3165b can be included in the void region. In some embodiments, the electrochemical cell 3100 can include tabs (not shown) extending from the anode current collector 3120 and/or the cathode current collector 3140.

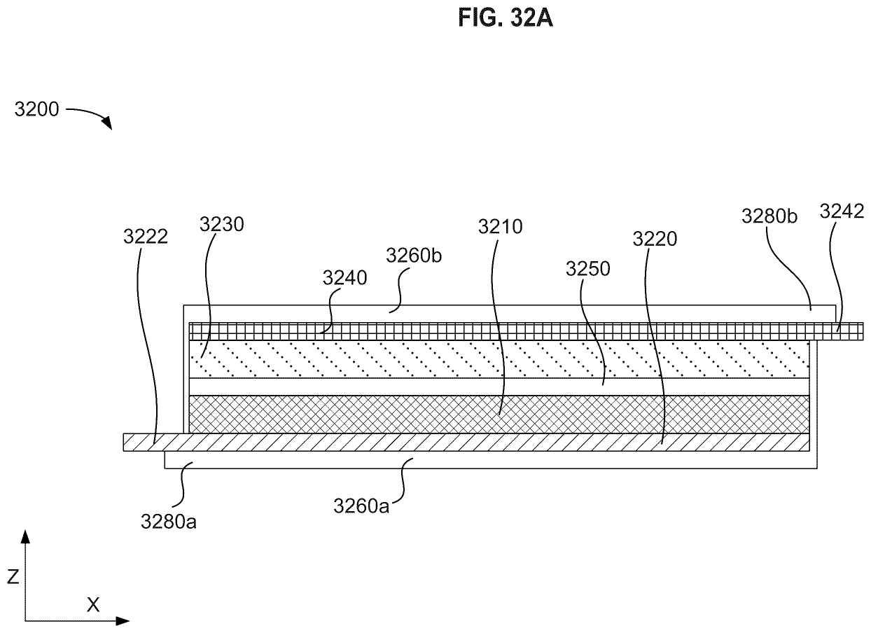

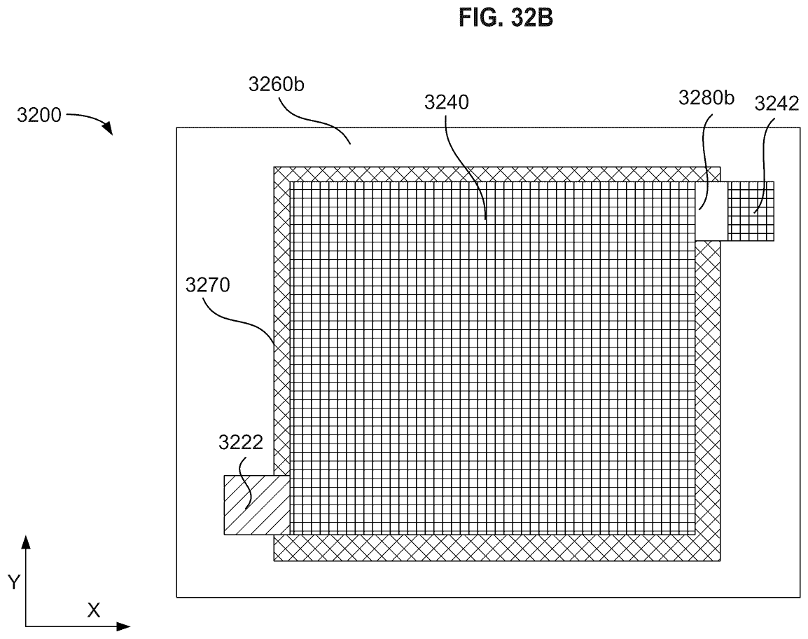

FIGS. 32A-B are illustrations of an electrochemical cell 3200, according to an embodiment. FIG. 32A is a side cross-sectional view, and FIG. 32B is a top view of the electrochemical cell 3200. As shown, the electrochemical cell 3200 includes an anode 3210, an anode current collector 3220, an anode tab 3222, a cathode 3230, a cathode current collector 3240, a cathode tab 3242, a separator 3250, films 3260a, 3260b (collectively referred to as films 3260), an adhesive 3270, and tab films 3280a, 3280b (collectively referred to as tab films 3280). Axes are shown for structural clarity. In some embodiments, the anode 3210, the anode current collector 3220, the anode tab 3222, the cathode 3230, the cathode current collector 3240, the cathode tab 3242, the separator 3250, the films 3260, the adhesive 3270, and the tab films 3280 can be the same or substantially similar to the anode 2910, the anode current collector 2920, the anode tab 2922, the cathode 2930, the cathode current collector 2940, the cathode tab 2942, the separator 2950, the films 2960, the adhesive 2970, and the tab films 2980, as described above with reference to FIG. 29. Thus, certain aspects of the anode 3210, the anode current collector 3220, the anode tab 3222, the cathode 3230, the cathode current collector 3240, the cathode tab 3242, the separator 3250, the films 3260, the adhesive 3270, and the tab films 3280 are not described in greater detail herein.

As shown, the anode tab 3222 and the cathode tab 3242 extend from opposite sides of the electrochemical cell 3200. In some embodiments, the anode tab 3222 and the cathode tab 3242 can extend from the same side of the electrochemical cell 3200. In some embodiments, the anode tab 3222 and the cathode tab 3242 can extend from sides of the electrochemical cell 3200 perpendicular to each other. As shown in FIG. 32B, the tab film 3280b forms a bond between the cathode tab 3242 and the film 3260b. On the opposite side of the electrochemical cell 3200 and not visible in FIG. 32, the tab film 3280a forms a bond between the anode tab 3222 and the film 3260a. As shown in FIG. 32B, the electrochemical cell 3200 has a rectangular form factor.

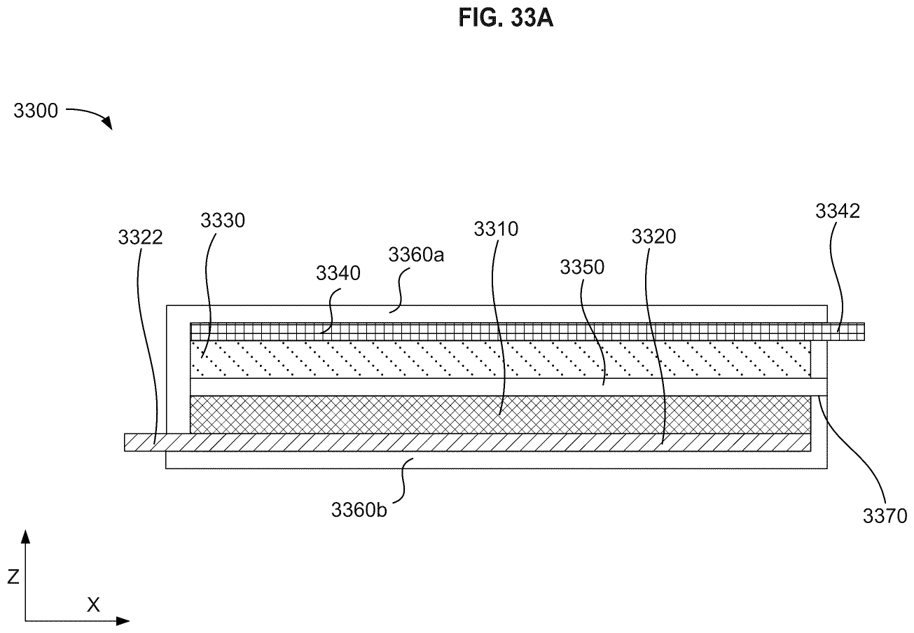

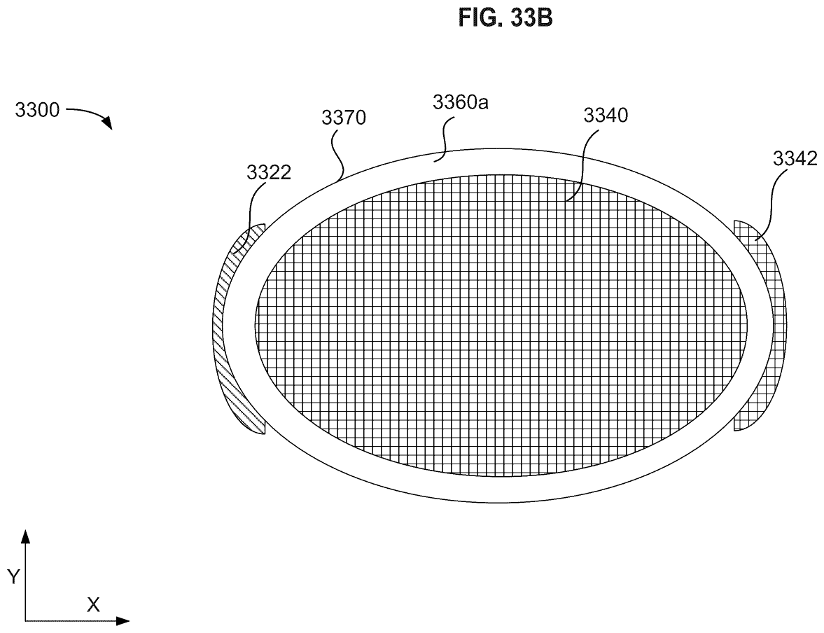

FIGS. 33A-B are illustrations of an electrochemical cell 3300, according to an embodiment. FIG. 33A is a side cross-sectional view, and FIG. 33B is a top view of the electrochemical cell 3300. As shown, the electrochemical cell 3300 includes an anode 3310, an anode current collector 3320, an anode tab 3322, a cathode 3330, a cathode current collector 3340, a cathode tab 3342, a separator 3350, films 3360a, 3360b (collectively referred to as films 3360), and an adhesive 3370. Axes are shown for structural clarity. In some embodiments, the anode 3310, the anode current collector 3320, the anode tab 3322, the cathode 3330, the cathode current collector 3340, the cathode tab 3342, the separator 3350, the films 3360, and the adhesive 3370 can be the same or substantially similar to the anode 2910, the anode current collector 2920, the anode tab 2922, the cathode 2930, the cathode current collector 2940, the cathode tab 2942, the separator 2950, the films 2960, and the adhesive 2970, as described above with reference to FIG. 29. Thus, certain aspects of the anode 3310, the anode current collector 3320, the anode tab 3322, the cathode 3330, the cathode current collector 3340, the cathode tab 3342, the separator 3350, the films 3360, and the adhesive 3370 are not described in greater detail herein.

As shown, the electrochemical cell 3300 has an elliptical form factor. In some embodiments, the electrochemical cell 3300 can have a circular or oval form factor. A rounded form factor can make the sealing region between the film 3360a and the film 3360b more stable, as there are no sharp corners more prone to leakage. In some embodiments, electrolyte can be added to the electrochemical cell 3300 before the film 3360a is coupled to the film 3360b. In some embodiments, electrolyte can be added to the electrochemical cell 3300 after the film 3360a is coupled to the film 3360b. In some embodiments, the separator 3350 can be sealed between the film 3360a and the film 3360b. In some embodiments, multiple electrochemical cells 3300 can be stacked in series and/or parallel connections.

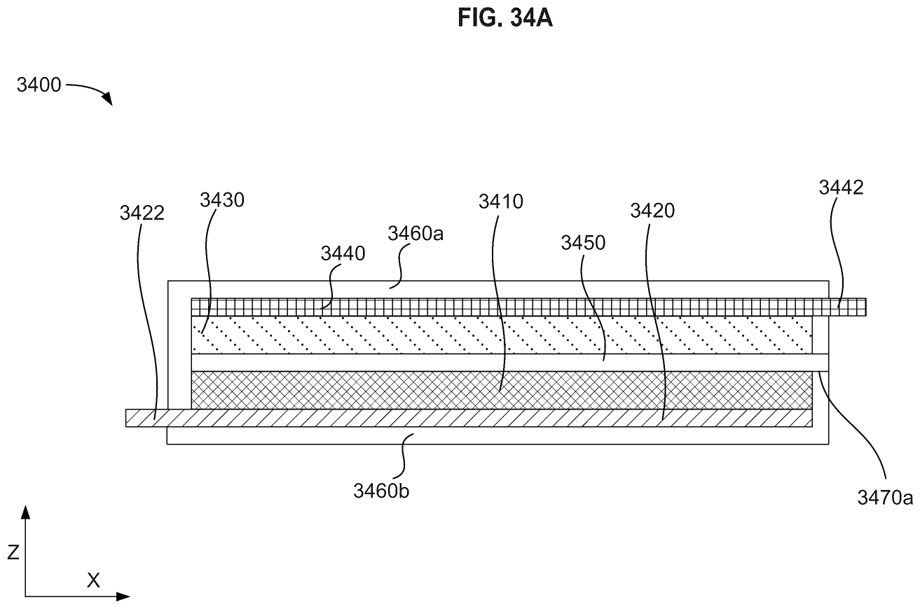

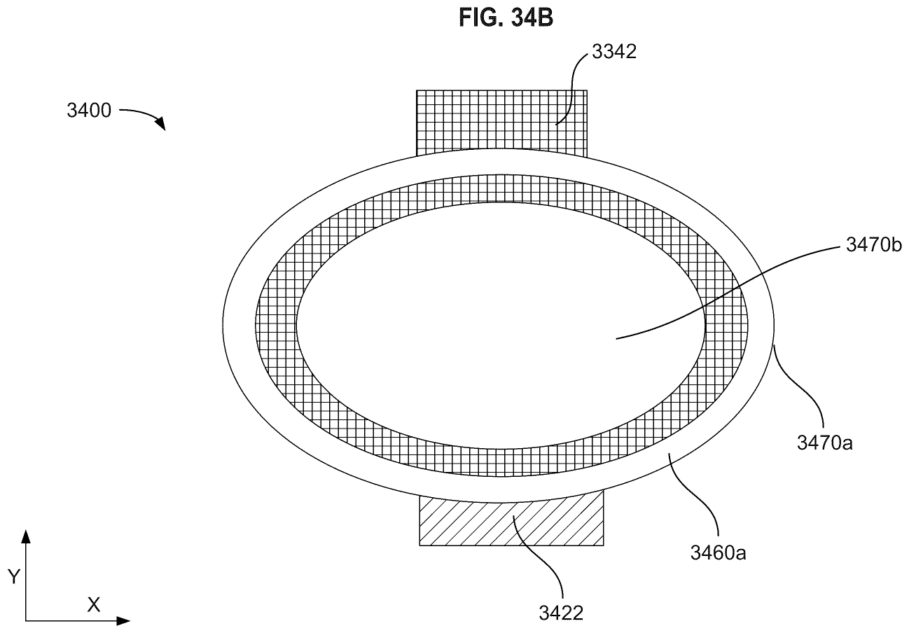

FIGS. 34A-B are illustrations of an electrochemical cell 3400, according to an embodiment. FIG. 34A is a side cross-sectional view, and FIG. 34B is a top view of the electrochemical cell 3400. As shown, the electrochemical cell 3400 includes an anode 3410, an anode current collector 3420, an anode tab 3422, a cathode 3430, a cathode current collector 3440, a cathode tab 3442, a separator 3450, films 3460a, 3460b (collectively referred to as films 3460), and adhesives 3470a, 3470b (collectively referred to as adhesives 3470). Axes are shown for structural clarity. In some embodiments, the anode 3410, the anode current collector 3420, the anode tab 3422, the cathode 3430, the cathode current collector 3440, the cathode tab 3442, the separator 3450, the films 3460, and the adhesives 3470 can be the same or substantially similar to the anode 3010, the anode current collector 3020, the anode tab 3022, the cathode 3030, the cathode current collector 3040, the cathode tab 3042, the separator 3050, the films 3060, and the adhesive 3070, as described above with reference to FIG. 30A. Thus, certain aspects of the anode 3410, the anode current collector 3420, the anode tab 3422, the cathode 3430, the cathode current collector 3440, the cathode tab 3442, the separator 3450, the films 3460, and the adhesives 3470 are not described in greater detail herein.

As shown, the adhesive 3470a couples the film 3460a and the film 3460b in a first sealing region and the adhesive 3470b couples the film 3460a and the film 3460b in a second sealing region. The electroactive components of the electrochemical cell 3400 form a donut shape. In some embodiments, the electroactive components of the electrochemical cell 3400 can form a circular donut shape. In some embodiments, the electroactive components of the electrochemical cell 3400 can form an elliptical donut shape. By including a first sealing region on the exterior of the electroactive components of the electrochemical cell 3400 and a second sealing region on the interior of the electroactive components of the electrochemical cell 3400, pressure can be more evenly applied to the electrodes of the electrochemical cell 3400. In some embodiments, the donut shape of the electroactive components of the electrochemical cell 3400 can be formed by punching the shape from the electrochemical cell 3400 (i.e., removing a portion of the components of the electrochemical cell 3400 from a round- or elliptical-shaped assembly). In some embodiments, electrolyte can be added to the electrochemical cell 3400 before the film 3460a is coupled to the film 3460b. In some embodiments, electrolyte can be added to the electrochemical cell 3400 after the film 3460a is coupled to the film 3460b. In some embodiments, the separator 3450 can be sealed between the film 3460a and the film 3460b. In some embodiments, multiple electrochemical cells 3400 can be stacked in series and/or parallel connections.

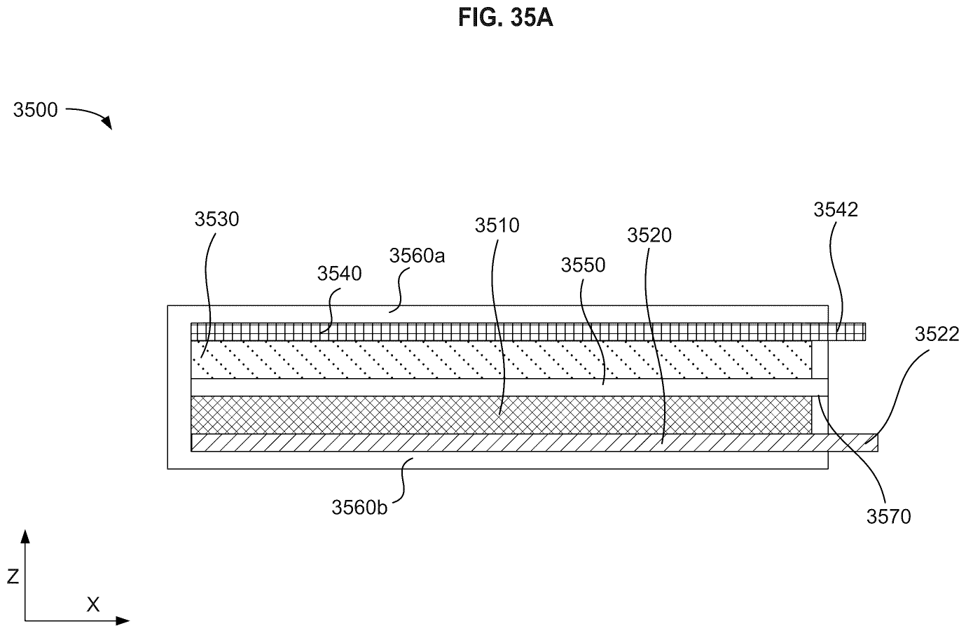

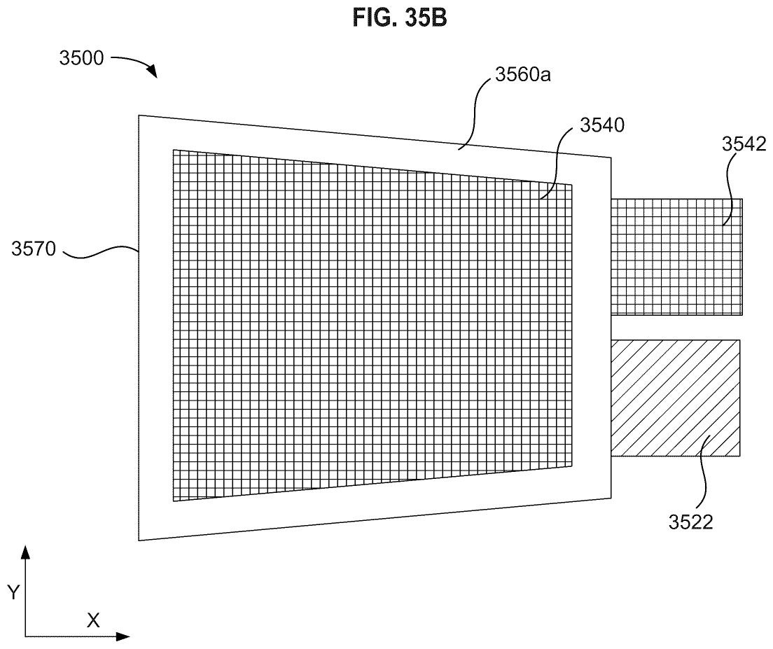

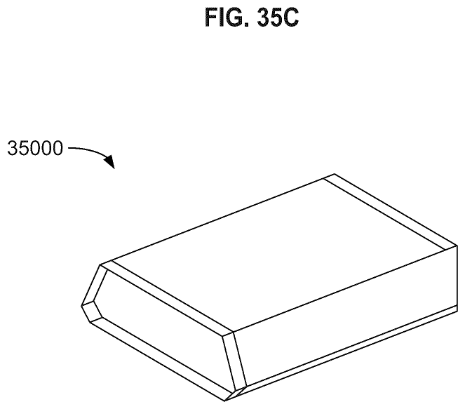

FIGS. 35A-C are illustrations of an electrochemical cell 3500, according to an embodiment. FIG. 35A is a side cross-sectional view, and FIG. 35B is a top view of the electrochemical cell 3500. As shown, the electrochemical cell 3500 includes an anode 3510, an anode current collector 3520, an anode tab 3522, a cathode 3530, a cathode current collector 3540, a cathode tab 3542, a separator 3550, films 3560a, 3560b (collectively referred to as films 3560), and an adhesive 3570. FIG. 35A shows a side profile view of the electrochemical cell 3500 while FIG. 35B shows an overhead view of the electrochemical cell 3500 and FIG. 35C shows the incorporation of the electrochemical cell 3500 into a cell stack 35000. Axes are shown for structural clarity. In some embodiments, the anode 3510, the anode current collector 3520, the anode tab 3522, the cathode 3530, the cathode current collector 3540, the cathode tab 3542, the separator 3550, the films 3560, and the adhesive 3570 can be the same or substantially similar to the anode 2910, the anode current collector 2920, the anode tab 2922, the cathode 2930, the cathode current collector 2940, the cathode tab 2942, the separator 2950, the films 2960, and the adhesive 2970, as described above with reference to FIG. 29. Thus, certain aspects of the anode 3510, the anode current collector 3520, the anode tab 3522, the cathode 3530, the cathode current collector 3540, the cathode tab 3542, the separator 3550, the films 3560, and the adhesive 3570 are not described in greater detail herein.

As shown, the electrochemical cell 3500 has a trapezoidal form factor. Trapezoidal form factors can give way to easier stacking and better packing efficiency (i.e., less space that is not electrically active and greater energy per unit mass/volume). As shown, the anode tab 3522 and the cathode tab 3542 extend from the same side of the electrochemical cell 3500. In some embodiments, the anode tab 3522 and the cathode tab 3542 can extend from opposite or different sides of the electrochemical cell 3500. FIG. 35C shows the electrochemical cell stack 35000, as formed from multiple electrochemical cells 3500 stacked together.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified, and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
receiving a current collector material on a surface of a first arc-shaped member and a surface of a second arc-shaped member disposed along an outside edge of a drum, the first arc-shaped member and the second arc-shaped member having a gap therebetween;
conveying the current collector material along the surface of the first arc-shaped member and the surface of the second arc-shaped member such that a portion of the current collector material is disposed into the gap between the first arc-shaped member and the second arc-shaped member;
moving the first arc-shaped member with respect to the second arc-shaped member to at least partially close the gap between the first arc-shaped member and the second arc-shaped member such that the current collector material is frictionally engaged with a portion of the first arc-shaped member and a portion of the second arc-shaped member;
dispensing a semi-solid electrode material onto portions of the current collector material that are disposed on the surface of the first arc-shaped member and the second arc-shaped member; and
moving the second arc-shaped member with respect to the first arc-shaped member to re-form the gap between the first arc-shaped member and the second arc-shaped member, such that a first discrete portion of the semi-solid electrode material and a second discrete portion of the semi-solid electrode material are formed on the current collector material.

2. The method of claim 1, wherein the movement of the first arc-shaped member with respect to the second arc-shaped member is controlled by a rotating concave roller gear that is in contact with an outside surface of both the first arc-shaped member and the second arc-shaped member.

3. The method of claim 2, wherein the movement of the first arc-shaped member with respect to the second arc-shaped member is controlled by a rotating concave roller gear in a time-staggered fashion such that the gap between the first arc-shaped member and the second arc-shaped member decreases during a pre-determined amount of time period.

4. The method of claim 1, further comprising:
maintaining a position of the first arc-shaped member with respect to the second arc-shaped member via a dynamic clamping force regulator system including a plurality of pinion gears after the gap is at least partially closed, wherein at least a portion of the plurality of pinion gears are in contact with a first portion of an outside edge of the first arc-shaped member and the second arc-shaped member.

5. The method of claim 1, wherein re-forming the gap between the first arc-shaped member and the second arc-shaped member is via a damping system including at least one pinion gear, the at least one pinion gear being in contact with a second portion of an outside edge of the first arc-shaped member and the second arc-shaped member.

6. The method of claim 1, receiving the current collector material is via an alignment drum mechanically coupled to the drum, the alignment drum being driven synchronously with the drum.

7. The method of claim 1, wherein the dispensing is approximately horizontal and in a direction tangential to movement of the current collector material that is frictionally engaged with the portion of the first arc-shaped member and the portion of the second arc-shaped member.

8. The method of claim 1, further comprising:
maintaining a position of the current collector material with respect to the surface of the first arc-shaped member and the surface of the second arc-shaped member during conveying via a vacuum inside the drum.

9. The method of claim 1, wherein the current collector material is disposed on a first surface of a film material.

10. The method of claim 9, wherein the film material includes a coating disposed on a second surface of the film material opposite the first surface, the second surface being in contact with the surface of the first arc-shaped member and the surface of the second arc-shaped member.

11. The method of claim 10, wherein the second surface of the film material has a coefficient of friction against the surfaces of the first arc-shaped member and the second arc-shaped member that is at least about 20% greater than a coefficient of friction of an uncoated second surface of the film material against the surfaces of the first arc-shaped member and the second arc-shaped member.

12. The method of claim 10, wherein the coating includes a heat activated adhesive film.

13. The method of claim 10, wherein the coating includes a polymer film having a coefficient of friction against a counter material that is at least about 20% greater than a coefficient of friction of the film material against the counter material.

14. A method, comprising:
receiving a current collector material from an alignment drum on a surface of a first arc-shaped member and a surface of a second arc-shaped member disposed along an outside edge of a drum mechanically coupled to the alignment drum, the first arc-shaped member and the second arc-shaped member having a gap therebetween, the alignment drum being driven synchronously with the drum;
conveying the current collector material along the surface of the first arc-shaped member and the surface of the second arc-shaped member such that a portion of the current collector material is disposed into the gap between the first arc-shaped member and the second arc-shaped member;
moving the first arc-shaped member with respect to the second arc-shaped member to at least partially close the gap between the first arc-shaped member and the second arc-shaped member such that the current collector material is frictionally engaged with a portion of the first arc-shaped member and a portion of the second arc-shaped member;
dispensing a semi-solid electrode material onto portions of the current collector material that are disposed on the surface of the first arc-shaped member and the second arc-shaped member; and
moving the second arc-shaped member with respect to the first arc-shaped member to re-form the gap between the first arc-shaped member and the second arc-shaped member, such that a first discrete portion of the semi-solid electrode material and a second discrete portion of the semi-solid electrode material are formed on the current collector material.

15. The method of claim 14, further comprising:
maintaining a position of the current collector material with respect to the surface of the first arc-shaped member and the surface of the second arc-shaped member during conveying via a vacuum inside the drum.

16. A system, comprising:
a plurality of arc-shaped pallets that forms a drum, the drum being rotated around a shaft;
a dispenser being attached to an outside surface of at least one of the arc-shaped pallets;
at least one concave roller gear being in touch with an outside surface of at least two of the arc-shaped pallets;
an alignment drum mechanically coupled to the drum;
a dynamic clamping force regulator system including a plurality of pinion gears, at least a portion of the plurality of pinion gears being in contact with a first portion of an outside edge of the drum; and
a damping system including at least one pinion gear, the at least one pinion gear being in contact with a second portion of an outside edge of the drum, the first portion of the outside edge of the drum and the second portion of the outside edge of the drum being next to each other with a distance of less than a surface arc length of one arc-shaped member.

17. The system of claim 16, further comprising:
a vacuum inside the drum.

18. The system of claim 17, wherein the plurality of arc-shaped pallets have a surface including holes.

19. The system of claim 16, further comprising:
a turret including a plurality of receivers, the plurality of receivers being filled with a semi-solid electrode material.

20-43. (canceled)

44. A system, comprising:
a drum, constructed from a first assembly and a second assembly, each of the first assembly and the second assembly including:
a plurality of disks spaced apart by a distance along an axial direction, each of the plurality of disks having an outer surface and an inner surface;
an arc-shaped pallet disposed on the plurality of disks and extending over a portion of the outer surface of the plurality of disks; and
a center axle disposed and configured to engage the inner surfaces of the plurality of disks of the first assembly and the inner surfaces of the plurality of disks of the second assembly; the first assembly and the second assembly being configured to be coupled together such that the plurality of disks of the first assembly are positioned in the spaces between the plurality of disks of the second assembly to form the drum.

45. The system of claim 44, wherein the arc-shaped pallet extends over half of the outer surface of the plurality of disks.

46. The system of claim 44, wherein the arc-shaped pallet includes one arc-shaped pallet, and the drum includes two arc-shaped pallets.

47. The system of claim 44, wherein the arc-shaped pallet includes two or more arch-shaped pallets.

48. The system of claim 44, wherein the center axle has a cylindrical shape and each of the plurality of disks have a spherical shape.

49-77. (canceled)
